(19) United States
(12) Patent Application Publication
(10) Pub. No.: US 2020/0407381 A1
(43) Pub. Date: Dec. 31, 2020

(54) C-BULKY P-CHIROGENIC ORGANOPHOSPHORUS COMPOUNDS

(71) Applicant: UNIVERSITÉ DE BOURGOGNE, Dijon (FR)

(72) Inventors: Jérôme BAYARDON, Dijon (FR); Antonin JAILLET, Quetigny (FR); Sylvain JUGÉ, Dijon (FR)

(73) Assignee: UNIVERSITÉ DE BOURGOGNE, Dijon (FR)

(21) Appl. No.: 16/980,979

(22) PCT Filed: Mar. 20, 2019
(86) PCT No.: PCT/EP2019/056965

§ 371 Date: Sep. 15, 2020

(30) Foreign Application Priority Data
Mar. 20, 2018 (EP) 18305304.0

(51) Int. Cl. C07F 9/50; C07B 53/00

(52) U.S. Cl. CPC C07F 9/505; C07B 53/00

(57) ABSTRACT

In the field of organic phosphorus chemistry, especially the chemistry of bulky organophosphorus compounds, a process for the synthesis of compound of formula (I). This process is especially useful to obtain chiral bulky phosphorus compounds. The present invention also relates to compounds of formula (VII), (VIII), (IX) and (X) and their processes of manufacturing starting from a compound of formula (I).

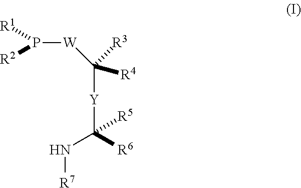

### FIELD OF INVENTION

The present invention relates to the field of organic phosphorus chemistry, especially the chemistry of bulky organophosphorus compounds. The present invention provides a process for the synthesis of compound of formula (I). This process is especially useful to obtain chiral bulky phosphorus compounds. The present invention also relates to compound of formula (VII), (VIII), (IX) and (X) and their processes of manufacturing starting from a compound of formula (I).

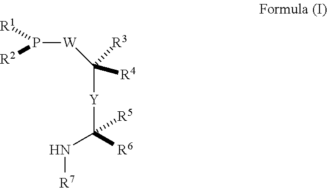

### BACKGROUND OF INVENTION

The organic phosphorus compounds are currently used in agrochemistry, pharmacy, catalysis, materials, or as flame retardants, extracting agents for hydrometallurgy, or still as chemical reagents. In addition, the properties of organic phosphorus compounds can depend on their chirality.

Depending on their substitution, the phosphorus compounds can bear the chirality on the P-center.

In recent years the electronically bulky phosphorus ligands (bulky phosphines) bearing substituents such as t-butyl or adamantyl gave a lot of interest in catalysis because they allow the activation of weakly actived substrates. That is explained by the steric hindrance of the ligand, allowing on one hand a weakly coordination of the metal in the catalyst, which makes it more reactive in respect of a substrate, and on the other hand favoring the reductive elimination of the product of the coordination sphere.

In the field of chirality, in recent years many chiral ligands bearing bulky substituents such as t-butyl, adamantyl (Ad) or 1,1,3,3-tetramethylbutyl demonstrated their extremely enantioselectivity. Today, many of these chiral ligands are commercially available:

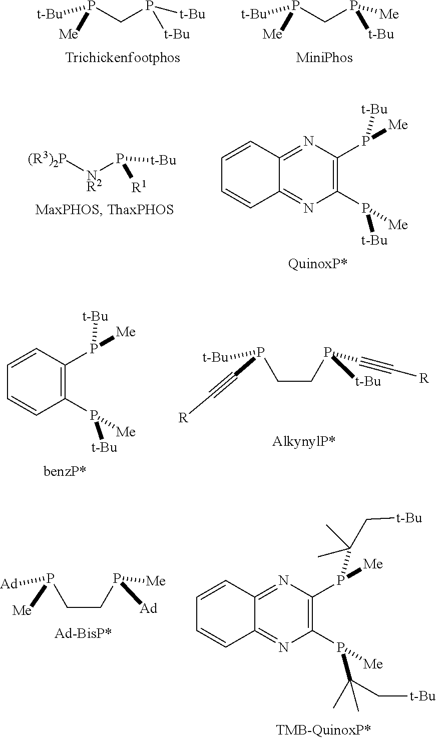

So far, the stereoselective synthesis of bulky phosphines could be achieved either from secondary phosphine derivatives, phosphinous acid borane complex or starting from dimethylphosphine borane complex, according to four main strategies (Scheme 1).

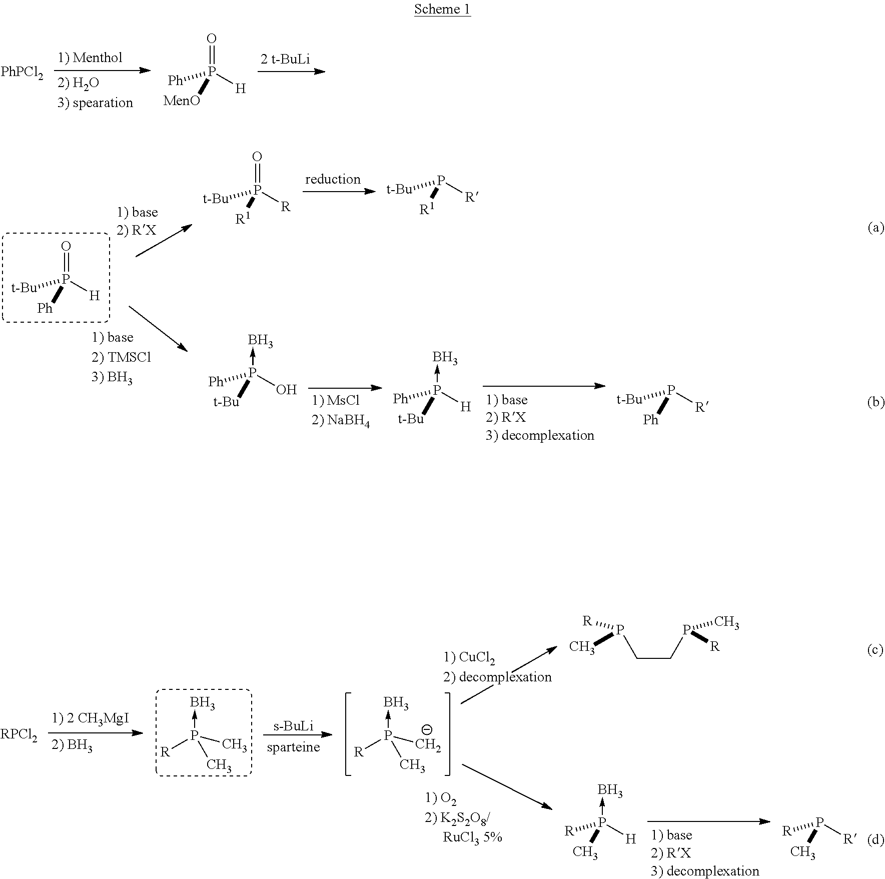

In the former case, P-chirogenic secondary phosphine oxides are prepared from dichlorophosphine, and via the secondary menthyl phosphinate which is diastereomerically separated by chromatography or cristallisation. Deprotonation of secondary phosphine oxide then alkylation leads to the phosphine oxides which are deoxygenated into the corresponding tertiary phosphines (Scheme 1a). Only the synthesis of t-butylphenylphosphine derivatives were described according to this strategy which requires difficult separation and deoxygenation steps.

A second route is based on the P-chirogenic phosphinous acid borane complex which is enantiomerically prepared either by chemical resolution or starting from secondary phosphine oxide. Subsequent reactions of phosphinous acid borane lead to the tertiary phosphine, via the secondary phosphine borane intermediate (Scheme 1b). Again, only the synthesis of the bulky t-butylphenylphosphine derivatives were described according to this strategy.

The more convenient methodology to synthesize bulky phosphines is based on the use of dimethylphosphine-borane (R=t-Bu, Ad, 1,1,3,3-tetramethylbutyl) prepared from the dichlorophosphine bearing R as bulky substitutent (ie t-Bu, Ad or 1,1,3,3-tetramethylbutyl) (Scheme 1 c,d). The asymmetric synthesis is based on the enantioselective deprotonation of the prochiral dimethylphosphine-borane in presence of (−)-sparteine, to afford diastereoselectively the corresponding carbanion in α-position with respect to the P-center (Scheme 1c and 1d). In a first case, the oxidative homocoupling of the anion by copper(II) salt leads then to the BisP* after decomplexation of the borane (Scheme 1c). In the second case the carbanion is oxidized by O₂ then K₂S₂O₈ in presence of RuCl₃ to afford the secondary methylphosphine-borane. Thus, deprotonation of the sec-phosphine-borane with n-butyllithium and subsequent reaction with R′X affords the tertiary methylphosphines after decomplexation (Scheme 1d). This method was used to prepare commercially available ligands for asymmetric metal-based catalysis, such as QuinoxP*, BisP* and TMB-QuinoxP*.

While (−)-sparteine is the naturally occurring chiral diamine, it is possible to prepare easily the surrogate of (+)-sparteine from (−)-cystisine, and use it for the synthesis of the enantiomer of an organophosphorus compound. However, if the use of the sparteine surrogate has been only demonstrated for the synthesis of t-butylphenyl- or t-butylmethylphosphines, the efficiency of this alternative route was not demonstrated for various substituents at the P-center.

On the other hand, among the best methodologies to synthesize P-chirogenic organophosphorus compounds, the stereoselective synthesis using ephedrine as asymmetric inductor and the borane as protecting group, developed by the Applicant, continue to occupy a place of choice, due to its efficiency to prepare various classes of products in a given configuration. The ephedrine method is based on the two key steps: diastereoselective preparation of the oxazaphospholidine-borane complex and stereoselective ring-opening by reaction with organolithium reagents to afford the aminophosphine-boranes (Scheme 2). Methanolysis or HCl acidolysis of aminophosphine boranes leads to phosphinite-boranes or chlorophosphine boranes, respectively, useful electrophilic building blocks for the synthesis of numerous classes of P-chirogenic phosphines (Scheme 2).

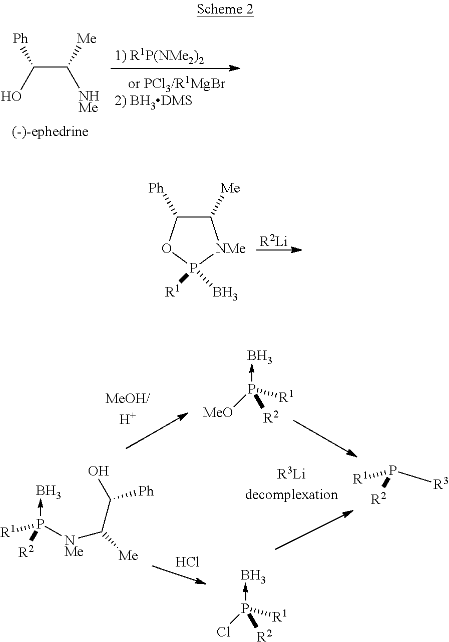

Whereas the efficiency of the ephedrine's methodology for the synthesis of P-chirogenic phosphorus compounds was extensively exemplified, only the bulky adamantyl- and t-butylphosphine phenyl derivatives have been synthetized according to this way.

As shown above, synthesis known in the prior art to obtain chiral bulky phosphorus compounds are poorly versatile. Indeed, to date, the best stereoselective methods using sparteine or ephedrine as asymmetric inductors, allow only to prepare bulky phosphines bearing only one bulky substituent such as t-butyl, adamantyl or 1,1,3,3-tetramethylbutyl, and a phenyl or methyl, at the P-center.

Therefore, there remains a need for the development of new method of synthesis of libraries of chiral bulky organophosphorus compounds. Such methods should be versatile enough to easily lead to broad library of bulky organophosphorus compounds.

### SUMMARY

The present invention relates to a selective process of synthesis of P-chirogenic organophosphorus compounds of general formula (I), summarized in Scheme 3.

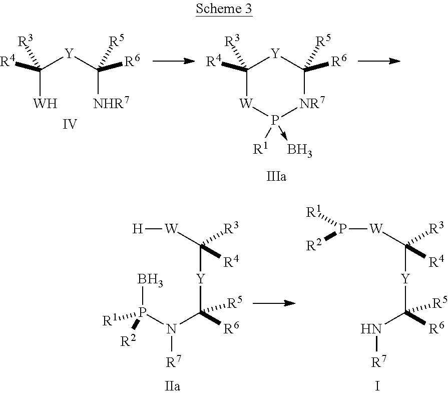

This invention thus relates to a process for manufacturing a compound of formula (I)

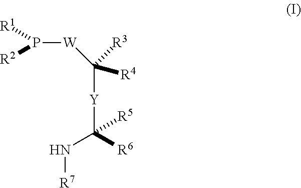

wherein R¹, R², R³, R⁴, R⁵, R⁶, R⁷, Y, and W are as defined below;
   comprising reacting a compound of formula (IIa)

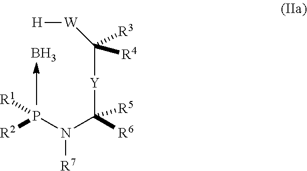

wherein R¹, R², R³, R⁴, R⁵, R⁶, R⁷, Y, and W are as defined below;
   with an amine

According to one embodiment, the amine is a mono or a diamine, preferably is selected from 1,4-diazabicyclo[2.2.2]octane (DABCO), diethylamine, triethylamine and morpholine, and more preferably 1,4-diazabicyclo[2.2.2]octane (DABCO).

According to one embodiment, the process is further comprising heating; preferably at a temperature ranging from 20° C. to 80° C.; more preferably at a temperature ranging from 30° C. to 60° C., even more preferably about 50° C.

According to one embodiment, the process is further a preliminary step comprising reacting a compound of formula (IIIa)

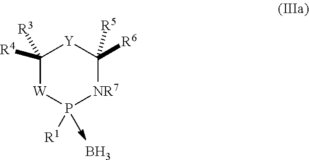

wherein R¹, R³, R⁴, R⁵, R⁶, R⁷, Y, and W are as defined below;
   with a reagent R²M¹, in which M¹ is a metal; preferably Li and R² is as defined below, resulting in the compound of formula (IIa).

According to one embodiment, the process is further comprising two preliminary steps:
(i) reacting a compound of formula (IV)

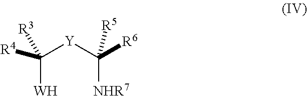

wherein R³, R⁴, R⁵, R⁶, R⁷, Y, and W are as defined below;
with
   a bis-aminophosphine R¹P(N(R⁹)₂)₂, in which R¹ is as defined below, and R⁹ represents a hydrogen atom or a substituted or unsubstituted group selected from alkyl, alkenyl, cycloalkyl and aryl; preferably a hydrogen atom or a substituted or unsubstituted alkyl group; more preferably a methyl group or ethyl group.
   with phosphorus trichloride PCl₃ for obtaining a compound of formula (VI);

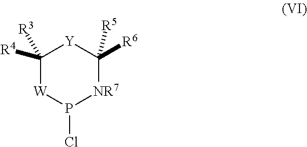

wherein R³, R⁴, R⁵, R⁶, R⁷, Y, and W are as defined below;
and further reacting the compound of formula (VI) with a reagent R¹M²; in which M² is a magnesium halide or an alkali metal; preferably M² is MgBr or Li.
   resulting in a compound of formula (Va)

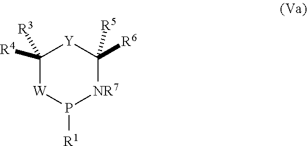

wherein R¹, R³, R⁴, R⁵, R⁶, R⁷, Y, and W are as defined below;
(ii) complexing the compound of formula (Va) with borane BH₃, resulting in the compound of formula (IIIa).

According to one embodiment, the process is further comprising four preliminary steps:
(i) reacting compound of formula (IV)

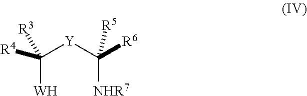

wherein R³, R⁴, R⁵, R⁶, R⁷, Y, W are as defined below;
with a bis-aminophosphine ZP(N(R⁹)₂)₂; wherein Z is leaving group and R⁹ is as defined above;
resulting in a compound of formula (Vb)

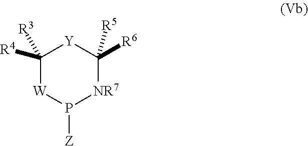

wherein R³, R⁴, R⁵, R⁶, R⁷, Y, W and Z are as defined below;
(ii) complexing the compound of formula (Vb) with a borane, resulting in a compound of formula (IIIb)

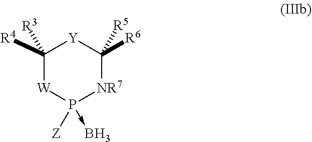

wherein R³, R⁴, R⁵, R⁶, R⁷, Y, W and Z are as defined below;
(iii) reacting the compound of formula (IIIb) with a reagent R¹M²; wherein R¹ and M² are as defined below; resulting in compound of formula (IIb)

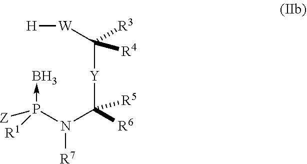

wherein R¹, R³, R⁴, R⁵, R⁶, R⁷, Y, W and Z are as defined below;
(iv) removing of the Z group of compound of formula (IIb) by contact with silica gel or by heating, resulting in compound of formula (IIIa).

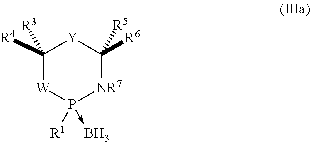

wherein R¹, R³, R⁴, R⁵, R⁶, R⁷, Y, and W are as defined below.

In another aspect, the present invention also relates to a compound of formula (I)

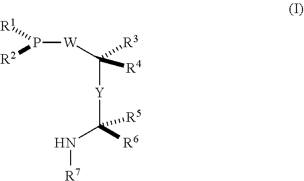

wherein R¹, R², R³, R⁴, R⁵, R⁶ R⁷, Y and W are as defined below;
provided that when R¹ is phenyl group, then R² is not phenyl group; provided that when R¹ is methoxy group, then R² is not phenyl group; provided that when R² is methoxy group, then R¹ is not phenyl group.

In another aspect, the process comprises a further step to manufacture a compound of formula (VII)

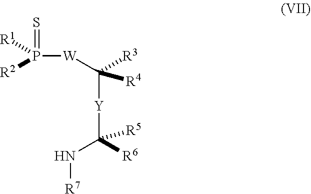

wherein R¹, R², R³, R⁴, R⁵, R⁶, R⁷, R¹⁰, R¹¹, Y and W are as defined below;
   by reacting a compound of formula (I) with sulfur.

In another aspect, the present invention relates to a compound of formula (VII)

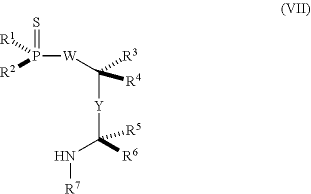

wherein R³, R⁴, R⁵, R⁶ R⁷, Y and W are as defined below;
R¹ and R² may be the same or different and represent each a substituted or unsubstituted group selected from alkyl, alkenyl, cycloalkyl, aryl, bisaryl, and metallocenyl; preferably a substituted or unsubstituted group selected from alkyl, aryl, bisaryl and metallocenyl.

In another aspect, the process comprises a further step to manufacture a compound of formula (VIII);

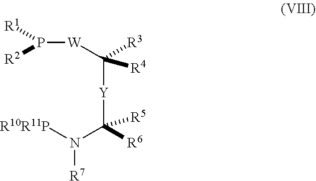

wherein R¹, R², R³, R⁴, R⁵, R⁶, R⁷, R¹⁰, R¹¹, Y and W are as defined below;
   by reacting a compound of formula (I) with a reagent R¹⁰R¹¹PCl, in which R¹⁰ and R¹¹ are as defined above, in presence of amine, preferably triethylamine

The present invention also relates to a compound of formula (VIII)

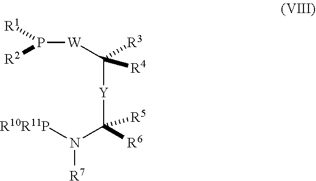

wherein R¹, R², R³, R⁴, R⁵, R⁶, R⁷, R¹⁰, R¹¹, Y and W are as defined below;
provided that when R¹, R¹⁰ and R¹¹ are phenyl groups and {R³, R⁴} is {H, Ph} or {Ph, H} and {R⁵, R⁶} is {H, Me} or {Me, H} and R⁷ is methyl group, and W is O and Y is a simple bond, then R² is not phenyl, o-anisyl or methyl group;
provided that when R¹, R¹⁰ and R¹¹ are phenyl groups and {R³, R⁴} is {H, Ph} or {Ph, H} and {R⁵, R⁶} is {H, Ph} or {Ph, H} and R⁷ is methyl group, and W is O and Y is a simple bond, then R² is not phenyl, o-anisyl or methyl group;
provided that when R¹, R¹⁰ and R¹¹ are phenyl groups and {R³, R⁴} is {H, H} and {R⁵, R⁶} is {H, Ph} or {Ph, H} and R⁷ is methyl group, and W is O and Y is a simple bond, then R² is not phenyl, o-anisyl or methyl group.

In another aspect, the process comprises a further step to manufacture a compound of formula (IX);

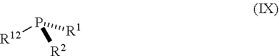

wherein
R¹, R² and R¹² are as defined below;
represents a hydrogen atom or a substituted or unsubstituted group selected from alkyl, alkenyl, cycloalkyl, aryl and bisaryl; preferably a substituted or unsubstituted group selected from alkyl, aryl and bisaryl; more preferably a methyl group or a tert-butyl group or a m-xylyl group.
   by reacting a compound of formula (I) with an organolithium reagent R¹²M³, in which R¹² is as defined above and M³ is an alkali metal, preferably Li.

In another aspect, the process comprises a further step to manufacture a compound of formula (X)

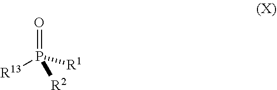

wherein
R¹ and R² are as defined below;
R¹³ represents a hydrogen atom or a substituted or unsubstituted group selected from alkyl, alkenyl, cycloalkyl and aryl; preferably a hydrogen atom or a substituted or unsubstituted group selected from alkyl and aryl; more preferably a hydrogen atom or a methyl group;
   by reacting a compound of formula (I) with an alkyl halide reagent R¹³X; X represents Cl, Br or I.

The present invention also relates to the use of compounds of formula (I) in catalysis.

### Definitions

In the present invention, the following terms have the following meanings:

When describing the compounds of the invention, the terms used are to be construed in accordance with the following definitions, unless indicated otherwise.

Where groups may be substituted, such groups may be substituted with one or more substituents, and preferably with one, two or three substituents. Substituents may be selected from but not limited to, for example, the group comprising halogen, hydroxyl, oxo, cyano, nitro, amido, carboxy, amino, haloalkoxy, and haloalkyl.
“About”: is used herein to mean approximately, roughly, around, or in the region of. When the term “about” is used in conjunction with a numerical range, it modifies that range by extending the boundaries above and below the numerical values set forth of 10%.
“Alkenyl”: refers to an unsaturated hydrocarbon group, which may be linear or branched, comprising one or more carbon-carbon double bonds. Suitable alkenyl groups comprise between 2 and 6 carbon atoms, preferably between 2 and 4 carbon atoms, still more preferably between 2 and 3 carbon atoms. Examples of alkenyl groups are ethenyl, 2-propenyl, 2-butenyl, 3-butenyl, 2-pentenyl and its isomers, 2-hexenyl and its isomers, 2,4-pentadienyl and the like.
“Alkoxy”: refers to any O-alkyl group, O-cycloalkyl group or O-aryl group.
“Alkyloxy”: refers to any O-alkyl group.
“Aryloxy”: refers to any O-aryl group.
“Alkyl”: refers to a hydrocarbyl radical of formula CₙH₂ₙ₊₁ wherein n is a number greater than or equal to 1. Generally, alkyl groups of this invention comprise from 1 to 12 carbon atoms, preferably from 1 to 6 carbon atoms. Alkyl groups may be linear or branched and may be substituted as indicated herein. Suitable alkyl groups include methyl, ethyl, propyl (n-propyl, i-propyl), butyl (n-butyl, i-butyl, s-butyl and t-butyl), pentyl and its isomers (e.g. n-pentyl, i-pentyl), and hexyl and its isomers (e.g. n-hexyl, i-hexyl).
“Alkylamino”: refers to any N-alkyl group.
“Amine”: refers to any compound derived from ammoniac NH₃ by substitution of one or more hydrogen atoms with an organic radical. According to the invention, amine any compound derived from ammoniac NH₃ by substitution of two or three hydrogen atoms with an organic radical.
“Arylamino”: refers to any N-aryl group.
“Aryl”: refers to a mono- or polycyclic system of 5 to 20 carbon atoms, and preferably 6 to 12, having one or more aromatic rings (when there are two rings, it is called a biaryl) among which it is possible to cite the phenyl group, the biphenyl group, the 1-naphthyl group, the 2-naphthyl group, the tetrahydronaphthyl group, the indanyl group and the binaphthyl group. The term aryl also means any aromatic ring including at least one heteroatom chosen from an oxygen, nitrogen or sulfur atom. The aryl group can be substituted by 1 to 3 substituents chosen independently of one another, among a hydroxy group, a linear or branched alkyl group comprising 1, 2, 3, 4, 5 or 6 carbon atoms, in particular methyl, ethyl, propyl, butyl, an alkoxy group or a halogen atom, in particular bromine, chlorine and iodine.
“Catalysis by transition metal complexes”: refers to a form of catalysis, whereby the rate of a chemical reaction is increased by organometallic compounds, i.e. by chemical compounds containing metal-element bounds of a largely covalent character.
“Chiral”: refers to a molecule with at least one asymmetric center.
“Chiral auxiliary”: refers to a stereogenic group that is temporarily incorporated into an organic compound in order to control the stereochemical outcome of the synthesis.
“Complex”: refers to a molecule binding a metal ion. Chelation (or complexation) involves the formation or presence of two or more separate coordinate bonds between a polydentate (multiple bonded) molecule and a single central atom. Polydentate molecules are often organic compounds, and are called ligands, chelants, chelatants, chelators, chelating agents, or sequestering agents.
“Cycloalkyl”: refers to a cyclic alkyl group, that is to say, a monovalent, saturated, or unsaturated hydrocarbyl group having 1 or 2 cyclic structures. Cycloalkyl includes monocyclic or bicyclic hydrocarbyl groups. Cycloalkyl groups may comprise 3 or more carbon atoms in the ring and generally, according to this invention comprise from 3 to 10, more preferably from 3 to 8 carbon atoms still more preferably from 3 to 6 carbon atoms. Examples of cycloalkyl groups include but are not limited to cyclopropyl, cyclobutyl, cyclopentyl, cyclohexyl.
“Cycloalkyloxy”: refers to any O-cycloalkyl group.
“Cycloalkylamino”: refers to any N-cycloalkyl group.
“DABCO”: refers to 1,4-diazabicyclo[2.2.2]octane.
“Heteroalkyl”: refers to a hydrocarbon radical of formula CₙH₂ₙ₊₁ wherein n is a number greater than or equal to 2; in which one or more carbon atoms in one or more of these hydrocarbon radicals can be replaced by oxygen, nitrogen or sulfur atoms. Generally, alkyl groups of this invention comprise from 1 to 12 carbon atoms, preferably from 1 to 6 carbon atoms. Alkyl groups may be linear or branched and may be substituted as indicated herein. Suitable alkyl groups include methyl, ethyl, propyl (n-propyl, i-propyl), butyl (n-butyl, i-butyl, s-butyl and t-butyl), pentyl and its isomers (e.g. n-pentyl, i-pentyl), and hexyl and its isomers (e.g. n-hexyl, i-hexyl).
“Heteroaryl”: refers to a polyunsaturated, aromatic hydrocarbyl group having a single ring or multiple aromatic rings fused together (such as naphtyl) or linked covalently, typically containing 5 to 20, and preferably 6 to 12, carbon atoms having one or more aromatic rings; in which one or more carbon atoms in one or more of these rings can be replaced by oxygen, nitrogen or sulfur atoms.
“Heterocycloalkyl”: refers to a cyclic alkyl group, that is to say, a monovalent, saturated, or unsaturated hydrocarbyl group having 1 or 2 cyclic structures. Cycloalkyl includes monocyclic or bicyclic hydrocarbyl groups. Cycloalkyl groups may comprise 3 or more carbon atoms in the ring and generally, according to this invention comprise from 3 to 10, more preferably from 3 to 8 carbon atoms still more preferably from 3 to 6 carbon atoms; in which one or more carbon atoms in one or more of these rings can be replaced by oxygen, nitrogen or sulfur atoms.
“Ligand”: refers to an ion or molecule that donates a pair of electrons to a metal atom or ion in forming a coordination.
“Metallocenyl”: refers to a group comprising a metal sandwiched between two cyclopentadienyl groups, or a group comprising a metal bounded to the π-cloud of a cyclopentadienyl or similar substituent.
“Organocatalysis”: refers to a form of catalysis, whereby the rate of a chemical reaction is increased by an organic catalyst referred to as an “organocatalyst” consisting of carbon, hydrogen, sulfur and other nonmetal elements found in organic compounds.
“Organophosphorus”: refers to organic compounds containing carbon-phosphorus bonds.
“P-chirogenic”: refers to phosphorus compounds bearing a chirality at the P-center. The enantiomer of the original molecule is obtained by interchanging two substituents of the phosphorus center.
“Phosphine borane”: refers to a complex between a phosphine and the borane (BH₃).
“Ortho position”: refers in the present invention, to the position on the aromatic ring that is adjacent to the position of the phosphorus atom.
“Transition metal salt”: refers to salt of transition-metal ions such as iron, copper, palladium or rhodium associated with chloride, sulfate, nitrate, acetocetonate, tetrafluoroborate, hexafluorophosphate, hexafluoroantimonate, triflate . . . counter anions.
“Transition metal complex”: refers to a specie consisting of a transition metal coordinated (bonded to) one or more ligands (neutral or anionic non-metal species).
“o” refers to ortho; “m” refers to meta; “p” refers to para.
“Ad” represent an adamantyl group, “o-An” represent an o-anisyl group, “o-biPh” represent a o-biphenyl group, “o-Tol” represent a o-tolyl group, “p-Tol” represent a p-tolyl group, “cHex” represent a cyclohexyl group, “Fc” represent a ferrocenyl group, “Ph” represent a phenyl group, “Me” represent a methyl group, “i-Pr” represent a i-propyl group, “m-Xyl” represent a m-xylyl group, “s-Bu” represent a s-butyl group, “t-Bu” represent a t-butyl group, “α-Np” represent a α-naphthyl group and “β-Np” represent a β-naphthyl group.

### DETAILED DESCRIPTION

It is appreciated that in any of the mentioned reactions, any reactive group in the substrate molecules may be protected according to conventional chemical practice. Suitable protecting groups in any of the mentioned reactions are those used conventionally in the art. The methods of formation and removal of such protecting groups are those conventional methods appropriate to the molecule being protected.

### Process for Manufacturing Compound of Formula (I)

The invention relates to a process for manufacturing a compound of formula (I),

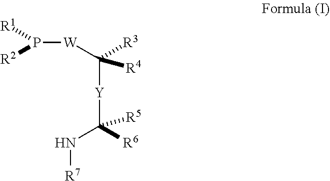

wherein
R¹ and R² may be the same or different and represent each a substituted or unsubstituted group selected from alkyl, alkenyl, cycloalkyl, aryl, bisaryl, metallocenyl and alkyloxy; preferably a substituted or unsubstituted group selected from alkyl, aryl, bisaryl and metallocenyl;
R³ represents a hydrogen atom or a substituted or unsubstituted group selected from alkyl, alkenyl, cycloalkyl and aryl; preferably an substituted or unsubstituted aryl group or a hydrogen atom; R⁵ represents a substituted or unsubstituted group selected from alkyl, alkenyl, cycloalkyl and aryl; preferably an substituted or unsubstituted alkyl group, an substituted or unsubstituted aryl group or a hydrogen atom; or R³ and R⁵ represent together a substituted or unsubstituted group selected from aryl, heteroaryl, cycloalkyl and heterocycloalkyl; preferably an substituted or unsubstituted aryl, or an substituted or unsubstituted cycloalkyl;
R⁴ represents a hydrogen atom or a substituted or unsubstituted group selected from alkyl, alkenyl, cycloalkyl and aryl; preferably an aryl group or a hydrogen atom; R⁶ represents a hydrogen atom or a substituted or unsubstituted group selected from alkyl, alkenyl, cycloalkyl and aryl; preferably a hydrogen atom or a substituted or unsubstituted alkyl group; more preferably a substituted or unsubstituted alkyl group or a hydrogen atom; or R⁴ and R⁶ represent together a substituted or unsubstituted group selected from aryl, heteroaryl, cycloalkyl and heterocycloalkyl; preferably substituted or unsubstituted aryl or substituted or unsubstituted cycloalkyl;
R⁷ represents a hydrogen atom or a substituted or unsubstituted group selected from alkyl, alkenyl, cycloalkyl and aryl; preferably a hydrogen atom or a substituted or unsubstituted group selected from alkyl and aryl; more preferably a hydrogen atom or an alkyl group; even more preferably a hydrogen atom or a methyl group;
Y represents a simple bond or a (CHR⁸)ₙ wherein R⁸ represents a substituted or unsubstituted group selected from alkyl, alkenyl, cycloalkyl and, aryl; preferably a substituted or unsubstituted group selected from alkyl and cycloalkyl; and n represents a positive integer ranging from 1 to 3; preferably Y represents a simple bond or a (CHR⁸)ₙ with n represents 1;
W represents O or S, preferably O.

According to one embodiment, R¹ and R² are different. In this embodiment, compound of formula (I) is P-chirogenic.

According to one embodiment R¹ represent each a substituted or unsubstituted group selected from alkyl, alkenyl, cycloalkyl, aryl, bisaryl, metallocenyl and alkyloxy; preferably a substituted or unsubstituted group selected from alkyl, aryl, bisaryl and metallocenyl. According to one embodiment, R¹ represents a substituted or unsubstituted group selected from phenyl, anisyl, naphtyl, tolyl, adamantyl, biphenyl, methyl, ferrocenyl, preferably phenyl, o-anisyl, α-naphtyl, β-naphtyl, o-tolyl, p-tolyl, adamantyl, o-biphenyl, methyl and ferrocenyl. According to one embodiment, R¹ represents phenyl, t-butyl, methyl, o-anisyl, β-naphtyl, o-tolyl, p-tolyl, o-biphenyl or ferrocenyl.

According to one embodiment R² represent each a substituted or unsubstituted group selected from alkyl, alkenyl, cycloalkyl, aryl, bisaryl, metallocenyl and alkyloxy; preferably a substituted or unsubstituted group selected from alkyl, aryl, bisaryl and metallocenyl. According to one embodiment, R² represents a substituted or unsubstituted group selected from phenyl, anisyl, naphtyl, tolyl, adamantyl, biphenyl, methyl, ferrocenyl, preferably phenyl, o-anisyl, α-naphtyl, β-naphtyl, o-tolyl, p-tolyl, adamantyl, o-biphenyl, methyl and ferrocenyl. According to one embodiment, R² represents phenyl, o-anisyl, α-naphtyl, o-biphenyl, adamantyl or methyl.

According to one embodiment R³ represents a hydrogen atom or a substituted or unsubstituted group selected from alkyl, alkenyl, cycloalkyl and aryl. According to a preferred embodiment R³ represents a hydrogen atom or a substituted or unsubstituted aryl group. According to a preferred embodiment R³ represents a hydrogen atom or a phenyl group.

According to a preferred embodiment R⁴ represents a hydrogen atom or a substituted or unsubstituted aryl group. According to a preferred embodiment R⁴ represents a hydrogen atom or a phenyl group.

According to one embodiment R⁵ represents a hydrogen atom, a substituted or unsubstituted alkyl or a substituted or unsubstituted aryl. According to a preferred embodiment, R⁵ represents an alkyl group or a hydrogen atom. According to a more preferred embodiment R⁵ represents a methyl group or a hydrogen atom.

According to one embodiment R⁶ represents a hydrogen atom, a substituted or unsubstituted alkyl or a substituted or unsubstituted aryl group. According to a preferred embodiment, R⁶ represents an alkyl group or a hydrogen atom. According to a more preferred embodiment, R⁶ represents a methyl group or a hydrogen atom.

According to a preferred embodiment R⁴ and R⁶ represent together a substituted or unsubstituted aryl or cycloalkyl. According to a preferred embodiment R⁴ and R⁶ represent together unsubstituted or substituted group selected from group A and group B:

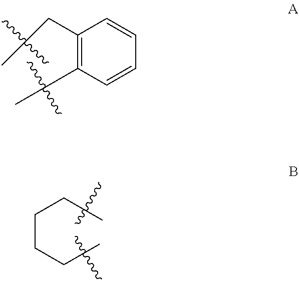 [SMILES: *Cc1ccccc1* ; *CCCC*]

According to a preferred embodiment R³ and R⁵ represent together a substituted or unsubstituted aryl or cycloalkyl. According to a preferred embodiment R³ and R⁵ represent together unsubstituted or substituted group selected from group A and group B.

According to one embodiment R⁷ represents a hydrogen atom or a substituted or unsubstituted group selected from alkyl and aryl. According to a preferred embodiment, R⁷ represents a hydrogen atom or a methyl group.

According to a preferred embodiment R⁷ and R⁵ represent together a substituted or unsubstituted cycloalkyl. According to a preferred embodiment R⁷ and R⁵ represent together unsubstituted or substituted group C

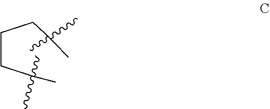 [SMILES: *CCC*]

According to a preferred embodiment R⁷ and R⁶ represent together a substituted or unsubstituted cycloalkyl. According to a preferred embodiment R⁷ and R⁶ represent together unsubstituted or substituted group C.

Y represents a simple bond or a (CHR⁸)ₙ wherein R⁸ represents a substituted or unsubstituted group selected from alkyl, alkenyl, cycloalkyl and aryl; preferably a substituted or unsubstituted group selected from alkyl and cycloalkyl; and n represents a positive integer ranging from 1 to 3; preferably Y represents a simple bond or (CHR⁸)ₙ with n represent 1.

According to a one embodiment R⁸ represents a substituted or unsubstituted group selected from alkyl and cycloalkyl. According to one embodiment n represents a positive integer ranging from 1 to 2. According to another preferred embodiment, n is equal to 1.

According to another preferred embodiment, n is equal to 2.

According to one embodiment W represents O. According to one embodiment W represents S.

According to a specific embodiment, R¹ represents Ph, R² represents o-An, R³ represents hydrogen atom, R⁴ and R⁶ represents together a 1-phenyl-prop-2-yl group, R⁵ represents H, R⁷ represents hydrogen atom, Y represents simple bond, and W represents oxygen atom.

Step (i)—Synthesis of Compound of Formula (IIIa) from Compound of Formula (IV)

Synthesis of compound (IIIa) involves the condensation of phosphorus trichloride PCl₃ with the corresponding aminoalcohol (IV), followed by reaction with a Grignard or an organolithium reagent R¹M², or the condensation of bis-aminophosphines R¹P(N(R⁹)₂)₂ (Scheme 4). This condensation is followed by a complexation of oxazaphosphacycloalcane of formula (Va) with borane.

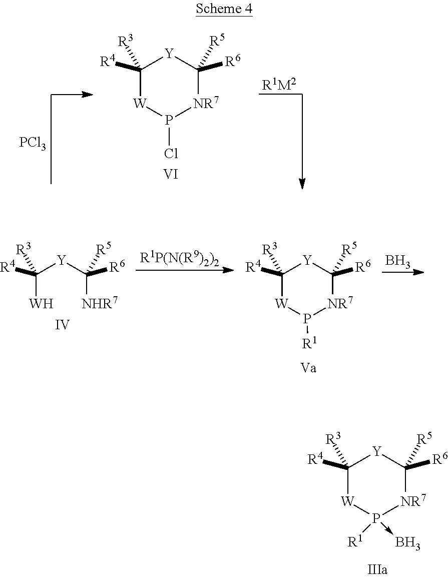

According to one embodiment, compound of formula (IV) is an amino alcohol. According to a preferred embodiment, compound of formula (IV) is a 1,2 aminoalcohol or a 1,3 aminoalcohol. According to one embodiment, R³ is different from R⁴. According to this embodiment, compound of formula (IV) is chiral. According to one embodiment, R⁵ is different from R⁶. According to this embodiment, compound of formula (IV) is chiral.

Particularly preferred amino alcohol (IV) of the invention are those listed in Table 1 hereafter:

TABLE 1

| | Chemical | | | | | | | |
|---|---|---|---|---|---|---|---|---|
| Cpd | Name and | | | | | | | |
| n° | structure | R³ | R⁴ | R⁵ | R⁶ | R⁷ | W | Y^{a} |
| (R,S)- IV1 | 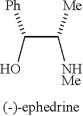 | Ph | H | Me | H | Me | O | L |
| (S,R)- IV2 | 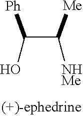 | H | Ph | H | Me | Me | O | L |
| (S,S)- IV3 | 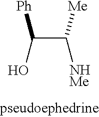 | H | Ph | Me | H | Me | O | L |
| (S)- IV4 | 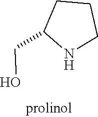 | H | H | 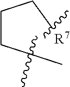 | H | 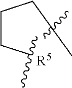 | O | L |
| (S)- IV5 | 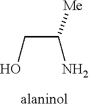 | H | H | Me | H | H | O | L |
| (S)- IV6 | 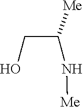 | H | H | Me | H | Me | O | L |
| (S)- IV7 | 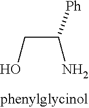 | H | H | Ph | H | H | O | L |
| (S)- IV8 | 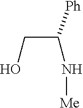 | H | H | Ph | H | Me | O | L |
| (S,S)- IV9 | 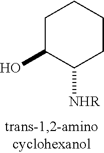 | H | 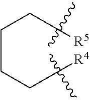 | | H | R | O | L |
| (S,R)- IV10 | 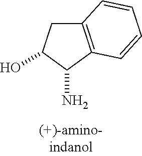 | 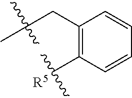 | H | 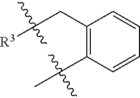 | H | H | O | L |
| IV11 | 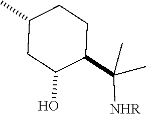 | 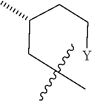 | H | Me | Me | R | O | 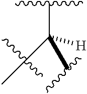 |
| IV12 | 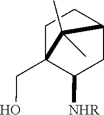 | H | H | H | 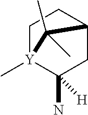 | R | O | 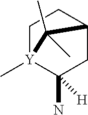 |

^{a}L = simple bond

According to one embodiment, more preferred compound of formula (IV) are ephedrine, pseudoephedrine and (1S,2R)-1-amino-2,3-dihydro-1H-inden-2-ol. According to one embodiment, compound of formula (IV) is (−)-ephedrine. According to one embodiment, compound of formula (IV) is (+)-ephedrine. According to one embodiment, compound of formula (IV) is (S)-prolinol. According to one embodiment, compound of formula (IV) is (1s, 2R)-1-amino-2,3-dihydro-1H-inden-2-ol.

According to one embodiment, compound of formula (IV) reacts with a bis-aminophosphine R¹P(N(R⁹)₂)₂, in which R¹, is as defined above, and R⁹ represents a hydrogen or a substituted or unsubstituted group selected from alkyl, alkenyl, cycloalkyl and aryl. According to a preferred embodiment, R⁹ represents a substituted or unsubstituted alkyl. According to a more preferred embodiment, R⁹ represents methyl or ethyl. According to a more preferred embodiment, R⁹ represents methyl. According to another more preferred embodiment, R⁹ represents ethyl.

According to one embodiment, bis-aminophosphine R¹P(N(R⁹)₂)₂ is selected from bis(dimethylamino)phenylphosphine, bis(diethylamino)phenylphosphine and bis(dimethylamino)methylphosphine.

According to one embodiment, the condensation step with a bis-aminophosphine R¹P(N(R⁹)₂)₂ is carried under heating conditions, at a temperature ranging from 40° C. to 160° C., preferably from 80° C. to 120° C., more preferably around 100° C.

According to one embodiment, the condensation step with a bis-aminophosphine is carried in presence of 1 to 1.5 equivalent, preferably of 1 to 1.1 equivalent of bis-aminophosphine.

According to one embodiment, the solvent used in this step is selected from the group comprising tetrahydrofuran, ether, diethylether, dioxane, benzene, toluene, xylenes, chlorobenzene, chloroform, dimethylsulfoxide and a mixture thereof. According to a preferred embodiment, the solvent used in this step is toluene.

According to another embodiment, compound of formula (IV) reacts with phosphorus trichloride PCl₃ for obtaining a compound of formula (VI):

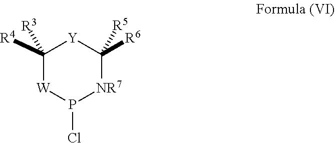

wherein R³, R⁴, R⁵, R⁶, R⁷, Y, and W are as defined above.

According to one embodiment, the condensation step with PCl₃ is carried out under cooling/heating conditions, at a temperature ranging from −80° C. to 40° C., preferably −78° C. then 25° C. after stirring overnight.

The compound of formula (VI) further reacts with a reagent R¹M²; in which M² is a magnesium halide or an alkali metal; resulting in a compound of formula (Va):

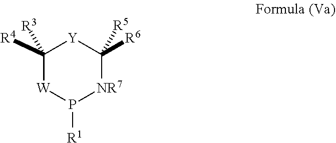

wherein R¹, R³, R⁴, R⁵, R⁶, R⁷, W and Y are as defined above.

According to one embodiment, M² represents MgBr or Li. According to one embodiment, M² represents MgBr. According to another embodiment, M² represents Li.

According to one embodiment, the reaction with the R¹M² reagent is carried in presence of 0.70 equivalent of R¹M² reagent.

According to one embodiment, the reaction with R¹M² reagent is carried under cooling conditions, at temperature ranging from −90° C. to −50° C., preferably from −78° C. to −60° C.

According to one embodiment, the solvent used in this step is selected from the group comprising tetrahydrofuran, ether, diethylether, dioxane, benzene, toluene, xylenes and a mixture thereof. According to a preferred embodiment, the solvent used in this step is tetrahydrofuran.

Compound of formula (Va) reacts with borane BH₃, preferably with BH₃.THF or BH₃.DMS, resulting in the borane complex of formula (IIIa);

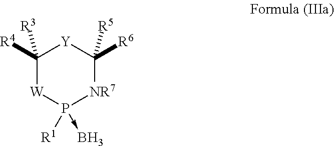

wherein R¹, R³, R⁴, R⁵, R⁶, R⁷, W and Y are as defined above.

According to one embodiment, the borane agent is BH₃.THF. According to another embodiment, the borane agent is BH₃.DMS.

According to one embodiment, complexation step is carried in presence of 1 to 2 equivalents, preferably of 1.5 equivalent of borane agent.

According to one embodiment, the complexation step is carried at room temperature, at a temperature ranging from 10° C. to 30° C., preferably from 15° C. to 28° C., more preferably about 25° C.

According to one embodiment, the solvent used in complexation step is selected from the group comprising tetrahydrofuran, ether, dioxane, benzene, toluene, xylenes, and a mixture thereof. According to a preferred embodiment, the solvent used in complexation step is mixture of tetrahydrofuran and toluene. According to another preferred embodiment, the solvent used in complexation step is mixture of toluene and ether.

According to one embodiment, borane complex of formula (IIIa) is purified by using chromatographic techniques or by recrystallisation.

According to one embodiment, borane complex of formula (IIIa) is obtained with an enantiomeric excess ranging from 0 to 100%, preferably from 85 to 100%. According to one embodiment, borane complex of formula (IIIa) is obtained without racemization, preferably with an enantiomeric excess of more than 85%, preferably of more than 95%, more preferably of 100%.

Step (i)—Alternative Route of Synthesis of Compound of Formula (IIIa)

According to another embodiment, compound (IIIa) may be obtained from compound (IV) via compound of formula (IIIb) and compound of formula (IIb).

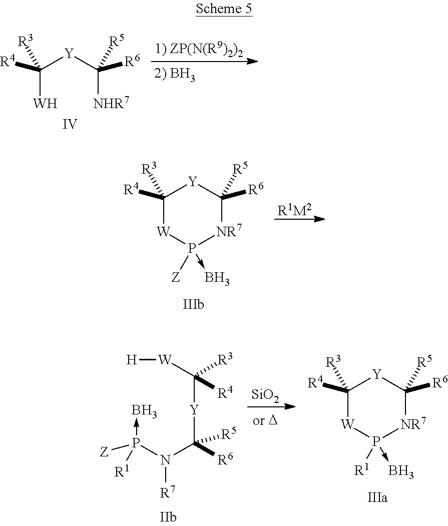

Indeed, the reaction of organolithium reagent with the oxazaphospholidine-borane of formula (IIIb) led to the aminophosphine borane of formula (IIb) by ring opening of the P—O bond (Scheme 5). Interestingly, by reaction with SiO₂ or by heating, the aminophosphine-borane of formula (IIb) led quantitatively to the oxazaphospholidine of formula (IIIa) by elimination of the leaving group. This new reaction offers an efficient route for a general synthesis of oxazaphospholidine variously substituted at the P-center.

Firstly, compound of formula (IV) reacts with a bis-aminophosphine ZP(N(R⁹)₂)₂; wherein Z is leaving group and R⁹ is as defined above; resulting in a compound of formula (Vb).

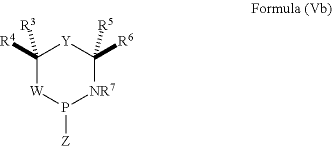

wherein R³, R⁴, R⁵, R⁶, R⁷, Y, W and Z are as defined above

According to one embodiment, Z represent a substituted or unsubstituted group selected from dialkylamino, diarylamino, dicycloalkylamino and alkoxy group. According to a preferred embodiment, Z represents a dialkylamino group. According to another preferred embodiment, Z represents an alkoxy group. According to a more preferred embodiment, Z represents a dimethylamino group. According to another more preferred embodiment, Z represents a methoxy group.

According to one embodiment, ZP(N(R⁹)₂)₂ represents hexamethylphosphorous triamide (P(NMe₂)₃).

According to one embodiment, the condensation step with a bis-aminophosphine ZP(N(R⁹)₂)₂ is carried under heating conditions, at a temperature ranging from 40° C. to 130° C., preferably from 80° C. to 120° C., more preferably around 105° C.

According to one embodiment, the condensation step with a bis-aminophosphine is carried in presence of 1 to 1.5 equivalent, preferably of 1 to 1.1 equivalent of bis-aminophosphine.

According to one embodiment, the solvent used in this step is selected from the group comprising tetrahydrofuran, ether, diethylether, chloroform, dioxane, benzene, toluene, xylenes, chlorobenzene, dimethylsulfoxide and a mixture thereof. According to a preferred embodiment, the solvent used in this step is toluene.

Secondly, the compound of formula (Vb) reacts with borane BH₃, preferably with BH₃.THF or BH₃.DMS, resulting in the borane complex of formula (IIIb).

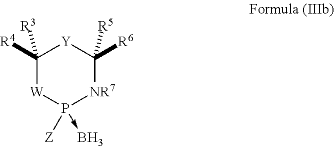

wherein R³, R⁴, R⁵, R⁶, R⁷, Y, W and Z are as defined above;

In a specific embodiment, compound of formula (IIIb) is such that W is a O; Y is a simple bond; Z is a dimethylamino; R³ is a phenyl; R⁴ is a hydrogen atom; R⁵ is a methyl; R⁶ is a hydrogen atom; R⁷ is a methyl.

According to one embodiment, borane complex of formula (IIIb) is purified by using chromatographic techniques or by recrystallisation.

According to one embodiment, compound of formula (IIIb) is obtained with an enantiomeric excess ranging from 0 to 100%, preferably from 85 to 100%. According to one embodiment, compound of formula (IIIb) is obtained without racemization, preferably with an enantiomeric excess of more than 85%, preferably of more than 95%.

The compound of formula (IIIb) further reacts with a reagent R¹M²; in which R¹ is as defined above and M² is an alkali metal; resulting in a compound of formula (IIb);

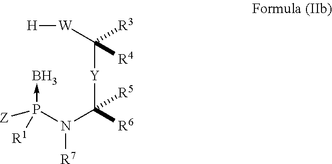

wherein R¹, R³, R⁴, R⁵, R⁶, R⁷, Y, W and Z are as defined above.

According to one embodiment, M² represents Li.

According to one embodiment, the reaction with the R¹M² reagent is carried in presence of 2 to 3, preferably 2 equivalents of R¹M² reagent.

According to one embodiment, the reaction with R¹M² reagent is carried under cooling/heating conditions, at temperature ranging from −90° C. to 50° C., preferably from −78° C. then 25° C.

According to one embodiment, the solvent used in this step is selected from the group comprising tetrahydrofuran, ether, diethylether, dioxane, benzene, chloroform, chlorobenzene, toluene, xylenes, and a mixture thereof. According to a preferred embodiment, the solvent used in this step is tetrahydrofuran.

Compound of formula (IIb) then further reacts with silica gel or is heated to result in compound of formula (IIIa)

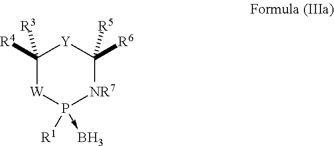

wherein R³, R⁴, R⁵, R⁶, R⁷, Y, and W are as defined above.

According to one embodiment compound of formula (IIb) reacts with silica gel.

According to this embodiment, the solvent used is selected from the group comprising tetrahydrofuran, ether, diethylether, dioxane, benzene, toluene, xylenes, chloroform, dichloromethane and a mixture of these ones. According to a preferred embodiment, the solvent used in this step is a mixture of toluene and dichloromethane.

According to one embodiment, the cyclisation step is carried at room temperature, at a temperature ranging from 10° C. to 30° C., preferably from 15° C. to 28° C., more preferably about 25° C.

According to one embodiment, this step is carried in presence of 2 to 20 equivalents, preferably of 10 equivalents of silica gel.

According to another embodiment compound of formula (IIb) is heated, preferably at a temperature ranging from 25° C. to 100° C., more preferably at a temperature ranging from 30° C. to 60° C., even more preferably at a temperature about 40° C.

According to this embodiment, the solvent used is selected from the group comprising tetrahydrofuran, ether, diethylether, dioxane, benzene, chlorobenzene, toluene, xylenes, chloroform, dichloromethane and a mixture thereof. According to a preferred embodiment, the solvent used in this step is a mixture of toluene and dichloromethane.

According to another embodiment, compound of formula (IIb) further reacts with silica gel at a temperature ranging from 25° C. to 60° C.

According to one embodiment, borane complex of formula (IIIa) is purified by using chromatographic techniques or by recrystallisation.

According to one embodiment, borane complex of formula (IIIa) is obtained with an enantiomeric excess ranging from 0 to 100%, preferably from 85 to 100%. According to one embodiment, borane complexe of formula (IIIa) is obtained without racemization, preferably with an enantiomeric excess of more than 85%, preferably of more than 95%.

Step (ii)—Synthesis of Compound of Formula (IIa) from Compound of Formula (IIIa)

According to one embodiment, the process further comprises the reaction between compound of formula (IIIa)

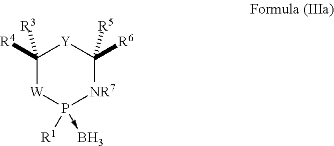

wherein R¹, R³, R⁴, R⁵, R⁶, R⁷, Y, and W are as defined above;
   and a reagent R²M¹, in which M¹ and R² is as defined above, resulting in the compound of formula (IIa).

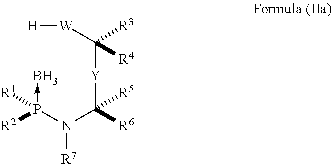

According to one embodiment, the reaction with the R²M¹ reagent is carried in presence of 1 to 3 equivalents, preferably 2 equivalents of R²M¹ reagent.

According to one embodiment, the reaction between compound of formula (IIIa) and R²M¹ is carried under cooling/heating conditions, at temperature ranging from −90° C. to 50° C., preferably from −78° C. to 25° C.

According to one embodiment, the solvent used in this step is selected from the group comprising tetrahydrofuran, diethylether, dioxane, benzene, toluene, xylenes, and a mixture thereof. According to a preferred embodiment, the solvent used in this step is tetrahydrofuran.

According to one embodiment, compound of formula (IIa) is purified by using chromatographic techniques or by recrystallisation.

According to one embodiment, compound of formula (IIa) is obtained without racemization, preferably with an enantiomeric excess of more than 85%, preferably of more than 95%.

Step (iii)—Synthesis of Compound of Formula (I) from Compound of Formula (IIa)

Synthesis of compound (I) from intermediate compound (IIa), involves the deprotection of the phosphorus atom by removing of the borane protective group, followed by a P*N, P*O rearrangement.

According to one embodiment, removing of the borane group is carried out by classical methods of removal of the borane group known of a skilled artisan. According to a preferred embodiment, removing of the borane group is achieved using an amine According to a more preferred embodiment, removing of the borane group is achieved using a mono or a diamine According to a more preferred embodiment, removing of the borane group is achieved using 1,4-diazabicyclo[2.2.2]octane (DABCO), diethylamine, triethylamine or morpholine. According to an even more preferred embodiment, removing of the borane group is achieved using 1,4-diazabicyclo[2.2.2]octane (DABCO) as reactive agent according to a similar procedure described in Brisset H., Gourdel Y., Pellon P. and Le Corre M., Tetrahedron Lett., 1993, 34, 4523-4526.

According to another embodiment, removing of the borane group is carried out by warming compound (IIa) in ethanol, amines or olefines. According to a preferred embodiment the temperature is ranging from 20° C. to 80° C. According to a more preferred embodiment the temperature is ranging from 30° C. to 60° C. According to an even more preferred embodiment, the process is performed at a temperature about 50° C.

According to one embodiment, removing of the borane group and the P*N, P*0 rearrangement occur without racemization.

### Compounds

The present invention also relates to a compound of formula (I)

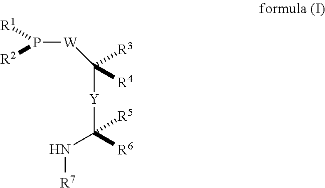

wherein R¹, R², R³, R⁴, R⁵, R⁶, R⁷, Y, and W are as defined above.

According to one embodiment, R¹ and R² are not a phenyl group. According to one embodiment, R¹ and R² are differents. According to one embodiment, when R¹ is phenyl group, then R² is not phenyl group. According to one embodiment, when R¹ is methoxy group, then R² is not phenyl group. According to one embodiment, when R² is methoxy group, then R¹ is not phenyl group. According to one embodiment, when R² is alkyloxy group, then R¹ is not phenyl group. According to one embodiment, when R¹ is alkyloxy group, then R² is not phenyl group.

According to a specific embodiment, R¹ represents Ph, R² represents o-An, R³ represents a phenyl, R⁴ and R⁶ represents together a hydrogen, R⁵ represents a methyl, R⁷ represents a methyl, Y represents simple bond, and W represents oxygen atom.

Particularly preferred compounds of formula (I) of the invention are those listed in Table 2 hereafter:

TABLE 2

| Cpd | Chemical name | R¹ | R² | R³ | R⁴ | R⁵ | R⁶ | R⁷ | W | Y^{a} |
|---|---|---|---|---|---|---|---|---|---|---|
| (Sₚ)-I1 | N-Methyl,N-{(1S,2R)- | t-Bu | Ph | H | Ph | H | Me | Me | O | L |
| | [1-(S)-t-butylphenyl- | | | | | | | | | |
| | phosphinito]-1-phenyl- | | | | | | | | | |
| | prop-2-yl}amine | | | | | | | | | |
| (Sₚ)-I2 | N-Methyl,N-{(1R,2S)- | Ph | o-An | Ph | H | Me | H | Me | O | L |
| | [1-(S)-o-anisylphenyl- | | | | | | | | | |
| | phosphinito]-1-phenyl- | | | | | | | | | |
| | prop-2-yl}amine | | | | | | | | | |
| (Rₚ)-I3 | N-Methyl,N-{(1S,2R)- | Fc | Ph | H | Ph | H | Me | Me | O | L |
| | [1-(R)-ferrocenylphenyl- | | | | | | | | | |
| | phosphinito]-1-phenyl- | | | | | | | | | |
| | prop-2-yl}amine | | | | | | | | | |
| (Sₚ)-I4 | N-Methyl,N-{(1S,2R)- | Me | Ph | H | Ph | H | Me | Me | O | L |
| | [1-(S)-methylphenyl- | | | | | | | | | |
| | phosphinito]-1-phenyl- | | | | | | | | | |
| | prop-2-yl}amine | | | | | | | | | |
| (Rₚ)-I5 | N-Methyl,N-{(1S,2R)- | o- | Ph | H | Ph | H | Me | Me | O | L |
| | [1-(R)-phenyl-o-tolyl- | Tol | | | | | | | | |
| | phosphinito]-1-phenyl- | | | | | | | | | |
| | prop-2-yl}amine | | | | | | | | | |
| (Sₚ)-I6 | N-Methyl,N-{(1R,2S)- | Ph | α-Np | Ph | H | Me | H | Me | O | L |
| | [1-(S)-α-naphtylphenyl- | | | | | | | | | |
| | phosphinito]-1-phenyl- | | | | | | | | | |
| | prop-2-yl}amine | | | | | | | | | |
| (Rₚ)-I7 | N-Methyl,N-{(1S,2R)- | o- | Ph | H | Ph | H | Me | Me | O | L |
| | [1-(R)-o-biphenylphenyl- | biPh | | | | | | | | |
| | phosphinito]-1-phenyl- | | | | | | | | | |
| | prop-2-yl}amine | | | | | | | | | |
| (Sₚ)-I7 | N-Methyl,N-{(1S,2R)- | Ph | o- | H | Ph | H | Me | Me | O | L |
| | [1-(S)-o-biphenylphenyl- | | biPh | | | | | | | |
| | phosphinito]-1-phenyl- | | | | | | | | | |
| | prop-2-yl}amine | | | | | | | | | |
| (Rₚ)-I8 | 1,1′-Bis{(R)-[(1S,2R)-2- | 1,1′- | Ph | H | Ph | H | Me | Me | O | L |
| | (N-methyl)amino-1- | Fc | | | | | | | | |
| | phenylpropyl-1-oxy] | | | | | | | | | |
| | phenylphosphino} | | | | | | | | | |
| | ferrocene | | | | | | | | | |
| (Rₚ)-I9 | N-Methyl,N-{(1R,2S)- | Ph | Ad | Ph | H | Me | H | Me | O | L |
| | [1-(R)-o-adamantyl- | | | | | | | | | |
| | phenylphosphinito]-1- | | | | | | | | | |
| | phenyl-prop-2-yl}amine | | | | | | | | | |
| (Rₚ)-I10 | N-Methyl,N-{(1S,2R)- | p- | Ph | H | Ph | H | Me | Me | O | L |
| | [1-(R)-phenyl-p-tolyl- | Tol | | | | | | | | |
| | phosphinito]-1-phenyl- | | | | | | | | | |
| | prop-2-yl}amine | | | | | | | | | |
| (Rₚ)-I11 | N-Methyl,N-{(1S,2R)- | β-Np | Ph | H | Ph | H | Me | Me | O | L |
| | [1-(R)-β-naphtylphenyl- | | | | | | | | | |
| | phosphinito]-1-phenyl- | | | | | | | | | |
| | prop-2-yl}amine | | | | | | | | | |
| (Rₚ)-I12 | (1S,2R)-N-{(1-(R)-o- anisylphenylphosphinito)- 2,3-dihydro-1H-inden- 2-ol}amine | o-An | Ph | 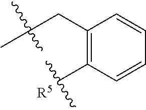 | H | 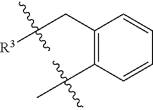 | H | H | O | L |
| (Sₚ)-I13 | (S)-2-[(S)-o-anisyl- phenylphosphinito- methyl]pyrrolidine | Ph | o-An | H | H | 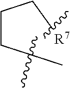 | H | 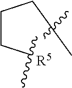 | O | L |

^{a}L = simple bond;

The present invention also relates to a compound of formula (IIa)

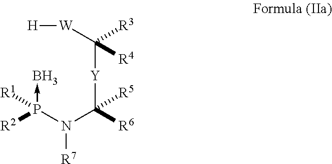

wherein R¹, R², R³, R⁴, R⁵, R⁶, R⁷, Y, and W are as defined above.
According to one embodiment, R¹ and R² are not a phenyl group. According to one embodiment, R¹ and R² are differents. Particularly preferred compounds of formula (IIa) of the invention are those listed in Table 3 hereafter:

TABLE 3

| Cpd | Chemical name | R¹ | R² | R³ | R⁴ | R⁵ | R⁶ | R⁷ | W | Y^{a} |
|---|---|---|---|---|---|---|---|---|---|---|
| (Sₚ)-IIa1 | (Sₚ)-(+)-N- | t-Bu | Ph | H | Ph | H | Me | Me | O | L |
| | methyl,N-[(1S,2R) | | | | | | | | | |
| | (1-hydroxy- | | | | | | | | | |
| | 1-phenyl-prop-2- | | | | | | | | | |
| | yl]amino-t- | | | | | | | | | |
| | butylphenyl- | | | | | | | | | |
| | phosphine- | | | | | | | | | |
| | borane | | | | | | | | | |
| (Rₚ)-IIa2 | (Rₚ)-(+)-N- | Ph | t-Bu | Ph | H | Me | H | Me | O | L |
| | methyl,N-[(1R,2S) | | | | | | | | | |
| | (1-hydroxy- | | | | | | | | | |
| | 1-phenyl-prop-2- | | | | | | | | | |
| | yl]amino-t- | | | | | | | | | |
| | butylphenylphos- | | | | | | | | | |
| | phine-borane | | | | | | | | | |
| (Rₚ)-IIa3 | (Rₚ)-(+)-N- | o-An | Ph | H | Ph | H | Me | Me | O | L |
| | methyl,N-[(1S,2R) | | | | | | | | | |
| | (1-hydroxy- | | | | | | | | | |
| | 1-phenyl-prop-2- | | | | | | | | | |
| | yl]-o-anisyl- | | | | | | | | | |
| | phenylphosphine- | | | | | | | | | |
| | borane | | | | | | | | | |
| (Sₚ)-IIa3 | (Sₚ)-(+)-N- | Ph | o-An | Ph | H | Me | H | Me | O | L |
| | methyl,N-[(1R,2S) | | | | | | | | | |
| | (1-hydroxy- | | | | | | | | | |
| | 1-phenyl-prop-2- | | | | | | | | | |
| | yl]amino-o- | | | | | | | | | |
| | anisylphenyl- | | | | | | | | | |
| | phosphine- | | | | | | | | | |
| | borane | | | | | | | | | |
| (Rₚ)-IIa4 | (Rₚ)-(+)-N- | Fc | Ph | H | Ph | H | Me | Me | O | L |
| | methyl,N-[(1S,2R) | | | | | | | | | |
| | (1-hydroxy- | | | | | | | | | |
| | 1-phenyl-prop-2- | | | | | | | | | |
| | yl]amino- | | | | | | | | | |
| | ferrocenylphenyl- | | | | | | | | | |
| | phosphine- | | | | | | | | | |
| | borane | | | | | | | | | |
| (Sₚ)-IIa5 | (Sₚ)-(+)-N- | Me | Ph | H | Ph | H | Me | Me | O | L |
| | methyl-N-[(1S,2R) | | | | | | | | | |
| | (1-hydroxy- | | | | | | | | | |
| | 1-phenyl-prop-2- | | | | | | | | | |
| | yl]methyl- | | | | | | | | | |
| | phenyl- | | | | | | | | | |
| | phosphine- | | | | | | | | | |
| | borane | | | | | | | | | |
| (Rₚ)-IIa6 | (Rₚ)-(+)-N- | o-Tol | Ph | H | Ph | H | Me | Me | O | L |
| | methyl,N-[(1S,2R) | | | | | | | | | |
| | (1-hydroxy- | | | | | | | | | |
| | 1-phenyl-prop-2- | | | | | | | | | |
| | yl]amino-o-tolyl- | | | | | | | | | |
| | phenylphosphine- | | | | | | | | | |
| | borane | | | | | | | | | |
| (Sₚ)-IIa7 | (Sₚ)-N-methyl,N- | Ph | α-Np | Ph | H | Me | H | Me | O | L |
| | [(1R,2S)-(1- | | | | | | | | | |
| | hydroxy-1- | | | | | | | | | |
| | phenyl-prop-2- | | | | | | | | | |
| | yl)]amino-α- | | | | | | | | | |
| | naphtylphenyl- | | | | | | | | | |
| | phosphine- | | | | | | | | | |
| | borane | | | | | | | | | |
| (Rₚ)-IIa8 | (Rₚ)-(+)-N- | o-biPh | Ph | H | Ph | H | Me | Me | O | L |
| | methyl,N-[(1S,2R) | | | | | | | | | |
| | (1-hydroxy- | | | | | | | | | |
| | 1-phenyl-prop-2- | | | | | | | | | |
| | yl]amino-o- | | | | | | | | | |
| | biphenyl-phenyl- | | | | | | | | | |
| | phosphine- | | | | | | | | | |
| | borane | | | | | | | | | |
| (Sₚ)-IIa8 | (Sₚ)-(+)-N- | Ph | o-biPh | H | Ph | H | Me | Me | O | L |
| | methyl,N- | | | | | | | | | |
| | [(1S,2R)-(1- | | | | | | | | | |
| | hydroxy-1- | | | | | | | | | |
| | phenyl-prop-2- | | | | | | | | | |
| | yl)]amino-o- | | | | | | | | | |
| | biphenyl-phenyl- | | | | | | | | | |
| | phosphine- | | | | | | | | | |
| | borane | | | | | | | | | |
| (Rₚ,Rₚ)- | (Rₚ,Rₚ)-1,1′-bis- | 1,1′- | Ph | H | Ph | H | Me | Me | O | L |
| IIa9 | {N-methyl,N- | Fc | | | | | | | | |
| | [(1S,2R) (1- | | | | | | | | | |
| | hydroxy-1- | | | | | | | | | |
| | phenyl-prop-2- | | | | | | | | | |
| | yl)amino]phenyl- | | | | | | | | | |
| | phosphino- | | | | | | | | | |
| | borane}ferrocene | | | | | | | | | |
| (Rₚ)-IIa10 | (Rₚ)-(+)-N- | Ph | Ad | Ph | H | Me | H | Me | O | L |
| | methyl-N-[(1R,2S) | | | | | | | | | |
| | (1-hydroxy- | | | | | | | | | |
| | 1-phenyl-prop-2- | | | | | | | | | |
| | yl]-adamantyl- | | | | | | | | | |
| | phenylphosphine- | | | | | | | | | |
| | borane | | | | | | | | | |
| (Rₚ)-IIa11 | (Rₚ)-(+)-N- | p-Tol | Ph | H | Ph | H | Me | Me | O | L |
| | methyl-N- | | | | | | | | | |
| | [(1S,2R)(1- | | | | | | | | | |
| | hydroxy-1- | | | | | | | | | |
| | phenyl-prop-2- | | | | | | | | | |
| | yl]amino- | | | | | | | | | |
| | phenyl-p-tolyl- | | | | | | | | | |
| | phosphine- | | | | | | | | | |
| | borane | | | | | | | | | |
| (Rₚ)-IIa12 | (Rₚ)-(+)-N- | β-Np | Ph | H | Ph | H | Me | Me | O | L |
| | methyl,N- | | | | | | | | | |
| | [(1S,2R)(1- | | | | | | | | | |
| | hydroxy-1- | | | | | | | | | |
| | phenyl-prop-2- | | | | | | | | | |
| | yl]amino-β- | | | | | | | | | |
| | naphtylphenyl- | | | | | | | | | |
| | phosphine-borane | | | | | | | | | |
| (Rₚ)-IIa13 | (1S,2R)-N-[1- (Rₚ)-o- anisylphenylphos- phinamino- borane]-2,3- dihydro-1H- inden-2-ol | o-An | Ph | 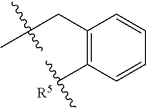 | H | 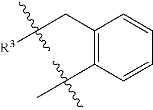 | H | H | O | L |
| (Sₚ)-IIa14 | (S)-N-[(Sₚ)-o- anisylphenyl- phosphino- borane]proline | Ph | o-An | H | H | 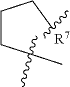 | H | 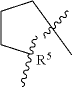 | O | L |
| (Rₚ)-IIa15 | (Rₚ)-N-methyl,N- | Ph | MeO | H | Ph | H | Me | Me | O | L |
| | [(1S,2R)-(1- | | | | | | | | | |
| | hydroxy-1- | | | | | | | | | |
| | phenylprop-2- | | | | | | | | | |
| | yl)]aminomethoxy- | | | | | | | | | |
| | phenyl- | | | | | | | | | |
| | phosphine- | | | | | | | | | |
| | borane | | | | | | | | | |

^{a}L = simple bond

The present invention also relates to a compound of formula (IIb)

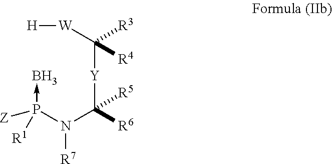

wherein R¹, R³, R⁴, R⁵, R⁶, R⁷, Z, Y, and W are as defined above.

According to a specific embodiment, R¹ represents Me, Z represent NMe₂, R³ represents a phenyl, R⁴ and R⁶ represents together a hydrogen, R⁵ represents a methyl, R⁷ represents a methyl, Y represents simple bond, and W represents oxygen atom.

Particularly preferred compounds of formula (IIb) of the invention are those listed in Table 4 hereafter:

TABLE 4

| Cpd | Chemical name | Z | R¹ | R³ | R⁴ | R⁵ | R⁶ | R⁷ | W | Y^{a} |
|---|---|---|---|---|---|---|---|---|---|---|
| (Rₚ)- | N,N-Dimethyl- | N(Me)₂ | Me | Ph | H | Me | H | Me | O | L |
| IIb1 | amino{N- | | | | | | | | | |
| | methyl,N- | | | | | | | | | |
| | [(1R,2S)- | | | | | | | | | |
| | (1-hydroxy- | | | | | | | | | |
| | 1-phenyl- | | | | | | | | | |
| | prop-2-yl)]amino} | | | | | | | | | |
| | methylphosphine- | | | | | | | | | |
| | borane | | | | | | | | | |
| (Rₚ)- | N,N-Dimethyl- | N(Me)₂ | Ph | Ph | H | Me | H | Me | O | L |
| IIb2 | amino{N- | | | | | | | | | |
| | methyl,N- | | | | | | | | | |
| | [(1R,2S)- | | | | | | | | | |
| | (1-hydroxy- | | | | | | | | | |
| | 1-phenyl- | | | | | | | | | |
| | prop-2-yl)]}amino | | | | | | | | | |
| | phenyphosphine- | | | | | | | | | |
| | borane | | | | | | | | | |

^{a}L = simple bond;

The present invention also relates to a compound of formula (IIIa)

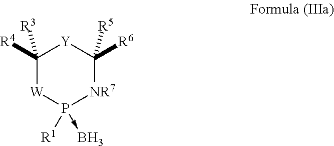

wherein R¹, R³, R⁴, R⁵, R⁶, R⁷, Y, and W are as defined above;

According to a specific embodiment, R¹ represents Ph, R³ represents hydrogen atom, R⁴ and R⁶ represents together a 1-phenyl-prop-2-yl group, R⁵ represents H, R⁷ represents hydrogen atom, Y represents simple bond, and W represents oxygen atom.

Particularly preferred compounds of formula (IIIa) of the invention are those listed in Table 5 hereafter:

TABLE 5

| Cpd n° | Chemical name | R¹ | R³ | R⁴ | R⁵ | R⁶ | R⁷ | W | Y^{a} |
|---|---|---|---|---|---|---|---|---|---|
| (Sₚ)- | 2-phenyl-1,3,2- | Ph | H | Ph | H | Me | Me | O | L |
| IIIa1 | oxazaphospholidine- | | | | | | | | |
| | borane | | | | | | | | |
| (Rₚ)- | 2-phenyl-1,3,2- | Ph | Ph | H | Me | H | Me | O | L |
| IIIa1 | oxazaphospholidine- | | | | | | | | |
| | borane | | | | | | | | |
| (Sₚ)- | 2-(o-biphenyl)- | o-biPh | H | Ph | H | Me | Me | O | L |
| IIIa2 | 1,3,2-oxaza- | | | | | | | | |
| | phospholidine- | | | | | | | | |
| | borane | | | | | | | | |
| (Rₚ)- | 2-methyl-1,3,2- | Me | Ph | H | Me | H | Me | O | L |
| IIIa3 | oxazaphospholi- | | | | | | | | |
| | dine-borane | | | | | | | | |
| (Rₚ)- IIIa4 | (R)-(1S,2R)-N- [2,3-dihydro-1H- inden-2-oxy] aminephenyl- phosphine-borane | Ph | 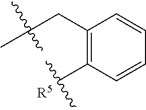 | H | 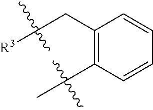 | H | H | O | L |
| (Rₚ)- IIIa5 | 2-phenyl-1,3,2- oxazaphospha- bicyclo[3.3.0] octane-borane | Ph | H | H | 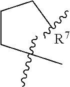 | H | 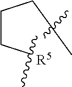 | O | L |

^{a}L = single bond

The present invention also relates to a compound of formula (IIIb)

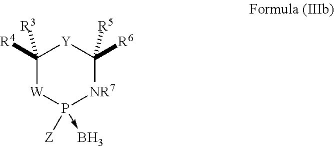

wherein R³, R⁴, R⁵, R⁶, R⁷, Z, Y, and W are as defined above;

Particularly preferred compounds of formula (IIIb) of the invention are those listed in Table 6 hereafter:

TABLE 6

| Cpd | | | | | | | | | |
|---|---|---|---|---|---|---|---|---|---|
| no | Chemical name | Z | R³ | R⁴ | R⁵ | R⁶ | R⁷ | W | Y^{a} |
| (Rₚ)- | 2-dimethylamino- | NMe₂ | Ph | H | Me | H | Me | O | L |
| IIIb1^{c} | 1,3,2- | | | | | | | | |
| | oxazaphospholidine- | | | | | | | | |
| | borane | | | | | | | | |

^{a}L= single bond

### Process for Manufacturing Further Compounds

In another aspect, the invention provides a process to manufacture compounds of formula (VII) by reacting phosphinites of formula (I) with sulfur (Scheme 6).

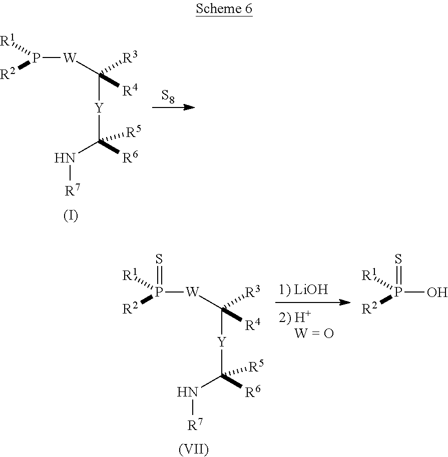

According to one embodiment, sulfuration of phosphinites is carried in presence of an excess of sulfur, preferably in presence of 2 equivalents of sulfur S₈.

According to one embodiment, the complexation step is carried at room temperature, at a temperature ranging from 10° C. to 30° C., preferably from 15° C. to 28° C., more preferably about 25° C.

According to one embodiment, the solvent used in sulfuration is selected from the group comprising tetrahydrofuran, ether, dioxane, benzene, toluene, xylenes, chlorobenzene and a mixture thereof. According to a preferred embodiment, the solvent used in sulfuration is toluene.

According to one embodiment, thiophosphinites of formula (VII) are purified by using chromatographic techniques or by recrystallisation.

According to one embodiment, the process to manufacture a compound of formula (VII) is carried out without racemization. According to one embodiment, the process to manufacture a compound of formula (VII) is carried out with retention of configuration.

The present invention also relates to a compound of formula (VII)

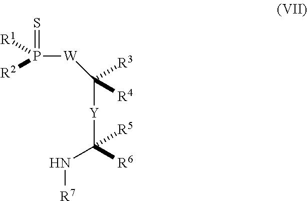

wherein R³, R⁴, R⁵, R⁶ R⁷, Y and W are as defined above; R¹ and R² may be the same or different and represent each a substituted or unsubstituted group selected from alkyl, alkenyl, cycloalkyl, aryl, bisaryl, and metallocenyl; preferably a substituted or unsubstituted group selected from alkyl, aryl, bisaryl and metallocenyl.

According to one embodiment, R¹ and R² are not a phenyl group. According to one embodiment, R¹ and R² are differents.

Particularly preferred compounds of formula (VII) of the invention are those listed in Table 7 hereafter:

TABLE 7

| Cpd | | | | | | | | | | |
|---|---|---|---|---|---|---|---|---|---|---|
| no | Chemical name | R₁ | R₂ | R₃ | R₄ | R₅ | R₆ | R₇ | W | Y^{a} |
| (Rₚ)- | N-Methyl,N- | Ph | o-An | Ph | H | Me | H | Me | O | L |
| VII1 | {(1R,2S-[1-(Rₚ)-o- | | | | | | | | | |
| | anisylphenylthio- | | | | | | | | | |
| | phosphinito]-1- | | | | | | | | | |
| | phenyl-prop-2-yl} | | | | | | | | | |
| | amine | | | | | | | | | |
| (Rₚ)- | N-Methyl, N- | t-Bu | Ph | H | Ph | H | Me | Me | O | L |
| VII2 | {(1S,2R)-[1-(Rₚ)- | | | | | | | | | |
| | t-butylphenylthio- | | | | | | | | | |
| | phosphinito]-1- | | | | | | | | | |
| | phenyl-prop-2-yl} | | | | | | | | | |
| | amine | | | | | | | | | |
| (Sₚ)- | N-Methyl,N- | Fc | Ph | H | Ph | H | Me | Me | O | L |
| VII3 | {(1S,2R)-[1-(Sₚ)- | | | | | | | | | |
| | ferrocenylphenyl- | | | | | | | | | |
| | thiophosphinito]- | | | | | | | | | |
| | 1-phenyl-prop-2- | | | | | | | | | |
| | yl}amine | | | | | | | | | |

^{a}L: simple bond

In another aspect, the invention provides a process to manufacture compounds of formula (VIII) by reacting phosphinites of formula (I) with a chlorophosphine in presence of amine (Scheme 7). The aminophosphine phosphinites AMPP* (VIII) may be isolated as diborane complexes of formula (VIIIb). The decomplexation of borane complexes of formula (VIIIb) into free AMPP* of formula (VIII) is carried out by classical methods of removal of the borane group (Scheme 7).

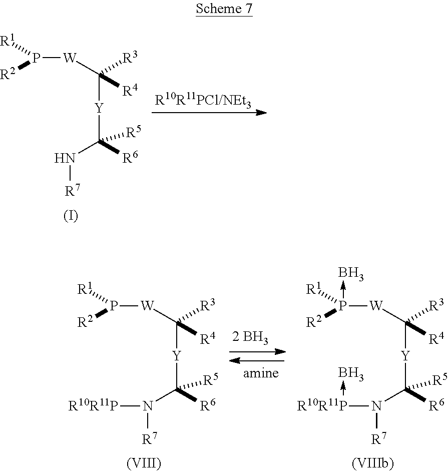

According to one embodiment, the amine is a trialkylamine, preferably triethylamine

According to one embodiment, this step is carried in presence of 1 to 5 equivalents, preferably of 2 equivalents of chlorophosphine R¹⁰R¹¹PCl.

According to one embodiment, this step is carried in presence of 1 to 10 equivalents, preferably of 5 equivalents of amine

According to one embodiment, this step is carried at room temperature, preferably at a temperature around 25° C.

According to one embodiment, the solvent used in this step is selected from the group comprising tetrahydrofuran, ether, dioxane, benzene, toluene, xylenes, chlorobenzene and a mixture thereof. According to a preferred embodiment, the solvent used in this step is toluene.

According to one embodiment, aminophosphine phosphinites of formula (VIII) are purified as borane complexes of formula (VIIIb) by using chromatographic techniques or by recrystallisation.

According to one embodiment, aminophosphine phosphinites of formula (VIIIb) are obtained with an enantiomeric excess ranging from 0 to 100%, preferably from 85 to 100%. According to one embodiment, compound of formula (VIIIb) is obtained without racemization, preferably with an enantiomeric excess of more than 85%, preferably of more than 95%.

The present invention also relates to a compound of formula (VIII)

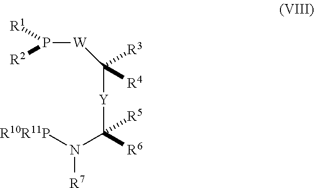

wherein R¹, R², R³, R⁴, R⁵, R⁶, R⁷, R¹⁰, R¹¹ Y and W are as defined above.

According to one embodiment, when R¹, R¹⁰ and R¹¹ are phenyl groups and {R³, R⁴} is {H, Ph} or {Ph, H} and {R⁵, R⁶} is {H, Me} or {Me, H} and R⁷ is methyl group, and W is O and Y is a simple bond, then R² is not phenyl, o-anisyl or methyl group. According to one embodiment, when R¹, R¹⁰ and R¹¹ are phenyl groups and {R³, R⁴} is {H, Ph} or {Ph, H} and {R⁵, R⁶} is {H, Ph} or {Ph, H} and R⁷ is methyl group, and W is O and Y is a simple bond, then R² is not phenyl, o-anisyl or methyl group. According to one embodiment, when R¹, R¹⁰ and R¹¹ are phenyl groups and {R³, R⁴} is {H, H} and {R⁵, R⁶} is {H, Ph} or {Ph, H} and R⁷ is methyl group, and W is O and Y is a simple bond, then R² is not phenyl, o-anisyl or methyl group.

According to one embodiment, when R¹, R¹⁰ and R¹¹ are phenyl groups, R² is not phenyl. According to one embodiment, when R¹, R¹⁰ and R¹¹ are phenyl groups, R² is not phenyl, o-anisyl or methyl group. According to one embodiment, R¹ and R¹⁰ are not phenyl group. According to one embodiment, R¹ and R¹⁰ are not methyl group.

Particularly preferred compounds of formula (VIII) and formula (VIIIb) of the invention are those listed in Table 8 hereafter:

TABLE 8

| | | | | | | | | | | | | | Cpd |
|---|---|---|---|---|---|---|---|---|---|---|---|---|---|
| Compound (VIII) | | | | | | | | | | | | | (VIIIb) |
| Cpd | Chemical name | R₁ | R₂ | R₃ | R₄ | R₅ | R₆ | R₇ | R₁₀ | R₁₁ | W | Y^{a} | Cpd |
| (Sₚ)- | N-Methyl,N-{(1S,2R)-[1-(Sₚ)- | t-Bu | Ph | H | Ph | H | Me | Me | Ph | Ph | O | L | (Sₚ)- |
| VIII1 | t-butylphenylphosphinito]-1- | | | | | | | | | | | | VIIIb1 |
| | phenyl-prop-2-yl}amino- | | | | | | | | | | | | |
| | diphenylphosphine | | | | | | | | | | | | |
| (Sₚ)- | N-Methyl,N-{(1R,2S)-[1-(Sₚ)- | Ph | o-An | Ph | H | Me | H | Me | Ph | Ph | O | L | (Sₚ)- |
| VIII2 | o-anisylphenylphosphinito]-1- | | | | | | | | | | | | VIIIb2 |
| | phenyl-prop-2-yl}amino- | | | | | | | | | | | | |
| | diphenylphosphine | | | | | | | | | | | | |
| (Rₚ)- | N-Methyl,N-{(1S,2R)-[1-(Rₚ)- | Fc | Ph | H | Ph | H | Me | Me | Ph | Ph | O | L | (Rₚ) |
| VIII3 | ferrocenylphenylphosphinito]- | | | | | | | | | | | | VIIIb3 |
| | 1-phenyl-prop-2-yl}amino- | | | | | | | | | | | | |
| | diphenylphosphine | | | | | | | | | | | | |
| (Rₚ)- | N-Methyl,N-{(1S,2R)-[1-(Rₚ)- | o-Tol | Ph | H | Ph | H | Me | Me | Ph | Ph | O | L | (Rₚ) |
| VIII4 | phenyl-o-tolylphosphinito]-1- | | | | | | | | | | | | VIIIb4 |
| | phenyl-prop-2-yl}amino- | | | | | | | | | | | | |
| | diphenylphosphine | | | | | | | | | | | | |
| (Sₚ)- | N-Methyl,N-{(1R,2S)-[1-(Sₚ)- | Ph | α-Np | Ph | H | Me | H | Me | Ph | Ph | O | L | (Sₚ)- |
| VIII5 | α-naphtylphenylphosphinito]- | | | | | | | | | | | | VIIIb5 |
| | 1-phenyl-prop-2-yl}amino- | | | | | | | | | | | | |
| | diphenylphosphine | | | | | | | | | | | | |
| (Rₚ)- | N-Methyl,N-{(1S,2R)-[1-(Rₚ)- | o-biPh | Ph | H | Ph | H | Me | Me | Ph | Ph | O | L | (Rₚ) |
| VIII6 | (o-biphenyl)phenyl- | | | | | | | | | | | | VIIIb6 |
| | phosphinito]-1-phenyl-prop-2- | | | | | | | | | | | | |
| | yl}aminodiphenylphosphine | | | | | | | | | | | | |
| (Sₚ)- | N-Methyl,N-{(1S,2R)-[1-(Sₚ)- | Ph | o-biPh | H | Ph | H | Me | Me | Ph | Ph | O | L | (Sₚ)- |
| VIII7 | (o-biphenyl)phenyl- | | | | | | | | | | | | VIIIb7 |
| | phosphinito]-1-phenyl-prop-2- | | | | | | | | | | | | |
| | yl}aminodiphenylphosphine | | | | | | | | | | | | |
| (Rₚ)- VIII8 | (1S,2R)-N-{(1-(Rₚ)-o-anisyl- phenylphosphinito)-2,3- dihydro-1H-inden-2-ol} aminodiphenylphosphine | o-An | Ph | 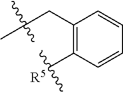 | H | 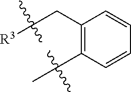 | H | H | Ph | Ph | O | L | (Rₚ) VIIIb8 |
| (Rₚ)- | N-Methyl,N-{(1S,2R)-[1-(Rₚ)- | β-Np | Ph | H | Ph | H | Me | Me | Ph | Ph | O | L | (Rₚ) |
| VIII9 | β-naphtylphenylphosphinito]- | | | | | | | | | | | | VIIIb9 |
| | 1-phenyl-prop-2-yl}amino- | | | | | | | | | | | | |
| | diphenylphosphine | | | | | | | | | | | | |
| (Rₚ)- | N-Methyl,N-{(1S,2R)-[1-(Rₚ)- | p-Tol | Ph | H | Ph | H | Me | Me | Ph | Ph | O | L | (Rₚ) |
| VIII10 | phenyl-p-tolylphosphinito]-1- | | | | | | | | | | | | VIIIb10 |
| | phenyl-prop-2-yl}amino- | | | | | | | | | | | | |
| | diphenylphosphine | | | | | | | | | | | | |
| (Rₚ,Rₚ)- | 1,1-Bis[{(R_{P})-[(1S,2R)-2-(N- | Fc | Ph | H | Ph | H | Me | Me | Ph | Ph | O | L | (Rₚ,Rₚ)- |
| VIII11 | methyl)amino-1-phenyl- | | | | | | | | | | | | VIIIb11 |
| | propyl-1-oxy]phenyl- | | | | | | | | | | | | |
| | phosphino}aminodiphenyl- | | | | | | | | | | | | |
| | phosphine]ferrocene | | | | | | | | | | | | |

^{a}L single bond

In still another aspect, the invention provides a process to manufacture a compound of formula (IX) from phosphinites of formula (I) and organolithium reagent (Scheme 8). The phosphine may be isolated as borane complexes of formula (IXb). The decomplexation of borane complexes of formula (IXb) into compounds of formula (IX) is carried out by classical methods of removal of the borane group.

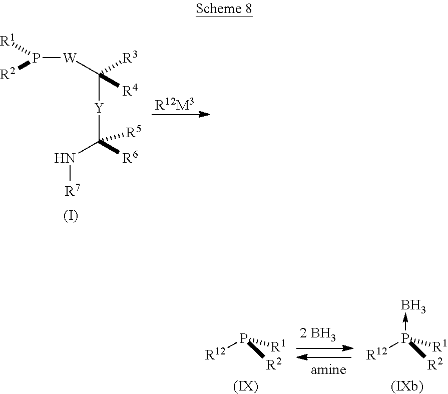

According to one embodiment, R¹ is selected from a group comprising a phenyl, a Fc, a o-Tol, a β-Np and a α-Np. According to one embodiment, R² is selected from a group comprising a t-Bu, a phenyl, an o-An and a α-Np. According to one embodiment, R¹² is selected from a group comprising a t-Bu, a methyl and a m-Xyl.

According to one embodiment, the reaction is carried in presence of 2 equivalents of R¹²M³ organometallic reagent. According to one embodiment, R¹²M³ is organolithium.

According to one embodiment, the reaction is carried under cooling/heating conditions, at temperature ranging from −90° C. to 50° C., preferably from −78° C. to 25° C.

According to one embodiment, the solvent used is selected from the group comprising tetrahydrofuran, ether, cyclohexane, dioxane, benzene, toluene, xylenes and a mixture thereof. According to a preferred embodiment, the solvent used in this step is toluene.

According to one embodiment, compound of formula (IX) is purified as borane complex (IXb) by using chromatographic techniques or by recrystallisation.

According to one embodiment, compound of formula (IX) is obtained without racemization, preferably with an enantiomeric excess of more than 85%, preferably of more than 95%

Particularly preferred compounds of formula (IX) and (IXb) of the invention are those listed in Table 9 hereafter:

TABLE 9

| Compound (IX) | | | | | Compound (IXb) |
|---|---|---|---|---|---|
| Cpd | Chemical name | R¹ | R² | R¹² | Cpd |
| (R)-IX1 | (R)-o-Anisyl-t-butylphenyl | Ph | o-An | t-Bu | (R)-IXb1 |
| | phosphine | | | | |
| (S)-IX1 | (S)-o-Anisyl-t-butylphenyl | o-An | Ph | t-Bu | (S)-IXb1 |
| | phosphine | | | | |
| (S)-IX2 | (S)-o-Anisylmethylphenyl | o-An | Ph | Me | (S)-IXb2 |
| | phosphine | | | | |
| (R)-IX3 | (R)-o-Anisylphenyl-m-xylyl | o-An | Ph | m-Xyl | (R)-IXb3 |
| | phosphine | | | | |
| (S)-IX4 | (S)-t-Butylferrocenylphenyl | Fc | Ph | t-Bu | (S)-IXb4 |
| | phosphine | | | | |
| (S)-IX5 | (S)-Ferrocenylmethylphenyl | Fc | Ph | Me | (S)-IXb5 |
| | phosphine | | | | |
| (R)-IX6 | (R)-Ferrocenylphenyl-m-xylyl | Fc | Ph | m-Xyl | (R)-IXb6 |
| | phosphine | | | | |
| (S)-IX7 | (S)-t-Butylmethylphenylphosphine | Me | Ph | t-Bu | (S)-IXb7 |
| (S)-IX8 | (S)-t-Butylphenyl-o-tolylphosphine | o-Tol | Ph | t-Bu | (S)-IXb8 |
| (S)-IX9 | (S)-Methylphenyl-o-tolylphosphine | o-Tol | Ph | Me | (S)-IXb9 |
| (R)-IX10 | (R)-Phenyl-o-tolyl-m-xylyl | o-Tol | Ph | m-Xyl | (R)-IXb10 |
| | phosphine | | | | |
| (R)-IX11 | (S)-t-Butyl-α-naphtylphenyl | Ph | α-Np | t-Bu | (R)-IXb11 |
| | phosphine | | | | |
| (S)-IX12 | (S)-Methyl-α-naphtylphenyl | α-Np | Ph | Me | (S)-IXb12 |
| | phosphine | | | | |
| (R)-IX13 | (R)-α-Naphtylphenyl-m-xylyl | α-Np | Ph | m-Xyl | (R)-IXb13 |
| | phosphine | | | | |
| (S)-IX14 | (S)-Methyl-β-naphtylphenyl | β-Np | Ph | Me | (S)-IXb14 |
| | phosphine | | | | |
| (S)-IX15 | (S)-t-Butyl-β-naphtylphenyl | β-Np | Ph | t-Bu | (S)-IXb15 |
| | phosphine | | | | |
| (R)-IX16 | (S)-β-Naphtylphenyl-m-xylyl | β-Np | Ph | m-Xyl | (S)-IXb16 |
| | phosphine | | | | |
| (S,S)-IX17 | 1,1′-bis[(S)-Methylphenyl | Fc | Ph | Me | (S,S)-IXb17 |
| | phosphino]ferrocene | | | | |
| (S,S)-IX18 | 1,1′-bis[(S)-t-Butylphenyl | Fc | Ph | t-Bu | (S,S)-IXb18 |
| | phosphino]ferrocene | | | | |
| (R,R)-IX19 | 1,1′-bis[(R)-Phenyl-m-xylyl | Fc | Ph | m-Xyl | (R,R)-IXb19 |
| | phosphino]ferrocene | | | | |

In still another aspect, the invention provides a process to manufacture a compound of formula formula (X) from phosphinites of formula (I) and alkyl halide R¹³X by Michaelis-Arbuzov like rearrangement (Scheme 9).

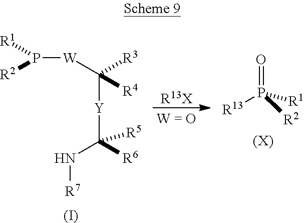

According to one embodiment, R¹ is selected from a group comprising t-Bu, o-An, Fc, o-Tol, β-Np, α-Np, and Ph.

According to one embodiment, R² is selected from a group comprising phenyl and o-An;

According to one embodiment, R¹³ is selected from a group comprising hydrogen atom and methyl.

According to one embodiment, X is a halogen. According to one embodiment, X is Br or I.

According to one embodiment, the reaction is carried in presence of 2 to 10 equivalents of R¹³X reagent. According to one embodiment, when R¹³ represents hydrogen atom, the reaction is carried in presence of 4 equivalents of R¹³X reagent.

According to one embodiment, when R¹³ represent an alkyl, the reaction is carried in presence of 2 equivalents of R¹³X reagent.

According to one embodiment, the reaction is carried out at room temperature.

According to one embodiment, the solvent used is selected from the group comprising tetrahydrofuran, ether, dioxane, benzene, toluene, xylenes, chlorobenzene and a mixture thereof. According to a preferred embodiment, the solvent used in this step is toluene.

According to one embodiment, compound of formula (X) is purified by using chromatographic techniques or by recrystallisation.

According to one embodiment, compound of formula (X) is obtained with an enantiomeric excess ranging from 0 to 100%, preferably from 85 to 100%.

Particularly preferred compounds of formula (X) of the invention are those listed in Table 10 hereafter:

TABLE 10

| Cpd no | Chemical name | R¹ | R² | R¹³ |
|---|---|---|---|---|
| (S)-X1 | (S)-t-Butylphenylphosphine-oxide | t-Bu | Ph | H |
| (R)-X2 | (R)-o-Anisylphenylphosphine-oxide | o-An | Ph | H |
| (R)-X3 | (R)-Ferrocenylphenylphosphine-oxide | Fc | Ph | H |
| (R)-X4 | (R)-Phenyl-o-tolylphosphine-oxide | o-Tol | Ph | H |
| (S)-X5 | (S)-α-Naphtylphenylphosphine-oxide | Ph | α-Np | H |
| (R)-X6 | (R)-β-Naphtylphenylphosphine-oxide | β-Np | Ph | H |
| (S)-X7 | (S)-o-Anisylmethylphenylphosphine-oxide | Ph | o-An | Me |
| (S)-X8 | (S)-t-Butylmethylphenylphosphine-oxide | t-Bu | Ph | Me |
| (R)-X9 | (R)-Ferrocenylmethylphenylphosphine-oxide | Fc | Ph | Me |
| (R)-X10 | (R)-Ferrocenylmethylphenylphosphine-oxide | Fc | Ph | Me |
| (R)-X11 | (R)-Ferrocenylmethylphenylphosphine-oxide | Fc | Ph | Me |
| (R)-X12 | (R)-Ferrocenylmethylphenylphosphine-oxide | Fc | Ph | Me |

Compounds of formula (I), (VII), (VIII), (IX), (X) of the present invention are useful in asymmetric catalysis by transition metal complexes or organocatalysis.

Especially, compounds of formula (VII) may be used to prepare new classes of chiral Brönsted acids useful in asymmetric organocatalyzed reactions.

Especially, compounds of formula (IX) may be used in catalyzed asymmetric reactions such as palladium-catalyzed allylic reactions, nickel-catalyzed reductive coupling and or alkyne-imine coupling. Compounds of formula (IX) may also be used as chiral auxiliary in catalyzed asymmetric reactions such as alkylation, silylation, CP- and CC-coupling, hydroxyalkylation, hydrophosphination, aminoalkylation, oxidation, carbonatation, formylation.

Compounds of formula (X) may also be used as chiral auxiliary in catalyzed asymmetric reactions in alkylation, PP-coupling, Michael-addition, hydroxyalkylation, aminoalkylation, hydrophosphination, sulfuration, halogenation, O-silylation, amination, aryne addition.

According to one embodiment, compound of formula (VIII) is used as ligand of a transition metal such as rhodium, palladium, ruthenium or iridium. According to a preferred embodiment, compound of formula (VIII) is used as ligand of a transition metal such as rhodium and palladium. Complexes of transition metal according to this embodiment may be suitable for asymmetric catalyzed reactions, preferably in allylation or hydrogenation reactions.

### EXAMPLES

The present invention is further illustrated by the following examples which are provided by way of illustration only and should not be considered to limit the scope of the invention.

### Abbreviations

° C.: Celsius Degree
AcOEt: ethyl acetate,
AMPP: aminophosphine-phosphinite,
BnNH₂: benzylamine,
BSA: bis(trimethylsilyl)acetamide,
BuLi: butyllithium,
Cpd: compound,
cm⁻¹: per centimeter,
DABCO: 1,4-diazabicyclo[2.2.2]octane,
DMS: dimethyl sulfide,
e.e: enantiomeric excess,
eq.: equivalent,
ESI: Electrospray Ionisation,
g: gram,
h: hour,
HPLC: high pressure liquid chromatography,
HRMS: high-resolution mass spectrometry,
K: Kelvin,
KOAc: potassium acetate,
M: mol/liter,
mg: milligram,
min: minute,
mL: milliliter,
mmol: millimole,
Mp: melting point,
n-Bu₂O: dibutyl ether,
NMR: Nuclear Magnetic Resonance,
ppm: parts-per-million,
Pt: platinum,
rt: room temperature,
t: time,
TBAF: tetra-n-butylammonium fluoride,
THF: tetrahydrofuran,
TOF: time-of-flight.

### Material and Methods

All reactions were carried out under an Ar atmosphere in dried glassware. Solvents were dried and freshly distilled under an Ar atmosphere over sodium/benzophenone for THF, diethyl ether, toluene, CaH₂ for CH₂Cl₂. Hexane and isopropanol for HPLC were of chromatographic grade and used without further purification. Reagents and starting materials were purchased and used as received from commercial vendors unless otherwise specified. Flash chromatography was performed with the indicated solvents using silica gel 60 A, (35-70 μm; Acros) or aluminium oxide 90 standardized (Merck).

Chiral HPLC analysis were performed on SHIMADZU 10-series apparatus, using chiral columns (Chiralcel OD-H, Chiralcel OJ, Chiralpak AD, Chiralpak IA, Chiralpak IB, Lux 5μm cellulose-2, Lux 5 μm cellulose-1), and with hexane/propan-2-ol mixtures as the mobile phase (Flow rate 1 mL·min⁻¹; UV detection λ=254 nm).

All NMR spectra data were recorded on BRUKER AVANCE 300, 500 and 600 spectrometers at ambient temperature. Data are reported as s=singlet, d=doublet, t=triplet, q=quartet, m=multiplet, brs=broad singlet, brd=broad doublet, dhept=doublet of heptuplet, coupling constant(s) in Hertz. Optical rotations values were recorded at 20° C. on a Perkin-Elmer 341 polarimeter, using a 10 cm quartz vessel. Infrared spectra were recorded on a Bruker Vector 22 apparatus. Mass and HRMS spectra were recorded under electrospray ionization conditions (ESI) with a Thermo LTQ orbitrap XP.

### A. SYNTHESIS OF P-CHIROGENIC PHOSPHINITES (I)

### A.1.1 Step 1: Preparation of 1,3,2-Oxazaphosphacycloalcane-Borane Complexes—Compound of Formula (IIIa)

A.1.1.1 Method A: From Bis(Dialkylamino)Phosphine R¹P(N(R⁹)₂)₂:

### General Procedure

The oxazaphosphacycloalcane borane complex (IIIa) are prepared by heating in toluene a bis(dimethylamino)phosphine R¹P(N(R⁹)₂)₂ with the corresponding α-amino alcohols (IV). In these conditions, the condensation occurs under thermodynamic control and the P(III)-oxazaphosphacycloalcane are obtained with diastereomeric ratios up to 95:5. The addition of BH₃.DMS or BH₃.THF lead to the corresponding borane complex (IIIa). The oxazaphosphacycloalcane borane complexes (IIIa) are air stable and moisture resistant compounds and can be stored without any precaution.

Method A is illustrated by the synthesis of oxazaphospholidine derivative (Sₚ)-IIIa1 wherein the amino alcohol is the (+)-ephedrine (IV2) and R⁹ is methyl.

A three-necked round-bottomed flask was equipped with a magnetic stirrer, a nitrogen inlet and a short path distillation head fitted with a dropping condenser was charged with 500 mL of toluene, (+)-ephedrine (IV2) (16.5 g, 0.1 mol) and freshly distilled bis(dimethylamino)phenylphosphine (19.6 g, 0.1 mol). The solution was stirred at 105° C. for 5 h under a gentle flow of nitrogen in order to remove the dimethylamine formed, which is collected by bubbling in water (100 mL). The formation of the oxazaphospholidine was monitored by titration of the dimethylamine solution with HCl, and/or by ³¹P NMR (δ=+142 ppm). After cooling, BH₃.DMS (or BH₃.THF) was added and the mixture was stirred overnight at room temperature. The solvent was then completely distilled off under reduced pressure, to afford a viscous colorless residue which was crystallized in isopropanol or methanol to afford the diastereomerically pure borane complexes (Sₚ)-IIIa1 in isolated yields up to 84%.

### 2-phenyl-1,3,2-oxazaphospholidine-borane (Sₚ)-IIIa1

Yield=84%. White crystals (i-PrOH). ³¹P NMR (CDCl₃, 121.5 MHz): δ=+133.5 (m).

### (Rₚ)-(1S,2R)—N-[2,3-dihydro-1H-inden-2-oxy]aminophenylphosphine-borane (Rₚ)-IIIa4

Yield=82%. Solid. ¹H NMR (CDCl₃, 300 MHz): δ=0.80 (q, J=107 Hz, 3H, BH₃), 3.27 (d, J=11.9 Hz, 1H, CHN), 3.30-3.48 (m, 2H), 4.92-5.00 (m, 1H), 5.18 (m, 1H), 7.24-7.42 (m, 4H, Hₐᵣₒₘ), 7.47-7.62 (m, 3H, Hₐᵣₒₘ), 7.79-7.89 (m, 2H, Hₐᵣₒₘ); ³¹P NMR (CDCl₃, 121.5 MHz): δ=+138.1 (q).

### 2-phenyl-1,3,2-oxazaphospha bicyclo[3.3.0]octane-borane (Rₚ)-IIIa5

Yield=62%. Uncrystallized sticky compound. ¹H NMR (CDCl₃, 500 MHz): δ=0.78 (q, J=90 Hz, 3H, BH₃), 1.70-1.78 (m, 1H), 1.89-2.02 (m, 2H), 2.06-2.14 (m, 1H), 2.67-2.77 (m, 1H), 3.76-3.86 (m, 2H), 3.87-3.94 (m, 1H), 4.22-4.29 (m, 1H), 7.43-7.54 (m, 3H, Hₐᵣₒₘ), 7.73-7.79 (m, 2H, Hₐᵣₒₘ); ³¹P NMR (CDCl₃, 202.4 MHz): δ=+141.3 (q).

A.1.1.2 Method B: Via 2-Chloro-1,3,2-Oxazaphosphacycloalcane

### General Procedure

The 2-chloro-1,3,2-oxazaphosphacycloalcane (VI) (5.9 mmol) was prepared by addition of PCl₃ (9.1 mmol) to a solution of N-methyl morpholine (18.2 mmol) in toluene (50 mL). After cooling at −78° C., a solution of amino alcohol (IV) (9.1 mmol) in 10 mL toluene was added dropwise under stirring and the reaction was allowed to reach room temperature overnight and the N-methylmorpholine hydrochloride was filtered under argon. To the resulting crude solution of 2-chloro-1,3,2-oxazaphosphacycloalcane (VI), was added at −60° C. a solution of R′MgBr Grignard or organolithium reagent in tetrahydrofuran, previously prepared by reaction from R¹Br (4.1 mmol) with Mg (10 mmol) in tetrahydrofuran (10 mL) or metal halide exchange with s-BuLi (1.3 M in cyclohexane; 3.5 mL, 4.5 mmol). After stirring overnight, BH₃.DMS (8.8 mmol) was added and the solution is stirred at room temperature during 6 hours. Water was added and after extraction with ethyl acetate (3×20 mL), the organic phases were dried over MgSO₄, filtered and evaporated to give a residue which was purified by chromatographic column on silica gel using a mixture petroleum ether/dichloromethane (1:1) as eluent to afford the compound of formula III, which was recrystallized in methanol/dichloromethane.

Method B is illustrated by the synthesis of intermediate (S)-IIIa2 wherein amino alcohol is (+)-ephedrine (IV2) and IV is o-biphenyl.

### Synthesis of (S)-2-(o-biphenyl)-1,3,2-oxazaphospholidine-borane (S)-IIIa2

To a solution of 2-chloro-1,3,2-oxazaphospholidine, prepared from (+)-ephedrine (1.48 g, 9.1 mmol) and PCl₃ (0.79 mL, 9.1 mmol) in presence of N-methylmorpholine (2 mL, 18.2 mmol) in THF (19 mL), was added at −78° C. a solution of o-biphenyl lithium in diethyl ether, previously prepared by reaction of 2-bromobiphenyl (0.96 g, 4.1 mmol) and s-BuLi (1.3 M in cyclohexane) (3.5 mL, 4.5 mmol) in diethyl ether (19 mL) at −78° C. during 30 minutes and one hour at 0° C. After stirring overnight, BH₃.DMS (0.82 mL, 8.8 mmol) was added and the solution is stirred at room temperature during 6 hours. Water was added and after extraction with ethyl acetate (3×20 mL), the organic phases were dried over MgSO₄, filtered and evaporated to give a residue which was purified by chromatographic column on silica gel using a mixture petroleum ether/dichloromethane (1:1) as eluent to afford the compound (S)-IIIa2, which was recrystallized in methanol/dichloromethane.

Yield=43% (m=1.13 g); White solid; [α]_{D}=−12.8 (c 0.3, CHCl₃); ¹H NMR (CD₂Cl₂, 300 MHz): δ=0.50 (d, J=6.5 Hz, 3H, CH₃), 2.32 (d, J=10.2 Hz, 3H, CH₃N), 3.21-3.33 (m, 1H, CHN), 4.56 (dd, J=2.3, 6.0 Hz, 1H, CHO), 7.02-7.06 (m, 2H, Hₐᵣₒₘ), 7.14-7.22 (m, 4H, Hₐᵣₒₘ), 7.26 (br.s, 5H, Hₐᵣₒₘ), 7.30-7.43 (m, 2H, Hₐᵣₒₘ), 7.77 (ddd, J=1.2, 7.4, 11.8 Hz, 1H, Hₐᵣₒₘ); ³¹P NMR (CD₂Cl₂, 121.5 MHz): δ=+132.5-132.6 (m). Anal calcd for C₂₂H₂₅BNOP (361.2): C, 73.15, H, 6.98; found C, 73.02, H, 7.03.

A.1.1.3. Method C: From Tris(Dialkylamino)Phosphine P(N(R⁹)₂)₃:

A.1.1.3.1: Synthesis of the Oxazaphospholidine (IIIb)

### General Procedure

The 2-dialkylamino-1,3,2-oxazaphosphacycloalcane (IIIb) was prepared by heating overnight P(N(R⁹)₂)₃ (1.7 mmol) and amino alcohol (IV) (1.7 mmol) in toluene (5 mL). After addition of BH₃.DMS (2.6 mmol), the reaction mixture was stirred at room temperature for 2 hours, the solvent is removed under vacuum and the residue was purified by chromatography on silica gel using a mixture petroleum ether/dichloromethane (2:1) as eluent.

The first step of method C is illustrated by the synthesis of the oxazaphospholidine (R)-IIIb1 wherein amino alcohol is (−)-ephedrine (IV1) and R⁹ is methyl.

### Synthesis of (R)-2-dimethylamino-1,3,2-oxazaphospholidine-borane (R)-IIIb1

The 2-dimethylamino-1,3,2-oxazaphospholidine (R)-IIIb1 was prepared by heating overnight P(NMe₂)₃ (0.28 g, 1.7 mmol) and (−)-ephedrine (0.28 g, 1.7 mmol) in toluene (5 mL). After addition of BH₃.DMS (0.24 mL, 2.6 mmol), the reaction mixture was stirred at room temperature for 2 hours, the solvent is removed under vacuum and the residue was purified by chromatography on silica gel using a mixture petroleum ether/dichloromethane (2:1) as eluent.

Yield=67% (m=0.29 g); Crystallized white solid; ¹H NMR (CDCl₃, 300 MHz): δ=0.76 (d, J=6.6 Hz, 3H, CH₃), 2.67 (d, J=9.5 Hz, 3H, CH₃N), 2.79 (d, J=9.9 Hz, 6H, CH₃N), 3.73-4.01 (m, 1H, CHN), 5.56 (d, J=5.7 Hz, 1H, CHO), 7.26-7.40 (m, 5H, Hₐᵣₒₘ); ¹³C NMR (CDCl₃, 75.0 MHz): δ=12.9, 28.8 (d, J=9.5 Hz, CH₃N), 36.1 (d, J=4.6 Hz, (CH₃)₂N), 60.3 (d, J=6.9 Hz, CHN), 81.9 (d, J=6.8 Hz, CHO), 125.9 (Cₐᵣₒₘ), 127.9 (Cₐᵣₒₘ), 128.3 (Cₐᵣₒₘ), 136.8 (d, J=7.2 Hz, Cₐᵣₒₘ). ³¹P NMR (CDCl₃, 121.5 MHz): δ=+114.1-116.6 (m). HRMS (ESI-Q-TOF): calcd for C₁₂H₂₂BN₂OPNa [M+Na]⁺: 275.1455; found: 275.1451.

A.1.1.3.1: Synthesis of the Oxazaphospholidine (IIIa) from Compound (IIIb) Via Compound of Formula (IIb)

### General Procedure

To a solution of oxazaphosphacycloalcane (IIIb) (1.92 mmol) in THF (4 mL) was added R′Li (3.85 mmol) at −78° C. under argon. The solution was stirred for 5 h until room temperature and was then hydrolyzed with 10 mL H₂O. After extraction with dichloromethane, the organic phases were dried over MgSO₄, filtrated and the solvent was removed under vacuum. The residue of compound (IIb) was dissolved in a mixture toluene/CH₂Cl₂ (1:1) (4 mL) and then SiO₂ (0.9 g) was added. After stirring for 24 h at room temperature, the solvent was removed under vacuum and the residue was purified by column chromatography on silica gel using a mixture petroleum ether/ethyl acetate (4:1) as eluent to afford the oxazaphosphacycloalcane (IIIa) which was recrystallized in hot hexane.

The second step of method C is illustrated by the synthesis of compound (R)-IIIa3 from compound (R)-IIIb1 via compound (R)-IIb1.

### Synthesis of 2-methyl-1,3,2-oxazaphospholidine-borane (R)-IIIa3

To a solution of (R)-IIIb1 (0.49 g, 1.92 mmol) in THF (4 mL) was added MeLi (1.6 M in Et₂O; 2.4 mL, 3.85 mmol) at −78° C. under argon. The solution was stirred for 5 h until room temperature and was then hydrolyzed with 10 mL H₂O. After extraction with dichloromethane, the organic phases were dried over MgSO₄, filtrated and the solvent was removed under vacuum. The residue ((R)-IIb1) was dissolved in a mixture toluene/CH₂Cl₂ (1:1) (4 mL) and then SiO₂ (0.9 g) was added. After stirring for 24 h at room temperature, the solvent was removed under vacuum and the residue was purified by column chromatography on silica gel using a mixture petroleum ether/ethyl acetate (4:1) as eluent to afford the compound (R)-IIIa3 which was recrystallized in hot hexane.

Yield=61%; Colorless crystals; [α]_{D}=−2.3 (c 0.7, CHCl₃). ¹H NMR (CDCl₃, 300 MHz): δ=0.78 (d, J=6.6 Hz, 3H, CH₃), 1.49 (dd, J=0.9, 7.5 Hz, 3H, CH₃), 2.68 (d, J=11.0 Hz, 3H, CH₃), 3.54-3.65 (m, 1H, CHN), 5.48 (dd, J=3.5, 6.0 Hz, 1H, CHO), 7.33-7.41 (m, 5H, Hₐᵣₒₘ); ³¹P NMR (CDCl₃, 121.5 MHz): δ=+146.5 (q, J=78.5 Hz). HRMS (ESI-Q-TOF): calcd for C₁₁H₁₉BONPNa [M+Na]⁺: 246.1192; found: 246.1185.

### Chemical Characterization

### (RP)—N,N-Dimethyl{N-methyl,N-[(1R,2S)-(1-hydroxy-1-phenyl-prop-2-yl)]amino}methylphosphine-borane IIb1

Yield=84%. Colorless oil. ³¹P NMR (CDCl₃, 121.5 MHz): δ=+91.9 (m).

### (R_{P})—N,N-Dimethyl{N-methyl,N-[(1R,2S)-(1-hydroxy-1-phenyl-prop-2-yl)]amino}phenylphosphine-borane IIb2

Yield=58%. Colorless oil. ¹H NMR (CDCl₃, 300 MHz): δ=1.05 (d, J=6.8 Hz, 3H, CH₃), 1.62 (br. s, 1H, OH), 2.23 (d, J=9.7 Hz, 6H, CH₃—N), 2.36 (d, J=7.3 Hz, 3H, CH₃—N), 3.88-4.01 (m, 1H, CH—N), 4.63 (dd, J=3.4, 6.0 Hz, 1H, CH—O), 7.05-7.35 (m, 10H, Hₐᵣₒₘ); ³¹P NMR (CDCl₃, 121.5 MHz): δ=+93.3 (m).

A.1.1 Step 2: Synthesis of the Aminophosphine-Borane Complexes IIa

The results in synthesis of the preferred ring opening compounds IIa from oxazaphosphacycloalcane Ma, are presented in the following Table 11.

TABLE 11
Preferred organic phosphorus compound of formula (IIa)

| | | | | | | | | | Aminophosphine- | | |
|---|---|---|---|---|---|---|---|---|---|---|---|
| | | | | | | | | | borane (IIa) | | |
| Oxazaphosphacycloalcane (IIIa) | | | | | | | | | | | Yield |
| Cpd | R¹ | R³ | R⁴ | R⁵ | R⁶ | R⁷ | W | Y^{a} | cpd | R² | (%) |
| (Sₚ)- | Ph | H | Ph | H | Me | Me | O | L | (Sₚ)- | t-Bu | 83 |
| IIIa1 | | | | | | | | | IIa1 | | |
| (Rₚ)- | Ph | Ph | H | Me | H | Me | O | L | (Rₚ)- | t-Bu | 93 |
| IIIa1 | | | | | | | | | IIa2 | | |
| (Sₚ)- | Ph | H | Ph | H | Me | Me | O | L | (Rₚ)- | o-An | 95 |
| IIIa1 | | | | | | | | | IIa3 | | |
| (Rₚ)- | Ph | Ph | H | Me | H | Me | O | L | (Sₚ)- | o-An | 93 |
| IIIa1 | | | | | | | | | IIa3 | | |
| (Sₚ)- | Ph | H | Ph | H | Me | Me | O | L | (Rₚ)- | Fc | 80 |
| IIIa1 | | | | | | | | | IIa4 | | |
| (Sₚ)- | Ph | H | Ph | H | Me | Me | O | L | (Sₚ)- | Me | 95 |
| IIIa1 | | | | | | | | | IIa5 | | |
| (Sₚ)- | Ph | H | Ph | H | Me | Me | O | L | (Rₚ)- | o-Tol | 92 |
| IIIa1 | | | | | | | | | IIa6 | | |
| (Rₚ)- | Ph | Ph | H | Me | H | Me | O | L | (Sₚ)- | α-Np | 87 |
| IIIa1 | | | | | | | | | IIa7 | | |
| (Sₚ)- | Ph | H | Ph | H | Me | Me | O | L | (Rₚ)- | o-biPh | 81 |
| IIIa1 | | | | | | | | | IIa8 | | |
| (Sₚ)- | Ph | H | Ph | H | Me | Me | O | L | (Rₚ,Rₚ)- | Fc | 29 |
| IIIa1 | | | | | | | | | IIa9 | | |
| (Rₚ)- | Ph | Ph | H | Me | H | Me | O | L | (Rₚ)- | Ad | — |
| IIIa1 | | | | | | | | | IIa10 | | |
| (Sₚ)- | Ph | H | Ph | H | Me | Me | O | L | (Rₚ)- | p-Tol | 87 |
| IIIa1 | | | | | | | | | IIa11 | | |
| (Sₚ)- | Ph | H | Ph | H | Me | Me | O | L | (Rₚ)- | β-Np | 61 |
| IIIa1 | | | | | | | | | IIa12 | | |
| (Sₚ)- | o-biPh | H | Ph | H | Me | Me | O | L | (Sₚ)- | Ph | 87 |
| IIIa2 | | | | | | | | | IIa8 | | |
| (Rₚ)- IIIa4 | Ph | 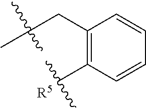 | H | 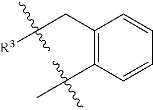 | H | H | O | L | (Rₚ)- IIa13 | o-An | 80 |
| (Rₚ)- IIIa5 | Ph | H | H | 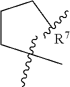 | H | 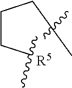 | O | L | (Sₚ)- IIa14 | o-An | 65 |
| (Sₚ)- | Ph | H | Ph | H | Me | Me | O | L | (Rₚ)- | OMe | 94 |
| IIIa1 | | | | | | | | | IIa15 | | |

^{a}L: simple bond

### General Procedure

To a solution of oxazaphosphacycloalcane Ma (1.92 mmol) in THF (5 mL) was added R²Li (3.85 mmol) at −78° C. and the mixture was then stirred at room temperature for 5 h. After addition of H₂O (10 mL) and extraction with CH₂Cl₂ (3×10 mL), the organic phases were dried over MgSO₄ and the solvent was removed after filtration. The residue was purified by chromatography on silica gel using CH₂Cl₂ as eluent.

The general procedure is illustrated by the synthesis of intermediate (Rₑ)-IIa10 wherein oxazaphospholidine is (R_{I}O-IIIa1 and R² is adamantyl.

### Synthesis of (Rₚ)-(+)-N-methyl,N-[(1R,2S)-(1-hydroxy-1-phenyl-prop-2-ylamino adamantylphenylphosphine-borane (Rₚ)-IIa10

To a solution of oxazaphospholidine (Rₚ)-IIIa1 (547 mg, 1.92 mmol) in THF (5 mL) was added AdLi (547 mg, 3.85 mmol) at −78° C. and the mixture was then stirred at room temperature for 5 h. After addition of H₂O (10 mL) and extraction with CH₂Cl₂ (3×10 mL), the organic phases were dried over MgSO₄ and the solvent was removed after filtration. The residue was purified by chromatography on silica gel using CH₂Cl₂ as eluent.

¹H NMR (CDCl₃, 300 MHz): δ=1.1 (d, J=7.0 Hz, 3H, CCH₃), 1.6 (m, 6H, PCCH₂ adamantane), 1.96 (m, 9H, adamantane), 2.87 (d, J=6.2 Hz, 3H, NCH₃), 4.04 (m, 1H, NCH), 5.11 (d, J=3.0 Hz, 1H, OCH), 7.15 (m, 1H, Hₐᵣₒₘ), 7.22 (m, 3H, Hₐᵣₒₘ), 7.36 (m, 5H, Hₐᵣₒₘ), 7.63 (m, 2H, Hₐᵣₒₘ); ³¹P NMR (CDCl₃, 121.5 MHz): δ=+83.

### Chemical Characterization

### (S_{P})—{N-methyl,N-[(1S,2R)-(1-hydroxy-1-phenyl-prop-2-yl)]amino}o-biphenylphenyl phosphine-borane IIa8

Yield=81%. White solid; [α]D=+9.9 (c 0.6, CHCl₃); ¹H NMR (CD₂Cl₂, 300 MHz): δ=0.85 (d, J=6.9 Hz, 3H, CH₃), 1.75 (d, J=4.4 Hz, 1H, OH), 2.42 (d, J=8.4 Hz, 3H, CH₃—N), 4.08-4.29 (m, 1H, CH—N), 4.51 (t, J=4.5 Hz, 1H, CH—O), 6.85-7.55 (m, 19H, Hₐᵣₒₘ); ³¹P NMR (CD₂Cl₂, 121.5 MHz): δ=+70.2-70.9 (m).

### (Rₚ)-(+)-N-methyl-N-[(1S,2R)(1-hydroxy-1-phenyl-prop-2-yl]amino-p-tolylphenyl phosphine-borane IIa11

Yield=87%. White solid; [α]_{D}=−44.3 (c 0.5, CHCl₃). ¹H NMR (CDCl₃, 300 MHz): δ=1.26 (d, J=6.7 Hz, 3H, CH₃), 1.89 (s1, 1H, OH), 2.41 (s1, 3H, PhCH₃), 2.49 (d, J=7.8 Hz, 3H, CH₃N), 4.25-4.39 (m, 1H, CHN), 4.83 (d, J=6.6 Hz, 1H, CHO), 7.14-7.20 (m, 2H, Hₐᵣₒₘ), 7.25-7.44 (m, 8H, Hₐᵣₒₘ), 7.47-7.53 (m, 4H, Hₐᵣₒₘ); ³¹P NMR (CDCl₃, 121.5 MHz): δ=+69.8-70.2 (m). HRMS calcd for C₂₃H₂₉BNOPNa [M+Na]⁺: 400.19720; found: 400.19738.

### (1S,2R)—N-[1-(R₂)-o-Anisylphenylphosphinamino-borane]-2,3-dihydro-1H-inden-2-ol IIa13

Yield=80%; Yellowish oil; ¹H NMR (CDCl₃, 300 MHz): δ=0.1-1.1 (m, 3H, BH₃), 1.67 (d, J=3.5 Hz, 1H, OH), 2.79 (d, J=16.6 Hz, 1H), 2.99 (dd, J=16.7, 4.8 Hz, 1H), 3.53 (s, 3H, CH₃O), 3.60 (dd, J=10.8, 5.3 Hz, 1H), 4.22-4.30 (m, 1H), 4.96 (td, J=10.5, 4.6 Hz, 1H), 6.85 (dd, J=8.4, 3.2 Hz, 1H), 7.03-7.10 (m, 1H), 7.14-7.25 (m, 3H), 7.30-7.51 (m, 5H), 7.57-7.66 (m, 2H), 7.95 (ddd, J=13.5, 7.5, 1.7 Hz, 1H); ³¹P NMR (CDCl₃, 121.5 MHz): δ=+54.5 (q, J=69 Hz).

### (S)—N—[(Sₚ)-o-Anisylphenylphosphino-borane]proline IIa14

Yield=65%; Colorless oil; ¹H NMR (CDCl₃, 500 MHz): δ=1.1 (m, J=125 Hz, 3H, BH₃), 1.63-1.73 (m, 1H), 1.83-2.01 (m, 5H), 2.93-3.05 (m, 1H), 3.49-3.58 (m, 2H), 3.64-3.70 (s, 3H, OCH₃), 4.06-4.17 (m, 1H), 6.95-6.99 (m, 1H), 7.05-7.12 (m, 1H), 7.37-7.59 (m, 6H), 7.70-7.77 (m, 1H); ³¹P NMR (CDCl₃, 202.4 MHz): δ=+58.2 (m, J=84 Hz).

### (R_{P})—N-methyl,N-[(1S,2R)-(1-hydroxy-1-phenylprop-2-yl)]aminomethoxyphenyl phosphine-borane IIa15

To sodium (96.9 mg, 4.2 mmol) was slowly added methanol (1.7 mL) at room temperature and the mixture was then stirred for 30 min. After cooling at −78° C., a solution of oxazaphospholidine (Sₚ)-IIIa1 (1.14 g, 4 mmol) in THF (10 mL) was slowly added. After 1 hour, the mixture was hydrolyzed at 0° C. and was then extracted with CH₂Cl₂ (3×10 mL). The organic phases were dried over MgSO₄ and the solvent was removed after filtration to afford a residue which was purified by chromatography on silica gel using toluene as eluent.

Yield=94% (1.2 g); White solid; [α]_{D}=+12.8 (c 3, CHCl₃). ¹H NMR (CDCl₃, 250 MHz): δ=0.1-1.1 (m, 3H, BH₃), 1.24 (d, J=6.8 Hz, 3H, CH₃), 1.94 (s, 1H, OH), 2.52 (d, J=8.3 Hz, 3H, NCH₃), 3.32 (d, J=11.9 Hz, 3H, OCH₃), 3.98-4.10 (m, 1H, CHN), 4.75 (d, J=5.6 Hz, OCH), 7.24-7.61 (m, 10H, Hₐᵣₒₘ); ³¹P NMR (CDCl₃, 101 MHz): δ=+115.7 (q, J=67 Hz).

### A.1.2 Step 3: Preparation of the P-Chirogenic Phosphinites I

### General Procedure

To a solution of aminophosphine borane IIb (1 mmol) in toluene (3 mL), was added DABCO (1.5 mmol). The mixture was added at 50° C. under argon for 1 night and the solvent was removed under vacuum. The residue was purified by chromatography on column of neutral alumine oxide using a mixture EtOAc/CH₂Cl₂ (9:1) as eluent.

The general procedure is illustrated by the synthesis of intermediate 13 wherein aminophosphine borane is compound IIa4.

### Synthesis of N-Methyl,N-{(1S,2R)-[1-(Rₚ)-ferrocenylphenylphosphinito]-1-phenylprop-2-yl}amine I3

To a solution of aminophosphine borane IIa4 (471.2 mg, 1 mmol) in toluene (3 mL), was added DABCO (168.2 mg, 1.5 mmol). The mixture was added at 50° C. under argon for 1 night and the solvent was removed under vacuum. The residue was purified by chromatography on column of neutral alumine oxide using a mixture EtOAc/CH₂Cl₂ (9:1) as eluent.

Yield=71%; Orange solid; [α]_{D}=+198.8 (c 0.3, CHCl₃). ¹H NMR (CDCl₃, 300 MHz): δ=0.99 (d, J=6.4 Hz, 3H, CCH₃), 1.41 (bs, 1H, NH), 2.33 (s, 3H, NCH₃), 2.75-2.88 (m, 1H, CHN), 3.76-3.83 (m, 1H, H_{Fc}), 4.06 (s, 5H, H_{Fc}), 4.27-4.32 (m, 1H, H_{Fc}), 4.36-4.43 (m, 1H, H_{Fc}), 4.46-4.51 (m, 1H, H_{Fc}, CHN), 4.83 (dd, J=10.1, 4.8 Hz, 1H, CHO), 7.15-7.23 (m, 5H, Hₐᵣₒₘ), 7.33-7.41 (m, 3H, Hₐᵣₒₘ), 7.61-7.72 (m, 2H, Hₐᵣₒₘ); ³¹P NMR (CDCl₃ 121.5 MHz): δ=+106.7 (s). HRMS (ESI-Q-TOF): calcd for C₂₆H₂₉NO₂PFe [M+H]⁺: 458.1331; found: 458.1315.

### Chemical Characterization as Free Phosphine

### N-Methyl,N-{(1S,2R)-[1-(Sₚ)-t-butylphenylphosphinito]-1-phenylprop-2-yl}amine I1

³¹P NMR (CDCl₃, 124.5 MHz): δ=+128.3 (s).

### N-Methyl,N-{(1R,2S)-[1-(Sₚ)-o-anisylphenylphosphinito]-1-phenylprop-2-yl}amine I2

Yield=59%; Colorless oil; [α]_{D}=−33.2 (c 0.4, CHCl₃). ¹H NMR (CDCl₃, 300 MHz): δ=1.01 (d, J=6.5 Hz, 3H, CCH₃), 1.21 (bs, 1H, NH), 2.29 (3H, s, NCH₃), 2.82 (qd, J=6.4, 4.8 Hz, 1H, CHN), 3.63 (s, 3H, OCH₃), 4.84 (dd, J=9.2, 4.7 Hz, 1H, CHO), 6.74 (ddd, J=8.3, 4.5, 0.7 Hz, 1H, Hₐᵣₒₘ), 6.97 (td, J=7.4, 0.7 Hz, 1H, Hₐᵣₒₘ), 7.08-7.16 (m, 8H, Hₐᵣₒₘ), 7.22-7.31 (m, 3H, Hₐᵣₒₘ), 7.56 (ddd, J=7.4, 4.4, 1.7 Hz, 1H, Hₐᵣₒₘ); ³¹P NMR (CDCl₃, 121.5 MHz): δ=+103.4 (s). HRMS (ESI-Q-TOF): calcd for C₂₃H₂₇NO₂P [M+H]⁺: 380.1774; found: 380.1764. The d.e. was checked by HPLC on chiral column: 99%, Lux 5 μm cellulose-2, 0.50 mL/min, hexane/isopropanol (95:5), t(s)=11.7 min, t_{(R)}=14.7 min.

### N-Methyl,N-{(1S,2R)-[1-(S)-methylphenylphosphinito]-1-phenylprop-2-yl}amine I4

³¹P NMR (CDCl₃, 121.5 MHz): δ=+116.3.

### N-Methyl,N-{(1S,2R)-[1-(Rₚ)-phenyl-o-tolylphosphinito]-1-phenylprop-2-yl}amine I5

Yield=54%; Colorless oil; [α]_{D}=+64.4 (c 0.3, CHCl₃). ¹H NMR (CD₂Cl₂, 300 MHz): δ=1.03 (d, J=6.0 Hz, 3H, CCH₃), 2.35-2.36 (2s, 6H, PhCH₃, NCH₃), 2.89-2.92 (m, 1H, CHN), 4.95 (dd, J=9.4, 4.1 Hz, 1H, CHO), 7.18-7.20 (m, 1H, Hₐᵣₒₘ), 7.26-7.37 (12H, m, Hₐᵣₒₘ), 7.86-7.89 (1H, m, Hₐᵣₒₘ); ³¹P NMR (CD₂Cl₂, 121.5 MHz): δ=+105.2 (s). HRMS (ESI-Q-TOF): calcd for C₂₃H₂₇NOP [M+H]⁺: 364.1825; found: 364.1813.

### N-Methyl,N-{(1R,2S)-[1-(Sₚ)-α-naphtylphenylphosphinito]-1-phenylprop-2-yl}amine I6

Yield=55%; Colorless oil; [α]_{D}=−136.7 (c 0.4, CHCl₃). ¹H NMR (CD₂Cl₂, 300 MHz): δ=1.0 (d, J=6.5 Hz, 3H, CCH₃), 2.22 (s, 3H, NCH₃), 2.87-2.92 (m, 1H, NCH), 5.02 (dd, J=9.5, 4.2 Hz, 1H, OCH), 7.25-7.27 (m, 3H, Hₐᵣₒₘ), 7.31-7.41 (m, 7H, Hₐᵣₒₘ), 7.42-7.52 (m, 2H, Hₐᵣₒₘ), 7.63 (t, J=7.9 Hz, 1H, Hₐᵣₒₘ), 7.92 (d, J=8.0 Hz, 1H, Hₐᵣₒₘ), 7.96 (d, J=8.3 Hz, 1H, Hₐᵣₒₘ), 8.13 (td, J=7.4, 0.9 Hz, 1H, Hₐᵣₒₘ), 8.37 (dd, J=8.3, 2.8 Hz, 1H, Hₐᵣₒₘ); ³¹P NMR (CD₂Cl₂, 121.5 MHz): δ=+109.0 (s). HRMS (ESI-Q-TOF): calcd for C₂₆H₂₆NOPNa [M+Na]⁺: 422.1644; found: 422.1635.

### N-Methyl,N-{(1S,2R)-[1-(Rₚ)-o-biphenylphenylphosphinito]-1-phenyl-prop-2-yl}amine (Rₚ)-I7

Yield=62%; visquous colorless oil; [α]_{D}=+134 (c 0.4, CHCl₃). ¹H NMR (CD₂Cl₂, 300 MHz): δ=1.0 (d, J=6.5 Hz, 3H, CCH₃), 2.22 (s, 3H, NCH₃), 2.84-2.88 (m, 1H, NCH), 4.84 (dd, J=9.1, 4.1 Hz, 1H, OCH), 7.20-7.35 (m, 16H, Hₐᵣₒₘ), 7.49 (td, J=7.2, 1.1 Hz, 1H, Hₐᵣₒₘ), 7.54 (td, J=7.5, 1.3 Hz, 1H, Hₐᵣₒₘ), 8.04 (ddd, J=7.6, 3.4, 1.3 Hz, 1H, Hₐᵣₒₘ); ³¹P NMR (CD₂Cl₂, 121.5 MHz): δ=+104.2 (s). HRMS (ESI-Q-TOF): calcd for C₂₈H₂₉NOP [M+H]⁺: 426.1981; found: 426.1961.

### N-Methyl,N-{(1S,2R)-[1-(Sₚ)-o-biphenylphenylphosphinito]-1-phenyl-prop-2-yl}amine (Sₚ)-I7

³¹P NMR (CDCl₃, 121.5 MHz): δ=+105.3 ppm

### 1,1′-Bis{(Rₚ)-[(1S,2R)-2-(N-methyl)amino-1-phenylpropyl-1-oxy]phenylphosphino}ferrocene I8

³¹P NMR (CDCl₃, 121.5 MHz): δ=+106 ppm

### N-Methyl,N-{(1S,2R)-[1-(Rₚ)-phenyl-p-tolylphosphinito]-1-phenylprop-2-yl}amine I10

³¹P NMR (CDCl₃, 202.4 MHz): δ=+113.6 (s).

### N-Methyl,N-{(1S,2R)-[1-(Rₚ)-β-naphtylphenylphosphinito]-1-phenyl-prop-2-yl}amine I11

³¹P NMR (CDCl₃, 121.5 MHz): δ=+112.9 (s).

### (1S,2R)—N-{(1-(Rₚ)-o-anisylphenylphosphinito)-2,3-dihydro-1H-inden-2-ol}amine I12

Yield=73%; ³¹P NMR (CDCl₃, 121.5 MHz): δ=+103.0 (s).

### (S)-2-[(Sₚ)-o-anisylphenylphosphinitomethyl]pyrrolidine I13

Yield=47%; ³¹P NMR (CDCl₃, 121.5 MHz): δ=+104.9 (s).

### Characterization as Diborane Complex

General Procedure

The phosphinite I (1 mmol) was stirred at room temperature with BH₃.DMS (8 mmol) and the mixture was stirred for a night to lead to the corresponding diborane complex derivative I.2BH₃. After hydrolysis (H₂O 10 mL), the aqueous phase was extracted with dichloromethane. The organic phase was dried and then the solvent was removed under vacuum to afford a residue which was purified by chromatography on silica gel to afford diborane complex I.2BH₃.

Chemical Characterization

### (1S,2R)—N-{(1-(Rₚ)-o-anisylphenylphosphinito)-2,3-dihydro-1H-inden-2-ol}amine diborane I11.2BH₃

Yield 71%; Colorless crystal; ¹H NMR (CDCl₃, 300 MHz): δ=2.96 (dd, J=16.4, 7.1 Hz, 1H), 3.22 (dd, J=16.4, 7.0 Hz, 2H), 3.69 (s, 3H, OCH₃), 4.10-4.20 (m, 1H), 4.72-4.90 (m, 1H), 4.96-5.08 (m, 1H), 6.86 (dd, J=8.2, 5.7 Hz, 1H), 6.99-7.10 (m, 2H), 7.13-7.26 (m, 2H), 7.36-7.52 (m, 4H), 7.57-7.63 (m, 1H), 7.69-7.87 (m, 3H); ³¹P NMR (CDCl₃, 121.5 MHz): δ=+110.5 (q, J=70 Hz).

### (S)-2-[(Sₚ)-o-anisylphenylphosphinitomethyl]pyrrolidine diborane I13.2BH₃

Yield 43%; Colorless uncrystallized compound; ¹H NMR (CDCl₃, 500 MHz): δ=1.59-1.76 (m, 3H), 1.87-1.97 (m, 1H), 1.99-2.09 (m, 1H), 2.78-2.90 (m, 1H), 3.09-3.29 (m, 1H), 3.66-3.69 (s, 3H, OCH₃), 3.85-4.03 (m, 1H), 4.10-4.21 (m, 1H), 4.29-4.49 (m, 1H), 6.83-6.88 (m, 1H, Hₐᵣₒₘ), 6.96-7.03 (m, 1H, Hₐᵣₒₘ) 7.33-7.51 (m, 4H, Hₐᵣₒₘ), 7.58-7.74) (m, 3H, Hₐᵣₒₘ); ³¹P NMR (CDCl₃, 202.4 MHz): δ=+109.2 (q, J=79 Hz).

### B. PROCESSES OF MANUFACTURING DERIVATIVES FROM COMPOUND OF FORMULA (I)

### B.1.1 Preparation of P-Chirogenic Phosphine-Oxides X

B.1.1.1 P-Chirogenic Secondary Phosphine-Oxides

### General Procedure

To a solution of phosphinite I (1 mmol) in toluene (3 mL) was added a solution of HBr in acetic acid (10 mmol). The mixture was stirred for 4 h at room temperature and then hydrolyzed with 10 mL H₂O. After extraction with dichloromethane, the organic phases were dried over MgSO₄ and the solvent was removed under vacuum to afford a residue which was purified by chromatography on silica gel.

The general procedure is illustrated by the synthesis of secondary phosphine-oxide X1 wherein phosphinite I is (S)-I1.

### Synthesis of (S)-t-Butylphenylphosphine-oxide X1

To a solution of phosphinite (S)-I1 (329.4 mg, 1 mmol) in toluene (3 mL) was added a solution of HBr in acetic acid (10 mmol). The mixture was stirred for 4 h at room temperature and then hydrolyzed with 10 mL H₂O. After extraction with dichloromethane, the organic phases were dried over MgSO₄ and the solvent was removed under vacuum to afford a residue which is purified by chromatography on silica gel.

Yield=76%; Uncrystallized compound; [α]_{D}=−26.1 (c 0.4, CHCl₃). ¹H NMR (CDCl₃, 300 MHz): δ=1.08 (9H, d, J=16.6 Hz, C(CH₃)₃), 6.97 (1H, d, J=452.9 Hz, PH), 7.39-7.46 (2H, m, 7.47-7.55 (1H, m, Hₐᵣₒₘ), 7.57-7.66 (2H, m, Hₐᵣₒₘ); ³¹P NMR (CDCl₃, 121.5 MHz): δ=+47.4 (s). HRMS (ESI-Q-TOF): calcd for C₁₀H₁₆OP [M+H]⁺: 183.09333; found: 183.09345. e.e.: 96%, determined by HPLC on Chiralpak IA, 1.0 mL/min, using a mixture hexane/isopropanol (9:1) as eluent; t(S)=13.8 min, t(R)=20.2 min.

### Chemical Characterization

### (R)-o-Anisylphenylphosphine-oxide X2 (prepared from (S)-I2)

Yield=80%; white powder; ¹H NMR (CDCl₃, 300 MHz): δ=3.71 (3H, s, OCH₃), 6.84 (1H, dd, J=8.3, 5.7 Hz, Hₐᵣₒₘ), 7.00-7.08 (1H, m, Hₐᵣₒₘ), 7.35-7.50 (4H, m, Hₐᵣₒₘ), 7.62-7.79 (3H, m, Hₐᵣₒₘ), 8.10 (1H, d, J=498.9 Hz, PH); ³¹P NMR (CDCl₃, 12.5 MHz): δ=+20.5 (s). e.e. 22% determined by HPLC on Chiralpak IB, 0.70 mL/min, using a mixture hexane/isopropanol (8:2) as eluent: t(S)=37.4 min, t(R)=45.7 min.

### (R)-Ferrocenylphenylphosphine-oxide X3 (prepared from (R)-I3)

Yield=47%; Orange solid; ¹H NMR (CDCl₃, 300 MHz): δ=4.26 (5H, s, H_{Fc}), 4.35-4.446 (4H, m, H_{Fc}), 7.35-7.53 (3H, m, Hₐᵣₒₘ), 7.60-7.73 (2H, m, Hₐᵣₒₘ), 7.98 (1H, d, J=483.0 Hz, P—H); ³¹P NMR (CDCl₃, 121.5 MHz): δ=+14.1 (s). e.e. 7% determined by HPLC on Chiralpak IB, 0.5 mL/min, using a mixture hexane/isopropanol (8:2) as eluent; t(R)=19.0 min, t(S)=20.1 min.

### (R)-Phenyl-o-tolylphosphine-oxide X4 (prepared from (R)-I5)

Yield=57%; White solid; ¹H NMR (CDCl₃, 300 MHz): δ=2.28 (3H, s, PhCH₃), 7.10-7.18 (1H, m, H arom), 7.19-7.27 (1H, m, Hₐᵣₒₘ), 7.32-7.48 (4H, m, Hₐᵣₒₘ), 7.50-7.68 (3H, m, Hₐᵣₒₘ), 8.03 (1H, d, J=480.1 Hz, P—H); ³¹P NMR (CDCl₃, 121.5 MHz): δ=+21.7 (s). e.e. 8% determined by HPLC on Chiralpak IA, 0.70 mL/min, using a mixture hexane/isopropanol (95:5) as eluent; t(R)=92.6 min, t(S)=95.9 min.

### (S)-α-Naphtylphenylphosphine-oxide X5 (prepared from (S)-I6)

Yield=63%; White solid; ¹H NMR (CDCl₃, 300 MHz): δ=7.31-7.52 (6H, m, Hₐᵣₒₘ), 7.58-7.7.70 (2H, m, Hₐᵣₒₘ), 7.78-8.02 (3H, m, Hₐᵣₒₘ), 8.16-8.24 (1H, m, Hₐᵣₒₘ), 8.34 (1H, d, J=483.4 Hz, P—H); ³¹P NMR (CDCl₃, 121.5 MHz): δ=+21.7 (s). e.e. 33% determined by HPLC on Chiralpak IB, 0.70 mL/min, using a mixture hexane/isopropanol (8:2) as eluent; t(S)=20.8 min, t(R)=24.0 min.

### (R)-β-Naphtylphenylphosphine-oxide X6 (prepared from (R)-I11)

Yield=53%; White solid; ¹H NMR (CDCl₃ 300 MHz): δ=7.33-7.55 (6H, m, Hₐᵣₒₘ), 7.58-7.69 (2H, m, Hₐᵣₒₘ), 7.73-7.86 (3H, m, Hₐᵣₒₘ), 8.25 (1H, d, J=15.7 Hz, Hₐᵣₒₘ), 8.34 (1H, d, J=480.6 Hz, P—H); ³¹P NMR (CDCl₃, 121.5 MHz): δ=+21.4 (s). e.e. 33% determined by HPLC on Chiralpak IB, 1.0 mL/min, using a mixture hexane/isopropanol (9:1) as eluent; t(S)=29.0 min, t(R)=31.4 min.

B.1.1.2 P-Chirogenic Tertiary Phosphine-Oxides

### General Procedure

To a solution of phosphinite I (1 mmol) in toluene (3 mL) was added R¹³X (3 mmol). The mixture was added for 4 h at temperature between 25° C. and reflux, then hydrolyzed by 10 mL of water. After extraction with dichloromethane the organic phases were dried over MgSO₄ and the solvent was removed under vacuum to afford a residue which was purified by chromatography on silica gel to afford the tertiary phosphine oxide X.

The general procedure is illustrated by the synthesis of phosphine oxide X7 wherein phosphinite is (S)-I2 and R¹³ is methyl.

### Synthesis of (S)-o-Anisylmethylphenylphosphine-oxide X7

To a solution of phosphinite (S)-I2 (379.4 mg, 1 mmol) in toluene (3 mL) was added MeI (0.19 mL; 3 mmol). The mixture was added for 4 h at room temperature, then hydrolyzed with 10 mL of water. After extraction with dichloromethane the organic phases were dried over MgSO₄ and the solvent was removed under vacuum to afford a residue which was purified by chromatography on silica gel to afford the phosphine oxide X7.

Yield=67%; White solid; lull)=−18.1 (c 0.5, CHCl₃). ¹H NMR (CDCl₃, 300 MHz): δ=1.99 (3H, d, J=14.1 Hz, PCH₃), 3.63 (3H, s, OCH₃), 6.80 (1H, dd, J=8.2, 5.4 Hz, Hₐᵣₒₘ), 6.97-7.05 (1H, m, Hₐᵣₒₘ), 7.27-7.46 (4H, m, Hₐᵣₒₘ), 7.60-7.71 (2H, m, Hₐᵣₒₘ), 7.88 (1H, ddd, J=13.1, 7.5, 1.7 Hz, Hₐᵣₒₘ³¹P NMR (CDCl₃, 121.5 MHz): δ=+28.4 (s1). HRMS (ESI-Q-TOF): calcd for C₁₄H₁₆O₂P [M+H]+: 247.08824; found: 247.08843; e.e. =84% determined by chromatography on Lux 5 μm cellulose-1, 1.0 mL/min, using a mixture hexane/isopropanol (9:1) as eluent; t(R)=21.8 min, t(S)=25.0 min.

### Chemical Characterization

### (S)-t-Butylmethylphenylphosphine-oxide X8 (prepared from (S)-I1)

Yield=21%; White solid; [α]_{D}=−17.3 (c 0.9, CHCl₃). ¹H NMR (CDCl₃, 300 MHz): δ=1.03 (d, J=14.8 Hz, 9H, C(CH₃)₃), 1.61 (d, J=12.1 Hz, 3H, PCH₃), 7.29-7.45 (m, 3H, Hₐᵣₒₘ), 7.55-7.69 (m, 2H, Hₐᵣₒₘ); ³¹P NMR (CDCl₃, 121.5 MHz): δ=+47.4 (bs).

### (R)-Ferrocenylmethylphenylphosphine-oxide X9 (prepared from (R)-I3)

Yield=67%; Orange solid; [α]_{D}=−88.7 (c 0.6, CHCl₃). ¹H NMR (CDCl₃, 300 MHz): δ=1.82 (d, J=13.2 Hz, 3H, PCH₃), 4.23 (s, 5H, H_{Fc}), 4.33-4.40 (m, 4H, H_{Fc}), 7.34-7.43 (m, 3H, Hₐᵣₒₘ), 7.60-7.67 (2H, m, Hₐᵣₒₘ); ³¹P NMR (CDCl₃, 121.5 MHz): δ=+30.5 (s1). HRMS (ESI-Q-TOF): calcd for C₁₇H₁₈FeOP [M+H]⁺: 325.04393; found: 325.04368; Calcd for C₁₇H₁₇FeOPNa [M+Na]⁺: 347.02588; found: 347.02389. e.e. 98% determined by HPLC on Lux 5 μm cellulose-1, 1.0 mL/min, using a mixture hexane/isopropanol (9:1) as eluent; t(S)=12.7 min, t(R)=16.3 min.

### (R)-Methyl-β-naphtylphenylphosphine-oxide X10 (prepared from (R)-I11)

Yield=59%; White solid; ¹H NMR (CDCl₃, 500 MHz): δ=2.12 (3H, d, J=13.1 Hz, PCH₃), 7.45-7.68 (6H, m, Hₐᵣₒₘ), 7.75-7.81 (2H, m, Hₐᵣₒₘ), 7.86-7.90 (1H, m, Hₐᵣₒₘ), 7.90-7.97 (2H, m, Hₐᵣₒₘ), 8.49 (1H, d, J=13.6 Hz, Hₐᵣₒₘ); ³¹P NMR (CDCl₃, 202.4 MHz): δ=+29.9 (1); HRMS (ESI-Q-TOF): calcd for C₁₇H₁₆OP [M+H]⁺: 267.09333; found: 267.09339; e.e. 87% determined by HPLC on Lux 5 μm cellulose-2, 1.0 mL/min, hexane/isopropanol (8:2), t(R)=34.3 min, t(S)=43.3 min.

### (R)-o-Anisylbenzylphenylphosphine-oxide X11 (prepared from (R)-I2)

Yield=63%; White solid; ¹H NMR (CDCl₃, 500 MHz): δ=3.69 (1H, dd, J=16.0, 14.5 Hz, PCH₂), 3.77 (3H, s, OCH₃), 3.79 (1H, dd, J=14.4, 13.3 Hz, PCH₂), 6.81-6.85 (1H, m, Hₐᵣₒₘ), 6.92-6.96 (1H, m, Hₐᵣₒₘ), 7.03-7.10 (5H, m, Hₐᵣₒₘ), 7.29-7.34 (2H, m, Hₐᵣₒₘ), 7.35-7.41 (2H, m, Hₐᵣₒₘ), 7.64-7.71 (2H, m, Hₐᵣₒₘ), 7.79 (1H, ddd, J=12.8, 7.5, 1.8 Hz, Hₐᵣₒₘ); ³¹P NMR (CDCl₃, 202.4 MHz): δ (ppm)+29.3 (s); HRMS (ESI-Q-TOF): calcd for C₂₀H₂₀O₂P [M+H]⁺: 323.11954; found: 323.11900; e.e. 98% determined by HPLC on Lux 5 μm cellulose-1, 1.0 mL/min, hexane/isopropanol (8:2), t(S)=11.5 min, t(R)=12.9 min.

### (R)-Allyl-o-Anisylphenylphosphine-oxide X12 (prepared from (R)-I2)

Yield=59%; ¹H NMR (CDCl₃, 500 MHz): δ=3.14-3.29 (2H, m, PCH₂), 3.73 (3H, s, OCH₃), 5.01-5.11 (2H, m, CH₂CH), 6.84 (1H, dd, J=8.2, 5.4 Hz, Hₐᵣₒₘ), 7.01-7.06 (1H, m, Hₐᵣₒₘ), 7.31-7.37 (2H, m, Hₐᵣₒₘ), 7.38-7.46 (2H, m, Hₐᵣₒₘ), 7.67-7.74 (2H, m, Hₐᵣₒₘ), 7.90 (1H, ddd, J=12.8, 7.5, 1.7 Hz, Hₐᵣₒₘ); ³¹P NMR (CDCl₃, 202.4 MHz): δ (ppm) 29.1 (s); e.e. 97% determined by HPLC on Lux 5 mm cellulose-2, 1.0 mL/min, hexane/isopropanol (8:2), t(R)=24.1 min, t(S)=25.8 min.

B.1.2 Preparation of P-Chirogenic Phosphines (IX) and their Borane Complexes (IXb)
B.1.2.1 Preparation of P-Chirogenic Monophosphines and their Borane Complexes

### General Procedure

To a solution of phosphinite I (1 mmol) in toluene (5 mL) was added 2 mmol of organolithium reagent at −78° C. The reaction mixture was stirred for 4 h to room temperature. The course of the reaction was checked by ³¹P NMR to follow the formation of free phosphine (IX).

Then, 2 mmol of BH₃.DMS were added at 0° C. and the solution was stirred for 4 h then hydrolyzed with 10 mL H₂O. The mixture was extracted by dichloromethane and the organic phases were dried over MgSO₄. After removing the solvent under vacuum the residue was purified by column chromatography on silica gel to afford phosphine borane (IXb).

The general procedure is illustrated by the synthesis of phosphine IX1 and borane complex IXb1 wherein phosphinite is (Sₚ)—I2 and organolithium reagent is t-butyllithium.

### Synthesis of (R)-o-Anisyl-t-butylphenylphosphine IX1 and borane complex (R)-IXb1

To a solution of phosphinite (S)-I2 (379.4 mg, 1 mmol) in toluene (5 mL) was added 2 mmol of t-butyllithium at −78° C. The reaction mixture was stirred for 4 h to room temperature. The course of the reaction was checked by ³¹P NMR to follow the formation of free phosphine IX1 (³¹P NMR (CDCl₃): δ=+5.6 (s)). Then, 2 mmol of BH₃.DMS were added at 0° C. and the solution was stirred for 4 h then hydrolyzed with 10 mL H₂O. The mixture was extracted by dichloromethane and the organic phases were dried over MgSO₄. After removing the solvent under vacuum the residue was purified by column chromatography on silica gel to afford the corresponding borane complex IXb1.

Yield=73%; White crystals (CH₂Cl₂/Hexane); Mp=82° C.; [α]_{D}=−8.5 (c 0.4, MeOH). ¹H NMR (CDCl₃, 300 MHz): δ=1.26 (9H, d, J=14.4 Hz, C(CH₃)₃), 3.49 (3H, s, OCH₃), 6.82 (1H, ddd, J=8.3, 3.4, 0.8 Hz, Hₐᵣₒₘ), 6.95-7.01 (1H, m, Hₐᵣₒₘ), 7.23-7.33 (3H, m, Hₐᵣₒₘ), 7.37-7.45 (1H, m, Hₐᵣₒₘ), 7.55-7.65 (2H, m, Hₐᵣₒₘ), 7.90 (1H, ddd, J=12.6, 7.7, 1.6 Hz, H arom); ³¹P NMR (CDCl₃, 121.5 MHz): δ=+36.2 (q, J=67.5 Hz) HRMS (ESI-Q-TOF): calcd for C₁₇H₂₃BOP [M−H]⁺: 285.15741; found: 285.15685; Calcd for C₁₇H₂₄BOPNa [M+Na]⁺: 309.15500; found: 309.15390.

### Chemical Characterization

### (S)-o-Anisyl-t-butylphenylphosphine (S)-IX1

³¹P NMR (CDCl₃, 121.5 MHz): δ=+5.6 (s).

### (S)-o-Anisyl-t-butylphenylphosphine-borane (S)-IX1

Yield=71%; White crystals (CH₂Cl₂/Hexane); Mp=82° C.; lab)=+11.9 (c 0.5, MeOH). ¹H NMR (CDCl₃, 300 MHz): δ=1.26 (9H, d, J=14.4 Hz, C(CH₃)₃), 3.49 (3H, s, OCH₃), 6.82 (1H, ddd, J=8.3, 3.4, 0.8 Hz, Hₐᵣₒₘ), 6.95-7.01 (1H, m, Hₐᵣₒₘ), 7.23-7.33 (3H, m, Hₐᵣₒₘ), 7.37-7.45 (1H, m, Hₐᵣₒₘ), 7.55-7.65 (2H, m, Hₐᵣₒₘ), 7.90 (1H, ddd, J=12.6, 7.7, 1.6 Hz, Hₐᵣₒₘ); ³¹P NMR (CDCl₃, 12.5 MHz): δ=+36.2 (q, J=67.5 Hz) HRMS (ESI-Q-TOF): calcd for C₁₇H₂₃BOP [M−H]⁺: 285.1574; found: 285.15685; calcd for C₁₇H₂₄BOPNa [M+Na]⁺: 309.15500; found: 309.15390.

### (S)-o-Anisylmethylphenylphosphine IX2

³¹P NMR (CDCl₃, 121.5 MHz): δ=−35.9 (s)

### (S)-o-Anisylmethylphenylphosphine-borane IXb2

Yield=61%; White solid; [α]_{D}=+11.8 (c 0.6, CHCl₃). ¹H NMR (CDCl₃, 300 MHz): δ=1.86 (3H, d, J=10.6 Hz, C(CH₃)₃), 3.60 (3H, s, OCH₃), 6.80 (1H, dd, J=8.3, 3.4, Hz, Hₐᵣₒₘ), 6.93-7.01 (1H, m, Hₐᵣₒₘ), 7.25-7.35 (3H, m, Hₐᵣₒₘ), 7.37-7.45 (1H, m, Hₐᵣₒₘ), 7.50-7.59 (2H, m, Hₐᵣₒₘ), 7.80 (1H, ddd, J=13.8, 7.6, 1.7 Hz, Hₐᵣₒₘ); ³¹P NMR (CDCl₃, 121.5 MHz): δ=+8.5 (q, J=55.0 Hz). HRMS (ESI-Q-TOF): calcd for C₁₄H₁₇BOP [M−H]⁺: 243.11046; found: 243.11014; calcd pour C₁₄H₁₈BOPNa [M+Na]+: 267.10805; found: 267.10738.

### (R)-o-Anisylphenyl-m-xylylphosphine IX3

³¹P NMR (CDCl₃, 121.5 MHz): δ=−15.9 (s)

### (R)-o-Anisylphenyl-m-xylylphosphine-borane IXb3

Yield=74%; White solid; [α]_{D}=−8.9 (c 0.6, CHCl₃). ¹H NMR (CDCl₃, 300 MHz): δ=2.20 (6H, s, ArCH₃), 3.45 (3H, s, O—CH₃), 6.82 (1H, ddd, J=8.3, 3.8, 0.7 Hz, Hₐᵣₒₘ), 6.93 (1H, tq, J=7.5, 1.0 Hz, Hₐᵣₒₘ), 6.98-7.01 (1H, m, Hₐᵣₒₘ), 7.09-7.13 (1H, m, Hₐᵣₒₘ), 7.14-7.17 (1H, m, Hₐᵣₒₘ), 7.25-7.57 (7H, m, Hₐᵣₒₘ); ³¹P NMR (CDCl₃, 121.5 MHz): δ=+18.1 (bs). HRMS (ESI-Q-TOF): calcd for C₂₁H₂₃BOP [M−H]⁺: 333.15741; found: 333.15744; calcd pour C₂₁H₂₄ BOPNa [M+Na]⁺: 357.15500; found: 357.15411.

### (S)-t-Butylferrocenylphenylphosphine IX4

³¹P NMR (CDCl₃, 121.5 MHz): δ=+8.0 (s).

### (S)-t-butylferrocenylphenylphosphine-borane IXb4

Yield=71%; Orange crystals (CH₂Cl₂/Hexane); [α]_{D}=−178.4 (c 0.3, MeOH). ¹H NMR (CDCl₃): δ=1.00 (9H, d, J=14.1 Hz, C(CH₃)₃), 3.87 (5H, s, H_{Fc}), 4.38-4.43 (2H, m, H_{Fc}), 4.45 (1H, m, H_{Fc}), 4.79 (1H, m, H_{Fc}), 7.40-7.50 (3H, m, Hₐᵣₒₘ), 7.96-8.03 (2H, m, Cₐᵣₒₘ); ³¹P NMR (CDCl₃, 121.5 MHz): δ=+30.4 (q, J=77.9 Hz). HRMS (ESI-Q-TOF): calcd for C₂₀H₂₆BFePNa [M+Na]⁺: 387.11068; found: 387.10976.

### (S)-Ferrocenylmethylphenylphosphine IX5

³¹P NMR (CDCl₃, 121.5 MHz): δ=−38.4 (s).

### (S)-Ferrocenylmethylphenylphosphine-borane IXb5

Yield=74%; Orange crystals (CH₂Cl₂/Hexane); [α]_{D}=−31.1 (c 0.4, CH₂Cl₂). ¹H NMR (CDCl₃, 300 MHz): δ=1.71 (3H, d, J=10.2 Hz, PCH₃), 4.19 (5H, s, H_{Fc}), 4.34-4.37 (1H, m, H_{Fc}), 4.38-4.44 (3H, m, H_{Fc}), 7.27-7.38 (3H, m, Hₐᵣₒₘ), 7.52-7.62 (2H, m, Hₐᵣₒₘ); ³¹P NMR (CDCl₃, 121.5 MHz): δ=+5.8 (q, J=55.1 Hz). HRMS (ESI-Q-TOF): calcd for C₁₇H₂₀BFePNa [M+Na]⁺: 345.06373; found: 345.06403.

### (R)-Ferrocenylphenyl-m-xylylphosphine IX6

³¹P NMR (CDCl₃, 121.5 MHz): δ=−16.8 (s).

### (R)-Ferrocenylphenyl-m-xylylphosphine-borane IXb6

Yield=78%; Orange crystals; [α]_{D}=−6.6 (c 0.5, CHCl₃). ¹H NMR (CDCl₃, 300 MHz): δ=2.22 (6H, s, ArCH₃), 4.03 (5H, s, H_{Fc}), 4.30-4.37 (2H, m, H_{Fc}), 4.40-4.54 (2H, m, H_{Fc}), 6.99-7.03 (1H, m, Hₐᵣₒₘ), 7.06-7.09 (1H, m, Hₐᵣₒₘ), 7.10-7.13 (1H, m, Hₐᵣₒₘ), 7.29-7.43 (3H, m, Hₐᵣₒₘ), 7.48-7.57 (2H, m, Hₐᵣₒₘ); ³¹P NMR (CDCl₃, 121.5 MHz): δ=+15.5 (bs).

### (S)-t-Butylmethylphenylphosphine IX7

³¹P NMR (CDCl₃, 121.5 MHz): δ=−11.2 (s).

### (S)-t-Butylmethylphenylphosphine-borane IXb7

Yield=74%; Colorless crystals; [α]_{D}=+14.9 (c 0.5, CHCl₃). ¹H NMR (CDCl₃, 300 MHz): δ=1.03 (9H, d, J=13.9 Hz, C(CH₃)₃), 1.49 (3H, d, J=9.7 Hz, PCH₃), 7.32-7.43 (3H, m, Hₐᵣₒₘ), 7.59-7.67 (2H, m, Hₐᵣₒₘ); ³¹P NMR (CDCl₃, 121.5 MHz): δ=+25.1 (q, J=59.5 Hz). HRMS (ESI-Q-TOF): calcd for C₁₁H₂₀BPNa [M+Na]⁺: 217.12879; found: 217.12811.

### (S)-t-Butylphenyl-o-tolylphosphine IX8

³¹P NMR (CDCl₃, 121.5 MHz): δ=+4.0 (s).

### (S)-t-Butylphenyl-o-tolylphosphine borane IXb8

Yield=79%; Colorless crystals; [α]_{D}=+44.1 (c 0.8, MeOH). ¹H NMR (CDCl₃, 300 MHz): δ=1.32 (9H, d, J=13.7 Hz, C(CH₃)₃), 1.97 (3H, s, PhCH₃), 7.08-7.14 (1H, m, Hₐᵣₒₘ), 7.15-7.22 (1H, m, Hₐᵣₒₘ), 7.25-7.42 (4H, m, Hₐᵣₒₘ), 7.52-7.60 (2H, m, 7.73-7.81 (1H, m, Hₐᵣₒₘ); ³¹P NMR (CDCl₃, 121.5 MHz): δ=+34.5 (q, J=62.0 Hz). HRMS (ESI-Q-TOF): calcd for C₁₇H₂₄BPNa [M+Na]⁺: 293.16009; found: 293.15969.

### (S)-Methylphenyl-o-tolylphosphine IX9

³¹P NMR (CDCl₃, 121.5 MHz): δ=−38.6 (s).

### (S)-Methylphenyl-o-tolylphosphine borane IXb9

Yield=64%; Colorless uncrystallized compound; ¹H NMR (CDCl₃, 300 MHz): δ=1.80 (3H, d, J=9.9 Hz, PCH₃), 2.12 (3H, s, PhCH₃), 7.10-7.16 (1H, m, Hₐᵣₒₘ), 7.21-7.29 (1H, m, Hₐᵣₒₘ), 7.30-7.43 (4H, m, Hₐᵣₒₘ), 7.48-7.56 (2H, m, Hₐᵣₒₘ), 7.57-7.66 (1H, m, Hₐᵣₒₘ); ³¹P NMR (CDCl₃, 121.5 MHz): δ=+10.3 (q, J=52.2 Hz).

### (R)-Phenyl-o-tolyl-m-xylylphosphine IX10

³¹P NMR (CDCl₃, 300 MHz): δ=−13.3 (s).

### (R)-Phenyl-o-tolyl-m-xylylphosphine borane IXb10

Yield=72%; Colorless uncrystallized compound; ¹H NMR (CDCl₃, 300 MHz): δ=2.20 (3H, s, PhCH₃), 2.23 (6H, s, PhCH₃), 6.87-6.97 (1H, m, Hₐᵣₒₘ), 7.02-7.20 (5H, m, Hₐᵣₒₘ), 7.26-7.46 (4H, m, Hₐᵣₒₘ), 7.50-7.60 (2H, m, Hₐᵣₒₘ); ³¹P NMR (CDCl₃, 121.5 MHz): δ=+19.8 (bs).

### (S)-t-Butyl-α-naphtylphenylphosphine IX11

³¹P NMR (CDCl₃, 121.5 MHz): δ=+0.7 (s).

### (S)-t-Butyl-α-naphtylphenylphosphine-borane IXb11

Yield=77%; Colorless crystals; [α]_{D}=+33.2 (c 0.7, CHCl₃). ¹H NMR (CDCl₃, 300 MHz): δ=1.49 (9H, d, J=14.0 Hz, C(CH₃)₃), 7.12-7.17 (1H, m, Hₐᵣₒₘ), 7.24-7.37 (4H, m, Hₐᵣₒₘ), 7.42-7.47 (1H, m, Hₐᵣₒₘ), 7.53-7.59 (2H, m, Hₐᵣₒₘ), 7.74 (1H, d, J=8.2 Hz, Hₐᵣₒₘ), 7.81 (1H, d, J=8.8 Hz, Hₐᵣₒₘ), 7.90 (1H, d, J=8.1 Hz, Hₐᵣₒₘ), 8.10 (1H, ddd, J=12.3, 7.3, 1.1 Hz, Hₐᵣₒₘ); ³¹P NMR (CDCl₃, 121.5 MHz): δ=+34.7 (m). HRMS (ESI-Q-TOF): calcd for C₂₀H₂₄BPNa [M+Na]⁺: 329.16009; found: 329.15902.

### (S)-Methyl-α-naphtylphenylphosphine IX12 ³¹P NMR (CDCl₃, 121.5 MHz): δ=−37.5 (s)

### (S)-Methyl-α-naphtylphenylphosphine-borane IXb12

Yield=67%; White solid; [α]_{D}=+34.2 (c 0.5, CHCl₃); ¹H NMR (CDCl₃, 300 MHz): δ=1.94 (3H, d, J=9.9 Hz, PCH₃), 7.25-7.43 (5H, m, Hₐᵣₒₘ), 7.64-7.57 (3H, m, Hₐᵣₒₘ), 7.79-7.91 (2H, m, Hₐᵣₒₘ), 7.92-8.02 (2H, m, Hₐᵣₒₘ); ³¹P NMR (CDCl₃, 121.5 MHz): δ=+10.0 (m). HRMS (ESI-Q-TOF): calcd for C₁₇H₁₈BPNa [M+Na]⁺: 287.11314; found: 287.11294.

### (R)-α-Naphtylphenyl-m-xylylphosphine IX13

³¹P NMR (CDCl₃, 121.5 MHz): δ=−13.9 (s)

### (R)-α-Naphtylphenyl-m-xylylphosphine-borane IXb13

Yield=76%; Sticky oil; [α]_{D}=+2.1 (c 1, CHCl₃). ¹H NMR (CDCl₃, 300 MHz): δ=2.20 (6H, s, PhCH₃), 7.02-7.08 (2H, m, Hₐᵣₒₘ), 7.12-7.45 (8H, m, Hₐᵣₒₘ), 7.50-7.63 (2H, m, Hₐᵣₒₘ), 7.76-7.82 (1H, m, Hₐᵣₒₘ), 7.87-7.93 (1H, m, Hₐᵣₒₘ), 8.03-8.11 (1H, m, Hₐᵣₒₘ); ³¹P NMR (CDCl₃, 121.5 MHz): δ=+19.9 (m). HRMS (ESI-Q-TOF): calcd for C₂₄H₂₄BPNa [M+Na]⁺: 377.16009; found: 377.15992.

### (S)-Methyl-β-naphtylphenylphosphine IX14

³¹P NMR (CDCl₃, 121.5 MHz): δ=−26.5 ppm

### (S)-Methyl-β-naphtylphenylphosphine-borane IXb14

Yield=57%; Sticky oil; [α]_{D}=−13.5 (c 0.5, CHCl₃). ¹H NMR (CDCl₃, 300 MHz): δ=1.87 (3H, d, J=10.1 Hz, PCH₃), 7.31-7.66 (8H, m, 7.74-7.85 (3H, m, Hₐᵣₒₘ), 8.19 (1H, d, J=13.1 Hz, Hₐᵣₒₘ); ³¹P NMR (CDCl₃, 121.5 MHz): δ=+10.4 (m). HRMS (ESI-Q-TOF): calcd for C₁₇H₁₈BPNa [M+Na]⁺: 287.11314; found: 287.11304.

### (S)-t-Butyl-β-naphtylphenylphosphine IX15

³¹P NMR (CDCl₃, 121.5 MHz): δ=+18.2(s).

### (S)-t-Butyl-β-naphtylphenylphosphine-borane IXb15

Yield=78%; Colorless solid; Mp=94° C.; [α]_{D}=−2.7 (c 0.7, CHCl₃). ¹H NMR (CDCl₃, 300 MHz): δ=1.26 (9H, d, J=14.1 Hz, C(CH₃)₃), 7.32-7.54 (5H, m, Hₐᵣₒₘ), 7.68-7.86 (6H, m, Hₐᵣₒₘ), 8.40 (1H, d, J=12.1 Hz, Hₐᵣₒₘ); ³¹P NMR (CDCl₃, 121.5 MHz): δ=+34.2 (m). HRMS (ESI-Q-TOF): calcd for C₂₀H₂₄BPNa [M+Na]⁺: 329.16009; found: 329.15971.

### (S)-β-Naphtylphenyl-m-xylylphosphine IX16

³¹P NMR (CDCl₃, 121.5 MHz): δ=−4.7 ppm

### (S)-β-Naphtylphenyl-m-xylylphosphine-borane IXb16

Yield=71%; Sticky oil; [α]_{D}=−7.7 (c 0.5, CHCl₃). ¹H NMR (CDCl₃, 300 MHz): δ=2.22 (6H, s, ArCH₃), 7.05-7.08 (1H, m, Hₐᵣₒₘ), 7.11-7.13 (1H, m, Hₐᵣₒₘ), 7.15-7.17 (1H, m, Hₐᵣₒₘ), 7.32-7.59 (8H, m, Hₐᵣₒₘ), 7.73-7.83 (3H, m, Hₐᵣₒₘ), 8.06 (1H, d, J=12.7 Hz, Hₐᵣₒₘ); ³¹P NMR (CDCl₃, 121.5 MHz): δ=+20.5 (m). HRMS (ESI-Q-TOF): calcd for C₂₄H₂₄BPNa [M+Na]⁺: 377.16009; found: 377.16004.

B.1.2.2 Preparation of P-Chirogenic Ferrocenyldiphosphines and their Borane Complexes

### General Procedure

To a solution of phosphinite (Rₚ,Rₚ)-I8 (1 mmol) in toluene (5 mL) was added 4 mmol of organolithium reagent at −78° C. The reaction mixture was stirred for 4 h to room temperature. The course of the reaction was checked by ³¹P NMR to follow the formation of free ferrocenyl bridged diphosphine (IX).

Then, 4 mmol of BH₃.DMS were added at 0° C. and the solution was added for 4 h then hydrolyzed with 10 mL H₂O. The mixture was extracted by dichloromethane and the organic phases were dried over MgSO₄. After removing the solvent under vacuum the residue was purified by column chromatography on silica gel to afford the corresponding diphosphine diborane complex (IXb).

### Chemical Characterization

### 1,1′-bis[(S)-Methylphenylphosphino]ferrocene (S,S)-IX17

³¹P NMR (CDCl₃): δ=−38.9 (s)

### 1,1′-bis[(S)-Methylphenylphosphino-borane]ferrocene (S,S)-IXb17

Yield=28%; Orange crystals; [α]_{D}=−196.9 (c 0.5, CHCl₃). ¹H NMR (CDCl₃, 300 MHz): δ=1.70 (d, J=10.2 Hz, 6H, PCH₃), 4.23 (m, 2H, C—H_{Fc}), 4.37 (m, 2H, H_{Fc}), 4.51 (m, 4H, H_{Fc}), 7.27-7.46 (m, 6H, Hₐᵣₒₘ), 7.54-7.69 (m, 4H, Hₐᵣₒₘ); ³¹P NMR (CDCl₃, 121.5 MHz): δ=+5.4 (m). HRMS (ESI-Q-TOF): calcd for C₂₄H₃₀B₂FeP₂Na [M+Na]⁺: 481.12505; found: 481.12420.

### 1,1′-bis[(S)-t-Butylphenylphosphino]ferrocene (S,S)-IX18

³¹P NMR (CDCl₃, 121.5 MHz): δ=+8.3 (s).

### (1,1′)-bis[(S)-t-Butylphenylphosphino-borane)ferrocene (S,S)-IXb18

Yield=38%; Orange crystals; [α]_{D}=−25.5 (c 0.5, CHCl₃). ¹H NMR (CDCl₃, 300 MHz): δ=0.95 (d, J=14.3 Hz, 18H, C(CH₃)₃), 3.95 (m, 2H, H_{Fc}), 3.98 m, (2H, H_{Fc}), 4.39 (m, 2H, H_{Fc}), 4.76 (m, 2H, H_{Fc}), 7.39-7.53 (m, 6H, Hₐᵣₒₘ), 7.82-7.91 (m, 4H, Hₐᵣₒₘ); ³¹P NMR (CDCl₃, 121.5 MHz): δ=+30.1 (m). HRMS (ESI-Q-TOF: calcd for C₃₀H₄₂B₂FeP₂Na [M+Na]⁺: 565.21895; found: 565.21829. e.e. =99% determined by HPLC on Lux 5 μm cellulose-2, 1.0 mL/min, using a mixture hexane/isopropanol (98:2) as eluent; t(S)=13.0 min, t(R)=16.1 min.

### 1,1′-bis[(R)-Phenyl-m-xylylphosphino]ferrocene (R,R)-IX19

³¹P NMR (CDCl₃): δ=−17.4 (s)

### 1,1′-bis[(R)-(Phenyl-m-xylylphosphino-borane]ferrocene (R,R)-IXb19

Yield=47%; Orange crystals; [α]_{D}=−18.4 (c 0.5, CHCl₃). ¹H NMR (CDCl₃, 300 MHz): δ=2.20 (s, 6H, ArCH₃), 4.12 (m, 2H, H_{Fc}), 4.25 (m, 2H, H_{Fc}), 4.41 (m, 4H, H_{Fc}), 6.96-7.04 (m, 6H, Hₐᵣₒₘ), 7.26-7.49 (m, 10H, Hₐᵣₒₘ); ³¹P NMR (CDCl₃, 121.5 MHz): δ=+14.8 (m). HRMS (ESI-Q-TOF): calcd for C₃₈H₄₂B₂FeP₂Na [M+Na]⁺: 661.21895; found: 661.21923.

### B.1.3 Preparation of P-Chirogenic Thiophosphinite (VII)

### General Procedure

To a solution of phosphinite I (1 mmol) in toluene (3 mL), 2 mmol of sulfur were added. The mixture was stirred at room temperature for 2 hours. After filtration, the reaction mixture was successively hydrolyzed with 10 mL H₂O, then extracted with 3×10 mL dichloromethane. The organic phase was dried on MgSO₄, and the solvent removed under vacuum, to give a residue which was purified by chromatography on silica to afford the thiophosphinite VII.

The general procedure is illustrated by the synthesis of compound of formula VIII wherein phosphinite I is compound 12.

### Synthesis of N-Methyl,N-{(1S,2R)-[1-(Rₚ)-o-anisylphenylthiophosphinito]-1-phenyl prop-2-yl}amine VII1

To a solution of phosphinite 12 (1 mmol) in toluene (3 mL), 2 mmol of sulfur were added. The mixture was stirred at room temperature for 2 hours. After filtration, the reaction mixture was successively hydrolyzed with 10 mL H₂O, then extracted with 3×10 mL dichloromethane. The organic phase was dried on MgSO₄, and the solvent removed under vacuum, to give a residue which was purified by chromatography on silica to afford the thophosphinite VII1.

Yield=67%; Yellowish uncrystallized product; R_{f}=0.40 (AcOEt/MeOH 10:1); [α]_{D}=+14.5 (c=0.7, CHCl₃); ¹H NMR (CDCl₃, 300 MHz): δ=0.96 (3H, d, J=6.6 Hz, CCH₃), 1.60 (1H, brs, NH), 2.18 (3H, s, NCH₃), 2.79 (1H, qd, J=6.4, 4.0 Hz, CHN), 3.50 (3H, s, OCH₃), 5.61 (1H, dd, J=13.6, 3.8 Hz, CHO), 6.78 (1H, dd, J=7.9, 6.2 Hz, Hₐᵣₒₘ), 6.96-7.04 (1H, m, Hₐᵣₒₘ), 7.05-7.27 (8H, m, Hₐᵣₒₘ), 7.35-7.44 (1H, m, Hₐᵣₒₘ), 7.52-7.64 (2H, m, Hₐᵣₒₘ), 8.12 (1H, ddd, J=15.7, 7.7 Hz, 1.71, Hₐᵣₒₘ); ³¹P NMR (CDCl₃, 121.5 MHz): δ=+80.9 (s). HRMS (ESI-Q-TOF): calcd for C₂₃H₂₇NO₂PS [M+H]⁺: 412.14946; found: 412.14860.

### Chemical Characterization

### N-Methyl, N-{(1S,2R)-[1-(Rₚ)-t-butylphenylthiophosphinito]-1-phenyl-prop-2-yl}amine VII2

Yield=79%; Yellowish uncrystallized product; ¹H NMR (CDCl₃, 300 MHz): δ=1.04 (3H, d, J=6.5 Hz, CH₃), 1.14 (9H, d, J=17.4 Hz, C(CH₃)₃), 1.66 (1H, brs, NH), 2.37 (3H, s, NCH₃), 3.02 (1H, qd, J=6.5, 4.4 Hz, CHN), 5.28 (1H, dd, J=13.1, 4.3 Hz, CHO), 7.01-7.10 (2H, m, Hₐᵣₒₘ), 7.13-7.28 (6H, m, 7.38-7.50 (2H, m, Hₐᵣₒₘ); ³¹P NMR (CDCl₃, 121.5 MHz): δ=+108.3 (s).

### N-Methyl,N-{(1S,2R)-[1-(Sₚ)-ferrocenylphenylthiophosphinito]-1-phenylprop-2-yl}amine VII3

Yield=57%; Orange uncrystallized compound; ¹H NMR (CDCl₃, 300 MHz): δ=1.13 (3H, d, J=6.5 Hz, CCH₃), 1.62 (1H, brs, NH), 2.44 (3H, s, NCH₃), 2.96 (1H, qd, J=6.5, 4.3 Hz, CHN), 4.27 (5H, s, H_{Fc}), 4.40 (1H, m, H_{Fc}), 4.48 (1H, m, H_{Fc}), 4.50 (1H, m, H_{Fc}), 4.85 (1H, m, H_{Fc}, CHN), 5.41 (1H, dd, J=13.8, 4.3 Hz, CHO), 7.10-7.27 (7H, m, 7.29-7.39 (1H, m, Hₐᵣₒₘ), 7.71-7.82 (2H, m, Hₐᵣₒₘ); ³¹P NMR (CDCl₃, 121.5 MHz): δ=+86.8 (s).

### B.1.4 Preparation P-Chirogenic Aminophosphine-Phosphinite (AMPP*) Ligands VIII via the P*N,P*O-rearrangement

### General Procedure

To a solution of phosphinite I (1 mmol) in toluene (3 mL) were added chlorophosphine R¹⁰R¹¹PCl (2 mmol) and triethylamine (5 mmol) to afford the free aminophosphine-phosphinite (AMPP*) VIII. The mixture was stirred at room temperature for 5 h. Then BH₃.DMS (8 mmol) was added to the P-chirogenic aminophosphine-phosphinite VIII and the mixture was stirred for a night to lead to the corresponding diborane complex VIIIb. After hydrolysis with H₂O (10 mL), the aqueous phase was extracted with dichloromethane. The organic phase was dried and the solvent was removed under vacuum to afford a residue which was purified by chromatography on silica gel to afford diborane complex VIIIb. A solution of AMPP diborane VIIIb (0.2 mmol) and DABCO (1.2 mmol) in toluene (3 mL) was stirred under argon at 50° C. for a night. After removing the solvent under vacuum, the residue was purified by chromatography on neutral alumine oxide using a mixture petroleum ether/AcOEt (4:1) as eluent to afford the free AMPP* VIII.

The general procedure is illustrated by the synthesis of AMPP* VIII1 and its diborane complex VIIIb1 wherein phosphinite I is (S)-I1 and chlorophosphine is chlorodiphenylphosphine.

### Synthesis of N-Methyl,N-{(1S,2R)-[1-(Sₚ)-t-butylphenylphosphinito]-1-phenyl-prop-2-yl}aminodiphenylphosphine-diborane VIIIb1

To a solution of phosphinite (S)-I1 (329.4 mg, 1 mmol) in toluene (3 mL) were added chlorodiphenylphosphine Ph₂PCl (441.3 mg or 0.36 mL, 2 mmol) and triethylamine (5 mmol). The mixture was stirred at room temperature for 5 h. Then BH₃.DMS (8 mmol) was added to the P-chirogenic aminophosphine-phosphinite VIII1 and the mixture was stirred for a night. After hydrolysis with H₂O (10 mL), the aqueous phase was extracted with dichloromethane. The organic phase was dried and the solvent was removed under vacuum to afford a residue which was purified by chromatography on silica gel to afford diborane complexes VIIIb1. A solution of AMPP diborane VIIIb1 (108.2 mg, 0.2 mmol) and DABCO (135 mg, 1.2 mmol) in toluene (3 mL) was stirred under argon at 50° C. for a night. After removing the solvent under vacuum, the residue was purified by chromatography on neutral alumine oxide using a mixture petroleum ether/AcOEt (4:1) as eluent to afford the free AMPP* VIII1.

### N-Methyl,N-{(1S,2R)-[1-(Sₚ)-t-butylphenylphosphinito]-1-phenylprop-2-yl}amino diphenylphosphine VIII1

³¹P NMR (CDCl₃, 121.5 MHz): δ=+66.4 (s, P—N), +129.4 (s, P—O).

### N-Methyl,N-{(1S,2R)-[1-(Sₚ)-t-butylphenylphosphinito]-1-phenyl-prop-2-yl}aminodiphenylphosphine-diborane VIIIb1

Yield=59%; Colorless crystals; [α]_{D}=−93.6 (c 1, CHCl₃). ¹H NMR (CDCl₃, 300 MHz): δ=1.13 (9H, d, J=14.6 Hz, C(CH₃)₃), 1.51 (3H, d, J=6.5 Hz, CH₃), 2.23 (3H, d, J=7.5 Hz, NCH₃), 4.63-4.76 (1H, m, CHN), 5.26 (1H, t, J=9.5 Hz, CHO), 6.53-6.63 (2H, m, Hₐᵣₒₘ), 6.96-7.62 (18H, m, Hₐᵣₒₘ); ³¹P NMR (CDCl₃, 121.5 MHz): δ=+71.1 (m, P—N), +125.4 (m, P—O). HRMS (ESI-Q-TOF): calcd for C₃₂H₄₃B₂NOP₂Na [M+Na]⁺: 564.28944; found: 584.28944. Anal. calcd for C₃₂H₄₃B₂NOP₂ (541.27): C, 71.01, H, 8.01, N 2.59; found C, 70.92, H, 8.39, N 2.65.

### Chemical Characterization

### N-Methyl,N-{(1R,2S)-[1-(S)-o-anisylphenylphosphinito]-1-phenyl-prop-2-yl}amino diphenylphosphine VIII2

³¹P NMR (CDCl₃, 121.5 MHz): δ=+66.1 (s, P—N), +104.3 (s, P—O).

### N-Methyl,N-{(1R,2S)-[1-(Sₚ)-o-anisylphenylphosphinito]-1-phenyl-prop-2-yl}amino diphenylphosphine-diborane VIIIb2

Yield=65%; White needle crystals (CH₂Cl₂/Hexane); Mp=155° C.; [α]_{D}=+68.8 (c 0.6, CHCl₃). ¹H NMR (CDCl₃, 300 MHz): δ=1.26 (3H, d, J=6.6 Hz, CH₃), 2.21 (3H, d, J=7.6 Hz, NCH₃), 3.47 (3H, s, OCH₃), 4.47-4.57 (1H, m, CHN), 5.33 (1H, t, J=9.4 Hz, CHO), 6.51-6.58 (2H, m, Hₐᵣₒₘ), 6.77 (1H, dd, J=8.2, 4.6 Hz, Hₐᵣₒₘ), 6.95-7.09 (8H, m, Hₐᵣₒₘ), 7.10-7.15 (1H, m, Hₐᵣₒₘ), 7.16-7.34 (7H, m, Hₐᵣₒₘ), 7.35-7.50 (4H, m, Hₐᵣₒₘ), 7.80 (1H, ddd, J=11.9, 7.0, 1.7 Hz, Hₐᵣₒₘ); ³¹P NMR (CDCl₃, 121.5 MHz): δ=+71.1 (m, P—N), +105.3 (m, P—O). HRMS (ESI-Q-TOF): calcd for C₃₅H₄₁B₂NO₂P₂Na [M+Na]⁺: 614.27026; found: 614.26804.

### N-Methyl,N-{(1S,2R)-[1-(Rₚ)-ferrocenylphenylphosphinito]-1-phenylprop-2-yl}amino diphenylphosphine VIII3

³¹P NMR (CDCl₃, 121.5 MHz): δ=+65.0 (s, P—N), +107.0 (s, P—O).

### N-Methyl,N-{(1S,2R)-[1-(Rₚ)-ferrocenylphenylphosphinito]-1-phenylprop-2-yl}amino diphenylphosphine-diborane VIIIb3

Yield=68%; Orange crystals; [α]_{D}=+9.8 (c 0.5, CHCl₃). ¹H NMR (CDCl₃, 300 MHz): δ=1.28 (3H, d, J=6.6 Hz, CH₃), 2.19 (3H, d, J=7.6 Hz, NCH₃), 4.02 (5H, s, H_{Fc}), 4.09 (1H, m, H_{Fc}), 4.33 (1H, m, H_{Fc}), 4.40 (2H, m, H_{Fc}, CHN), 4.58 (1H, m, H_{Fc}), 5.14 (1H, t, J=9.4 Hz, CHO), 6.52-6.58 (2H, m, Hₐᵣₒₘ), 6.95-7.05 (5H, m, Hₐᵣₒₘ), 7.07-7.18 (3H, m, Hₐᵣₒₘ), 7.15-7.17 (1H, m, Hₐᵣₒₘ), 7.19-7.24 (2H, m, Hₐᵣₒₘ), 7.29-7.33 (2H, m, Hₐᵣₒₘ), 7.36-7.40 (1H, m, Hₐᵣₒₘ), 7.42-7.49 (4H, m, Hₐᵣₒₘ); ³¹P NMR (CDCl₃, 121.5 MHz): δ=+71.7 (m, P—N), +106.9 (m, P—O). HRMS (ESI-Q-TOF): calcd for C₃₈H₄₃B₂FeNOP₂ [M]⁺: 669.23633; found: 669.23672; calcd for C₃₈H₄₃B₂FeNOP₂Na [M+Na]⁺: 692.22610; found: 692.22470.

### N-Methyl,N-{(1S,2R)-[1-(Rₚ)-phenyl-o-tolylphosphinito]-1-phenylprop-2-yl}amino diphenylphosphine VIII4

³¹P NMR (CDCl₃, 121.5 MHz): δ=+65.8 (s, P—N), +107.1 (s, P—O).

### N-Methyl,N-{(1S,2R)-[1-(Rₚ)-phenyl-o-tolylphosphinito]-1-phenylprop-2-yl}amino diphenylphosphine-diborane VIIIb4

Yield=64%; Colorless crystals; [α]_{D}=−59.3 (c 0.5, CHCl₃). ¹H NMR (CDCl₃, 300 MHz): δ=1.17 (3H, d, J=6.5 Hz, CH₃), 2.07 (3H, s, PhCH₃), 2.23 (3H, d, J=7.6 Hz, NCH₃), 4.42-4.62 (1H, m, CHN), 5.43 (1H, t, J=9.6 Hz, CHO), 6.50-6.60 (2H, m, Hₐᵣₒₘ), 6.95-7.24 (12H, m, Hₐᵣₒₘ), 7.27-7.51 (9H, m, Hₐᵣₒₘ), 8.04 (1H, ddd, J=12.5, 7.4, 1.4 Hz, Hₐᵣₒₘ); ³¹P NMR (CDCl₃, 121.5 MHz): δ=+70.9 (m, P—N), +109.3 (m, P—O). HRMS (ESI-Q-TOF): calcd for C₃₅H₄₁B₂NOP₂Na [M+Na]⁺[: 598.27417; found: 598.27261.

### N-Methyl,N-{(1R,2S)-[1-(Sₚ)-α-naphtylphenylphosphinito]-1-phenylprop-2-yl}amino diphenylphosphine VIII5

³¹P NMR (CDCl₃, 121.5 MHz): δ=+64.4 (s, P—N), +108.4 (s, P—O).

### N-Methyl,N-{(1R,2S)-[1-(V-α-naphtylphenylphosphinito]-1-phenylprop-2-yl}amino diphenylphosphine-diborane VIIIb5

Yield=61%; Colorless crystals; [α]_{D}=+48.9 (c 0.5, CHCl₃). ¹H NMR (CDCl₃, 300 MHz): δ=1.02 (3H, d, J=6.6 Hz, CH₃), 2.19 (3H, d, J=7.6 Hz, NCH₃), 4.42-4.54 (1H, m, NCH), 5.51 (t, J=9.7 Hz, OCH), 6.56 (2H, dd, J=11.3, 7.8 Hz, Hₐᵣₒₘ), 6.93-7.02 (4H, m, Hₐᵣₒₘ), 7.03-7.21 (8H, m, Hₐᵣₒₘ), 7.22-7.45 (8H, m, Hₐᵣₒₘ), 7.49-7.54 (1H, Hₐᵣₒₘ)₉7.77 (1H, d, J=8.2 Hz, Hₐᵣₒₘ), 7.94 (2H, d, J=8.5 Hz, Hₐᵣₒₘ), 8.31 (1H, ddd, J=14.8, 7.1, 0.7 Hz, Hₐᵣₒₘ); ³¹P NMR (CDCl₃, 121.5 MHz): δ=+71.3 (m, P—N), +110.0 (m, P—O); HRMS (ESI-Q-TOF): calcd for C₃₈H₄₂ B₂NOP₂ [M+H]⁺: 612.29348; found: 612.29213; calcd for C₃₈H₄,B₂NOP₂Na [M+Na]⁺: 634.27543; found: 634.27398.

### N-Methyl,N-{(1S,2R)-[1-(Rₚ)-(o-biphenyl)phenylphosphinito]-1-phenylprop-2-yl}aminodiphenylphosphine VIII6

Yield=94%; Colorless amorphous solid; ¹H NMR (CD₂Cl₂, 300 MHz): δ=1.35 (3H, d, J=6.3 Hz, CH₃), 2.19 (3H, d, J=3.2 Hz, CH₃), 3.90-4.00 (1H, m, CH), 4.68 (1H, t, J=8.7 Hz, CH), 6.65-6.71 (2H, m, Hₐᵣₒₘ), 6.98-7.34 (24H, m, Hₐᵣₒₘ), 7.42-7.52 (2H, m, Hₐᵣₒₘ), 7.93-7.97 (1H, m, Hₐᵣₒₘ), 7.11-7.17 (5H, m, Hₐᵣₒₘ), 7.22-7.35 (8H, m, Hₐᵣₒₘ), 7.44-7.63 (7H, m, Hₐᵣₒₘ), 8.33 (1H, dd, J=13.1, 7.2 Hz, Hₐᵣₒₘ); ³¹P NMR (CDCl₃, 121.5 MHz): δ=+64.9 (s, P—N), +101.9 (s, P—O).

### N-Methyl,N-{(1S,2R)-[1-(Rₚ)-(o-biphenyl)phenylphosphinito]-1-phenylprop-2-yl}aminodiphenylphosphine-diborane VIIIb6

Yield=67%; White solid; Mp=216-218° C.; [α]_{D}=−5.9 (c 0.4, CHCl₃). ¹H NMR (CD₂Cl₂, 300 MHz): δ=1.29 (3H, d, J=5.7 Hz, CH₃), 2.29 (3H, d, J=7.6 Hz, NCH₃), 4.51-4.54 (1H, m, NCH), 5.54 (1H, t, J=9.9 Hz, OCH), 6.60-6.64 (2H, m, Hₐᵣₒₘ), 6.69-7.73 (2H, m, Hₐᵣₒₘ), 6.84-6.86 (2H, m, Hₐᵣₒₘ), 6.90-6.94 (2H, m, Hₐᵣₒₘ), 7.11-7.17 (5H, m, Hₐᵣₒₘ), 7.22-7.35 (8H, m, Hₐᵣₒₘ), 7.44-7.63 (7H, Hₐᵣₒₘ), 8.33 (1H, dd, J=13.1, 7.2 Hz, Hₐᵣₒₘ); ³¹P NMR (CDCl₃, 121.5 MHz): δ=+71.1 (m, P—N), +110.6 (m, P—O). HRMS (ESI-Q-TOF): calcd for C₄₀H₄₃B₂NOP₂Na [M+Na]⁺: 660.2898; found: 660.2884.

### N-Methyl,N-{(1S,2R)-[1-(Sₚ)-(o-biphenyl)phenylphosphinito]-1-phenylprop-2-yl}aminodiphenylphosphine VIII7

Yield=88%; colorless amorphous solid; ¹H NMR (CD₂Cl₂, 300 MHz): δ=1.15 (3H, d, J=6.8 Hz, CH₃), 2.05 (3H, d, J=4.0 Hz, CH₃), 3.81-3.90 (1H, m, CH), 4.63 (1H, t, J=8.1 Hz, CH), 6.52-6.57 (2H, m, Hₐᵣₒₘ), 6.81-6.85 (2H, m, Hₐᵣₒₘ), 6.96-7.21 (24H, m, Hₐᵣₒₘ), 7.58-7.62 (1H, m, Hₐᵣₒₘ); ³¹P NMR (CDCl₃, 121.5 MHz): δ=+65.1 (s, P—N), +104.8 (s, P—O).

### N-Methyl,N-{(1S,2R)-[1-(Sₚ)-(o-biphenyl)phenylphosphinito]-1-phenylprop-2-yl}aminodiphenylphosphine-diborane VIIIb7

Yield=58%; White solid; [α]_{D}=−67.7 (c 0.4, CHCl₃). ¹H NMR (CD₂Cl₂, 300 MHz): δ=1.25 (3H, d, J=6.6 Hz, CH₃), 2.32 (3H, d, J=7.7 Hz, NCH₃), 4.57-4.65 (1H, m, NCH), 5.52 (1H, t, J=8.9 Hz, OCH), 6.69-6.73 (2H, m, Hₐᵣₒₘ), 6.77-6.79 (2H, m, Hₐᵣₒₘ), 7.05-7.08 (3H, m, Hₐᵣₒₘ), 7.15-7.38 (21H, m, Hₐᵣₒₘ), 7.84 (1H, ddd, J=13.5, 7.8, 1.0 Hz, Hₐᵣₒₘ); ³¹P NMR (CDCl₃, 121.5 MHz): δ=+71.1-71.4 (m, P—N), +107.5-107.9 (m, P—O). HRMS (ESI-Q-TOF): calcd for C₄₀H₄₄B₂NOP₂Na [M+H]⁺: 638.3092; found: 638.3091.

### (1S,2R)—N-{(1-(Rₚ)-o-Anisylphenylphosphinito)-2,3-dihydro-1H-inden-2-ol}amino diphenylphosphine VIII8

³¹P NMR (CDCl₃, 121.5 MHz): δ=+42.3 (s, P—N), +101.2 (s, P—O).

### (1S,2R)—N-{(1-(Rₚ)-o-Anisylphenylphosphinito)-2,3-dihydro-1H-inden-2-ol}amine diphenylphosphine-diborane VIIIb8

Yield=57%; Colorless uncrystallized compound; [α]_{D}=+3.5 (c 0.3, CHCl₃). ¹H NMR (CDCl₃, 300 MHz): δ=2.80-2.94 (2H, m, CH₂), 3.03 (1H, d, J=17.2 Hz, NH), 3.26 (3H, s, OCH₃), 4.70 (1H, dd, J=10.8, 2.8 Hz, CH), 5.03 (1H, m, CH), 6.67 (1H, dd, J=8.0, 4.3 Hz, Hₐᵣₒₘ), 6.82-6.95 (2H, m, Hₐᵣₒₘ), 7.05-7.14 (3H, m, Hₐᵣₒₘ), 7.22-7.65 (17H, m, Hₐᵣₒₘ); ³¹P NMR (CDCl₃, 121.5 MHz): δ=+56.1 (m, P—N), +103.8 (m, P—O). HRMS (ESI-Q-TOF): calcd for C₃₄H₃₇B₂NO₂P₂Na [M+Na]⁺: 598.23778; found: 598.23635.

### N-Methyl,N-{(1S,2R)-[1-(Rₚ)-β-naphtylphenylphosphinito]-1-phenyl-prop-2-yl}amino diphenylphosphine VIII9

Yield=89%; Colorless amorphous solid; ¹H NMR (CD₂Cl₂, 300 MHz): δ=1.28 (3H, d, J=6.6 Hz, CH₃), 2.12 (3H, d, J=3.1 Hz, CH₃), 3.85-4.05 (1H, m, CH), 4.76 (1H, t, J=8.9 Hz, CH), 6.54-6.64 (2H, m, Hₐᵣₒₘ), 6.94-7.01 (2H, m, Hₐᵣₒₘ), 7.03-7.23 (17H, m, Hₐᵣₒₘ), 7.27-7.35 (2H, m, Hₐᵣₒₘ), 7.39-7.48 (3H, m, Hₐᵣₒₘ), 7.68-7.87 (3H, m, Hₐᵣₒₘ), 8.02-8.11 (1H, m, Hₐᵣₒₘ); ³¹P NMR (CDCl₃, 121.5 MHz): δ=+64.5 (s, P—N), +112.1 (s, P—O).

### N-Methyl,N-{(1S,2R)-[1-(Rₚ)-β-naphtylphenylphosphinito]-1-phenyl-prop-2-yl}amino diphenylphosphine-diborane VIIIb9

Yield=81%; Colorless crystals; [α]_{D}=−66.3 (c 0.6, CHCl₃). ¹H NMR (CDCl₃, 300 MHz): δ=1.35 (3H, d, J=6.5 Hz, CH₃), 2.33 (3H, d, J=7.5 Hz, NCH₃), 4.58-4.74 (1H, m, NCH), 5.46 (1H, t, J=9.4 Hz, OCH), 6.59-6.71 (2H, m, Hₐᵣₒₘ), 7.05-7.23 (8H, m, Hₐᵣₒₘ), 7.26-7.66 (15H, m, Hₐᵣₒₘ), 7.68-7.77 (1H, m, Hₐᵣₒₘ), 7.86-8.00 (3H, m, Hₐᵣₒₘ), 8.33 (1H, d, J=12.7 Hz, Hₐᵣₒₘ); ³¹P NMR (CDCl₃, 121.5 MHz): δ=+71.1 (m, P—N), +107.2 (m, P—O). HRMS (ESI-Q-TOF): calcd for C₃₈H₄₁B₂NOP₂Na [M+Na]⁺: 634.27417; found: 634.27319. Anal. calcd for C₃₈H₄,B₂NOP₂ (611.32):

### N-Methyl,N-{(1S,2R)-[1-(Rₚ)-phenyl-p-tolylphosphinito]-1-phenylprop-2-yl}amino diphenylphosphine VIII10

³¹P NMR (CDCl₃, 300 MHz): δ=+64.5 (s, P—N), +112.5 (s, P—O)

### N-Methyl,N-{(1S,2R)-[1-(Rₚ)-phenyl-p-tolylphosphinito]-1-phenylprop-2-yl}amino diphenylphosphine-diborane VIIIb10

Yield=67%; Colorless crystals (CH₂Cl₂/Hexane); [α]_{D}=−71.6 (c 0.5, CHCl₃). ¹H NMR (CDCl₃, 500 MHz): δ=1.25 (3H, d, J=6.5 Hz, CH₃), 2.22 (3H, d, J=7.6 Hz, NCH₃), 2.32 (3H, s, PhCH₃), 4.46-4.55 (1H, m, CHN), 5.30 (1H, t, J=9.4 Hz, CHO), 6.52-6.58 (2H, m, Hₐᵣₒₘ), 6.97-7.11 (7H, m, Hₐᵣₒₘ), 7.15-7.24 (6H, m, Hₐᵣₒₘ), 7.28-7.35 (4H, m, Hₐᵣₒₘ), 7.37-7.42 (1H, m, Hₐᵣₒₘ), 7.43-7.49 (2H, m, Hₐᵣₒₘ), 7.51-7.56 (2H, m, Hₐᵣₒₘ); ³¹P NMR (CDCl₃, 202.4 MHz): δ=+71.0 (m, P—N), +107.0 (m, P—O).

### 1,1′-Bis{[N-methyl,N-{(1S,2R)-1-[(Rₚ)-ferrocenylphenylphosphinito]-1-phenyl prop-2-yl}aminodiphenylphosphine VIII11

³¹P NMR (CDCl₃, 300 MHz): δ=+64.2 (s, P—N), +105.2 (s, P—O)

### 1,1′-bis{[N-Methyl,N-{(1S,2R)-1-[(Rₚ)-ferrocenylphenylphosphinito]-1-phenylprop-2-yl}aminodiphenylphosphine-diborane VIIIb1l

Yield=77%; Orange solid; [α]_{D}=−18.1 (c 0.5, CHCl₃). ¹H NMR (CDCl₃, 300 MHz): δ=1.26 (6H, d, J=6.4 Hz, CH₃), 2.17 (6H, d, J=7.6 Hz, NCH₃), 3.73 (2H, m, H_{Fc}), 4.18 (2H, m, H_{Fc}), 4.31-4.42 (2H, m, CHN), 4.52 (2H, m, H_{Fc}), 4.62 (2H, m, H_{Fc}) 5.08 (2H, t, J=9.2 Hz, CHO), 6.50-6.57 (4H, m, Hₐᵣₒₘ), 6.93-7.09 (14H, m, Hₐᵣₒₘ), 7.12-7.16 (4H, m, Hₐᵣₒₘ), 7.17-7.25 (4H, m, Hₐᵣₒₘ), 7.29-7.41 (10H, m, Hₐᵣₒₘ), 7.42-7.48 (4H, m, Hₐᵣₒₘ); ³¹P NMR (CDCl₃, 121.5 MHz): δ=+71.1 (m, P—N), +106.4 (m, P—O). HRMS (ESI-Q-TOF): calcd for C₆₆H₇₆B₄FeN₂O₂P₄Na [M+Na]⁺: 1175.44711; found: 1175.44564.

### C. APPLICATION OF P-CHIROGENIC AMINOPHOSPHINE-PHOSPHINITE (AMPP*) LIGANDS IN ASYMMETRIC CATALYSIS

### C.1.1 Application in Pd-Catalyzed Asymmetric Allylation

The P-chirogenic AMPP* VIII were used as ligands in the palladium-catalyzed allylic reactions of malonate or benzylamine (Scheme 10).

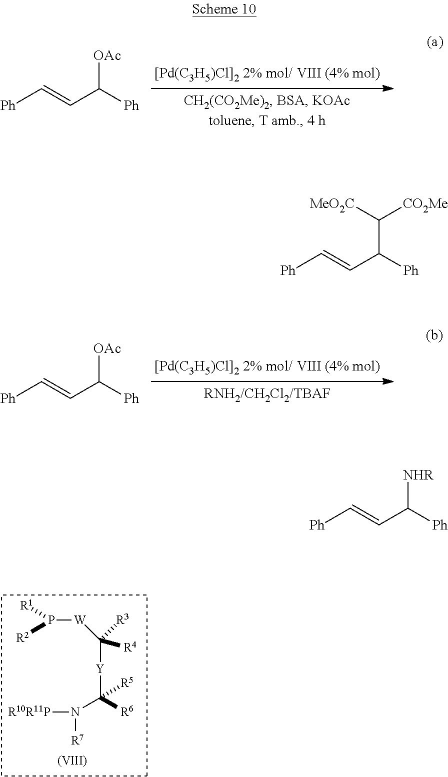

### C.1.1.1 Allylation of Dimethyl Malonate

The allylation of dimethyl malonate was performed with the allylic substrate in dichloromethane or toluene, using 2 mol % of [Pd(C₃H₅)Cl]₂ and 4 mol % of AMPP* VIII, N,O-bis(trimethylsilyl)acetamide (BSA) and a catalytic amount of potassium acetate as base. The reactions were completed at room temperature to selectively afford the mono allylated malonates (Scheme 10a). The results are reported in Table 12.

TABLE 12
Asymmetric Pd-catalyzed allylation in presence of AMPP* VIII

| AMPP* | Reagent | Solvent | Yield | Ee % |
|---|---|---|---|---|
| (R)-VIII6 | CH₂(CO₂Me)₂ | toluene | >90% | 70% (S) |
| (R)-VIII6 | CH₂(CO₂Me)₂ | CH₂Cl₂ | >90% | 50% (S) |
| (S)-VIII7 | CH₂(CO₂Me)₂ | CH₂Cl₂ | >90% | 14% (S) |
| (R)-VIII3 | CH₂(CO₂Me)₂ | CH₂Cl₂ | >90% | 46% (S) |

### C.1.1.2 Allelic Substitution of (E)-1,3-Diphenylprop-2-en-1-yl Acetate

The allylic substitution of (E)-1,3-diphenylprop-2-en-1-yl acetate catalyzed by the palladium complexes with the AMPP* VIII, was also investigated using benzylamine as nucleophiles (Scheme 10b). The reactions were performed at room temperature in dichloromethane using TBAF as additive, to afford the corresponding allylated amine products. The results are summarized in Table 13.

TABLE 13
Asymmetric Pd-catalyzed allylation in presence of AMPP* VIII

| AMPP* | Reagent | Solvent | Yield | Ee % |
|---|---|---|---|---|
| (R)-VIII6 | BnNH₂ | CH₂Cl₂ | >85% | 70% (R) |
| (S)-VIII7 | BnNH₂ | CH₂Cl₂ | >85% | 34% (R) |
| (R)-VIII3 | BnNH₂ | CH₂Cl₂ | >85% | 56% (R) |
| (R)-VIII9 | BnNH₂ | CH₂Cl₂ | >85% | 20% (R) |
| (R)-VIII3 | 4-ClPhCH₂NH₂ | CH₂Cl₂ | >85% | 59% |
| (R)-VIII9 | 4-ClPhCH₂NH₂ | CH₂Cl₂ | >85% | 11% |

### C.1.2 Application in Rh-Catalyzed Hydrogenation

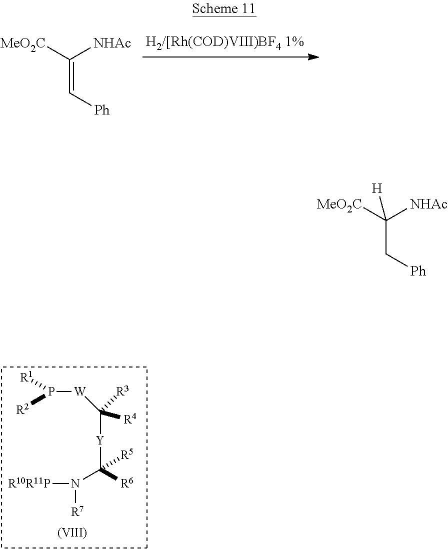

The AMPP* ligands VIII were used in rhodium-catalyzed asymmetric hydrogenation of the methyl α-acetamido cinnamate (Scheme 11). The results are reported in Table 14.

TABLE 14
Asymmetric Rh-catalyzed hydrogenation in presence of AMPP* VIII

| AMPP* | Substrate | Hydrogenated product | Yield | Ee % |
|---|---|---|---|---|
| (S)-VIII1 | 58 | 59 | >90% | 47% (R) |
| (R)-VIII3 | 58 | 59 | >90% | 81% (R) |

1-13. (canceled)

14. A process for manufacturing a compound of formula (I) 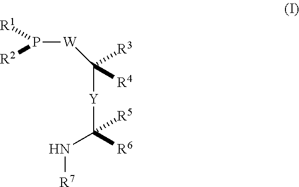
wherein
R¹ and R² may be the same or different and represent each a substituted or unsubstituted group selected from alkyl, alkenyl, cycloalkyl, aryl, bisaryl, metallocenyl and alkyloxy;
R³ represents a hydrogen atom or a substituted or unsubstituted group selected from alkyl, alkenyl, cycloalkyl and aryl; R⁵ represents a hydrogen atom or a substituted or unsubstituted group selected from alkyl, alkenyl, cycloalkyl and aryl; or R³ and R⁵ represent together a substituted or unsubstituted group selected from aryl, heteroaryl, cycloalkyl and heterocycloalkyl;
R⁴ represents a hydrogen atom or a substituted or unsubstituted group selected from alkyl, alkenyl, cycloalkyl and aryl; R₆ represents a hydrogen atom or a substituted or unsubstituted group selected from alkyl, alkenyl, cycloalkyl and aryl; or R₄ and R₆ represent together a substituted or unsubstituted group selected from aryl, heteroaryl, cycloalkyl and heterocycloalkyl;
R⁷ represents a hydrogen atom or a substituted or unsubstituted group selected from alkyl, alkenyl, cycloalkyl and aryl;
Y represents a simple bond or a (CHR⁸)ₙ wherein R⁸ represents a substituted or unsubstituted group selected from alkyl, alkenyl, cycloalkyl and aryl; and n represents a positive integer ranging from 1 to 3;
W represents O or S;
comprising reacting a compound of formula (IIa) 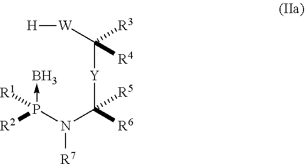
wherein R¹, R², R³, R⁴, R⁵, R⁶, R⁷, Y, and W are as defined above,
with an amine.

15. The process according to claim 14, wherein the amine is a mono or a diamine.

16. The process according to claim 14, further comprising heating.

17. The process according to claim 14, comprising a preliminary step comprising reacting a compound of formula (IIIa) 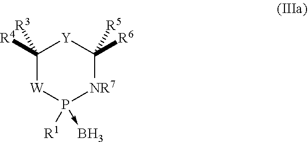
wherein R¹, R³, R⁴, R⁵, R⁶, R⁷, Y, and W are as defined above;
with a reagent R²M¹, in which M¹ is a metal and R² is as defined above;
resulting in the compound of formula (IIa).

18. The process according to claim 17, further comprising two preliminary steps:
(i) reacting a compound of formula (IV) 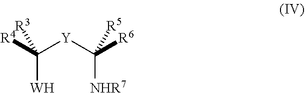
wherein R³, R⁴, R⁵, R⁶, R⁷, Y, and W are as defined above;
with
a bis-aminophosphine R¹P(N(R⁹)₂)₂, in which R¹, is as defined above, and R⁹ represents a hydrogen atom or a substituted or unsubstituted group selected from alkyl, alkenyl, cycloalkyl and aryl; or
with phosphorus trichloride PCl₃ for obtaining a compound of formula (VI); 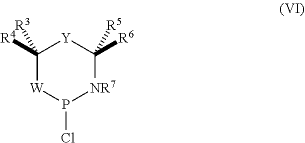
wherein R³, R⁴, R⁵, R⁶, R⁷, Y, and W are as defined above;
and further reacting the compound of formula (VI) with a reagent R¹M²;
wherein R¹ is as defined above and M² is a magnesium halide or an alkali metal;
resulting in a compound of formula (Va) 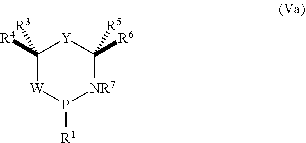
wherein R¹, R³, R⁴, R⁵, R⁶, R⁷, Y, and W are as defined above;
(ii) complexing the compound of formula (Va) with borane BH₃, resulting in the compound of formula (IIIa).

19. The process according to claim 17, further comprising four preliminary steps:
(i) reacting compound of formula (IV) 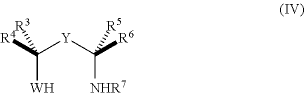
wherein R³, R⁴, R⁵, R⁶, R⁷, Y, W are as defined above;
with a bis-aminophosphine ZP(N(R⁹)₂)₂; wherein Z is leaving group and R⁹ represents a hydrogen atom or a substituted or unsubstituted group selected from alkyl, alkenyl, cycloalkyl and aryl;
resulting in a compound of formula (Vb) 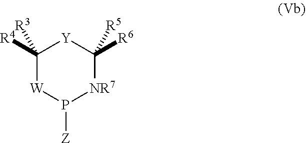
wherein R³, R⁴, R⁵, R⁶, R⁷, Y, W and Z are as defined above;
(ii) contacting the compound of formula (Vb) with a borane, resulting in a compound of formula (IIIb) 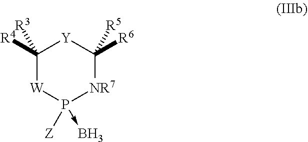
wherein R³, R⁴, R⁵, R⁶, R⁷, Y, W and Z are as defined above;
(iii) reacting the compound of formula (IIIb) with a reagent R¹M²; wherein R¹ is as defined above; M² is a magnesium halide or an alkali metal; resulting in compound of formula (IIb) 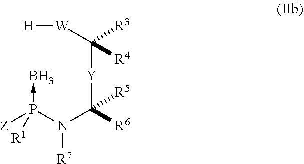
wherein R³, R⁴, R⁵, R⁶, R⁷, Y, W and Z are as defined above;
(iv) removing of the Z group of the compound of formula (IIb) by contact with silica gel or by heating, resulting in compound of formula (IIIa) 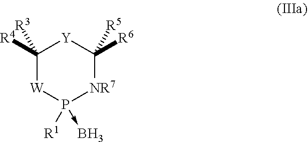
wherein R¹, R³, R⁴, R⁵, R⁶, R⁷, Y, and W are as defined above.

20. A compound of formula (I) 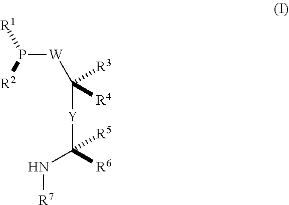
wherein
R¹ and R² may be the same or different and represent each a substituted or unsubstituted group selected from alkyl, alkenyl, cycloalkyl, aryl, bisaryl, metallocenyl and alkyloxy;
R³ represents a hydrogen atom or a substituted or unsubstituted group selected from alkyl, alkenyl, cycloalkyl and aryl; R⁵ represents a hydrogen atom or a substituted or unsubstituted group selected from alkyl, alkenyl, cycloalkyl and aryl; or R³ and R⁵ represent together a substituted or unsubstituted group selected from aryl, heteroaryl, cycloalkyl and heterocycloalkyl;
R⁴ represents a hydrogen atom or a substituted or unsubstituted group selected from alkyl, alkenyl, cycloalkyl and aryl; R₆ represents a hydrogen atom or a substituted or unsubstituted group selected from alkyl, alkenyl, cycloalkyl and aryl; or R₄ and R₆ represent together a substituted or unsubstituted group selected from aryl, heteroaryl, cycloalkyl and heterocycloalkyl;
R⁷ represents a hydrogen atom or a substituted or unsubstituted group selected from alkyl, alkenyl, cycloalkyl and aryl;
Y represents a simple bond or a (CHR⁸)ₙ wherein R⁸ represents a substituted or unsubstituted group selected from alkyl, alkenyl, cycloalkyl and aryl; and n represents a positive integer ranging from 1 to 3;
W represents O or S; provided that when R¹ is phenyl group, then R² is not phenyl group; provided that when R¹ is methoxy group, then R² is not phenyl group; provided that when R² is methoxy group, then R¹ is not phenyl group.

21. The process according to claim 14, comprising a further step selecting from
(i) a step to manufacture a compound of formula (VII) 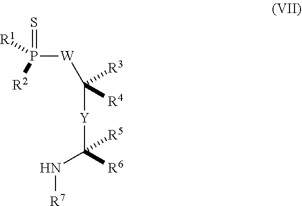
wherein
R¹ and R² may be the same or different and represent each a substituted or unsubstituted group selected from alkyl, alkenyl, cycloalkyl, aryl, bisaryl, metallocenyl and alkyloxy;
R³ represents a hydrogen atom or a substituted or unsubstituted group selected from alkyl, alkenyl, cycloalkyl and aryl; R⁵ represents a hydrogen atom or a substituted or unsubstituted group selected from alkyl, alkenyl, cycloalkyl and aryl; or R³ and R⁵ represent together a substituted or unsubstituted group selected from aryl, heteroaryl, cycloalkyl and heterocycloalkyl;
R⁴ represents a hydrogen atom or a substituted or unsubstituted group selected from alkyl, alkenyl, cycloalkyl and aryl; R₆ represents a hydrogen atom or a substituted or unsubstituted group selected from alkyl, alkenyl, cycloalkyl and aryl; or R₄ and R₆ represent together a substituted or unsubstituted group selected from aryl, heteroaryl, cycloalkyl and heterocycloalkyl;
R⁷ represents a hydrogen atom or a substituted or unsubstituted group selected from alkyl, alkenyl, cycloalkyl and aryl;
Y represents a simple bond or a (CHR⁸)ₙ wherein R⁸ represents a substituted or unsubstituted group selected from alkyl, alkenyl, cycloalkyl and aryl; and n represents a positive integer ranging from 1 to 3;
W represents O or S;
by reacting a compound of formula (I) with sulfur.
(ii) a step to manufacture a compound of formula (VIII): 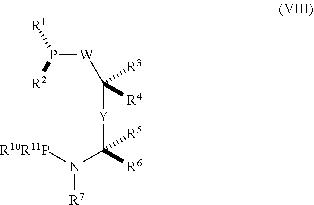
wherein
R¹, R², R³, R⁴, R⁵, R⁶ R⁷, Y and W are as defined above;
R¹⁰ and R¹¹ may be the same or different and represent each a substituted or unsubstituted group selected from alkyl, cycloalkyl and aryl;
by reacting a compound of formula (I) with a reagent R¹⁰R¹¹PCl, in which R¹⁰ and R¹¹ are as defined above, in presence of amine.
(iii) a step to manufacture a compound of formula (IX) 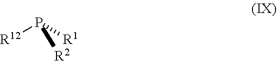
wherein
R¹ and R² are as defined above;
R¹² represents a hydrogen atom or a substituted or unsubstituted group selected from alkyl, alkenyl, cycloalkyl, aryl and bisaryl;
by reacting a compound of formula (I) with an organolithium reagent R¹²M³, wherein R¹² is as defined above and M³ is an alkali metal.
(iv) a step to manufacture a compound of formula (X) 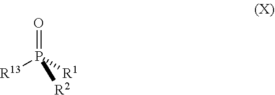
wherein
R¹ and R² are as defined above;
R¹³ represents a hydrogen atom or a substituted or unsubstituted group selected from alkyl, alkenyl, cycloalkyl and aryl;
by reacting a compound of formula (I) with an alkyl halide reagent R¹³X; wherein X represents Cl, Br or I.
